(19) United States
(12) Patent Application Publication
(10) Pub. No.: US 2024/0307803 A1
(43) Pub. Date: Sep. 19, 2024

(54) VIRUS FILTRATION OPERATIONS EMPLOYING AN OVERSIZED VIRUS PREFILTER

(71) Applicant: AMGEN INC., Thousand Oaks, CA (US)

(72) Inventors: Andrew John Maloney, West Roxbury, MA (US); David George Meliek, Billerica, MA (US); Joseph Edward Basconi, Cambridge, MA (US); Sravanthi Vadlamannati, Arlington, MA (US); Glen Bolton, Boston, MA (US)

(73) Assignee: AMGEN INC., Thousand Oaks, CA (US)

(21) Appl. No.: 18/602,388

(22) Filed: Mar. 12, 2024

Related U.S. Application Data
(60) Provisional application No. 63/489,857, filed on Mar. 13, 2023.

(51) Int. Cl. B01D 36/02; B01D 39/16; B01D 39/20; B01D 69/06; B01D 71/68

(52) U.S. Cl. CPC B01D 36/02; B01D 39/16; B01D 39/2068; B01D 69/06; B01D 71/68; B01D 2201/182

(57) ABSTRACT

Disclosed herein are methods for removing at least one viral contaminant from a concentrated composition, comprising filtering the concentrated composition through a virus prefilter and a virus filter over one or more filtration cycles, wherein a ratio of the virus prefilter area to the virus filter area in each filtration cycle is at least about 2:1, as well as viral filtration skids for use in such methods.

### CROSS-REFERENCE TO RELATED APPLICATIONS

This application claims the benefit of priority to U.S. Provisional Patent Application No. 63/489,857, filed Mar. 13, 2023, which is hereby incorporated by reference in its entirety.

### FIELD

The present disclosure provides methods for removing at least one viral contaminant from a concentrated composition (e.g., a composition comprising at least about 10 g/L, such as, e.g., at least about 15 g/L, of a recombinant protein), comprising filtering the concentrated composition through a virus prefilter and a virus filter over one or more filtration cycles, wherein a ratio of the virus prefilter area to the virus filter area in each filtration cycle is at least about 2:1, as well as viral filtration skids for use in such methods.

### BACKGROUND

Mammalian cells used in the production of recombinant protein therapeutics are susceptible to viral infection and propagation. To remove potential adventitious and endogenous viral contaminants, downstream purification processes for therapeutic proteins generally include dedicated viral clearance operations, such as viral inactivation and viral filtration operations. For example, low pH or detergent-based viral inactivation is commonly employed to denature enveloped viruses. Additionally, virus retentive filtration, a complementary unit operation, removes a range of viruses from harvested cell culture fluid through a robust, largely size-based mechanism. Specifically, virus filters with complex pore structures retain viral particles while allowing other solutes to pass through a polymeric membrane.

Virus filtration is often a costly unit operation. To extend the throughput that can be achieved and thereby reduce the required filter size, associated cost, and footprint, in-line prefilters are commonly used in conjunction with virus filters to remove certain contaminants in the product pool or eluate stream before applying the pool or eluate to the virus filter. However, despite the improvements in virus filtration economics associated with prefilter use, virus filtration remains one of the most expensive unit operations in protein purification.

Accordingly, there is a need in the art for new and improved virus filtration methods that enable robust removal of viral particles in high-throughput processes at reduced cost.

### SUMMARY

One aspect of the present disclosure provides a method of removing at least one viral contaminant from a composition, comprising filtering the composition through a virus prefilter and a virus filter, wherein the ratio of the virus prefilter area to the virus filter area is at least about 2:1.

Another aspect of the present disclosure provides a method of removing at least one viral contaminant from a composition, comprising filtering the composition through a virus prefilter and a virus filter, wherein:

the virus filter is loaded to at least about 1500 L/m² over one or more filtration cycles; and

a ratio of the virus prefilter area to the virus filter area in each filtration cycle is at least about 2:1.

In some embodiments, the composition comprises at least about 10 g/L of a recombinant protein. In some embodiments, the composition comprises at least about 12.5 g/L of a recombinant protein. In some embodiments, the composition comprises at least about 15 g/L of a recombinant protein.

In some embodiments, the virus filter is loaded to at least about 2000 L/m² over one or more filtration cycles.

In some embodiments, the virus filter is loaded to about 1500 L/m² to about 3000 L/m² over one or more filtration cycles. In some embodiments, the virus filter is loaded to about 2000 L/m² to about 3000 L/m² over one or more filtration cycles. In some embodiments, the virus filter is loaded to about 2500 L/m² to about 3000 L/m² over one or more filtration cycles.

Yet another aspect of the disclosure provides a method of removing at least one viral contaminant from a composition, comprising filtering the composition through a virus prefilter and a virus filter, wherein:

the virus filter is loaded to at least about 30,000 g/m² over one or more filtration cycles; and

a ratio of the virus prefilter area to the virus filter area in each filtration cycle is at least about 2:1.

In some embodiments, the composition comprises at least about 10 g/L of a recombinant protein. In some embodiments, the composition comprises at least about 12.5 g/L of a recombinant protein. In some embodiments, the composition comprises at least about 15 g/L of a recombinant protein.

Still another aspect of the disclosure provides a method of removing at least one viral contaminant from a composition, comprising filtering the composition through a virus prefilter and a virus filter, wherein:

the virus filter is loaded to at least about 1500 L/m² and/or at least about 30,000 g/m² over one or more filtration cycles;

the virus prefilter is a depth filter;

the virus filter is comprised of at least one flat sheet; and

a ratio of the virus prefilter area to the virus filter area in each filtration cycle is at least about 2:1.

In some embodiments, the composition comprises at least about 10 g/L of a recombinant protein. In some embodiments, the composition comprises at least about 12.5 g/L of a recombinant protein. In some embodiments, the composition comprises at least about 15 g/L of a recombinant protein.

In some embodiments, the virus filter is loaded to at least about 2000 L/m² over one or more filtration cycles.

In some embodiments, the virus filter is loaded to about 1500 L/m² to about 3000 L/m² over one or more filtration cycles. In some embodiments, the virus filter is loaded to about 2000 L/m² to about 3000 L/m² over one or more filtration cycles. In some embodiments, the virus filter is loaded to about 2500 L/m² to about 3000 L/m² over one or more filtration cycles.

In some embodiments, the virus prefilter is a diatomaceous earth-based depth filter. In some embodiments, the virus filter comprises polyethersulfone (PES). In some embodiments, the virus prefilter is a diatomaceous earth-based depth filter, and the virus filter comprises polyethersulfone (PES).

Yet another aspect of the disclosure provides a method of removing at least one viral contaminant from a composition, comprising filtering the composition through a virus prefilter and a virus filter, wherein:

the virus filter is loaded to at least about 1500 L/m² and/or at least about 30,000 g/m² over at least two filtration cycles, wherein the virus prefilter is optionally replaced after one or more filtration cycles;

the virus prefilter is a depth filter;

the virus filter is comprised of at least one flat sheet; and

a ratio of the virus prefilter area to the virus filter area in each filtration cycle is at least about 2:1.

In some embodiments, the composition comprises at least about 10 g/L of a recombinant protein. In some embodiments, the composition comprises at least about 12.5 g/L of a recombinant protein. In some embodiments, the composition comprises at least about 15 g/L of a recombinant protein.

In some embodiments, the virus filter is loaded to at least about 2000 L/m² over the at least two filtration cycles.

In some embodiments, the virus filter is loaded to about 1500 L/m² to about 3000 L/m² over the at least two filtration cycles. In some embodiments, the virus filter is loaded to about 2000 L/m² to about 3000 L/m² over the at least two filtration cycles. In some embodiments, the virus filter is loaded to about 2500 L/m² to about 3000 L/m² over the at least two filtration cycles.

In some embodiments, the virus prefilter is a diatomaceous earth-based depth filter. In some embodiments, the virus prefilter is a diatomaceous earth-based depth filter, and the method further comprises flushing the diatomaceous earth-based depth filter with sodium carbonate prior to filtering the composition.

In some embodiments, the virus filter comprises polyethersulfone (PES). In some embodiments, the virus prefilter is a diatomaceous earth-based depth filter, and the virus filter comprises polyethersulfone (PES). In some embodiments, the virus prefilter is a diatomaceous earth-based depth filter, the virus filter comprises polyethersulfone (PES), and the method further comprises flushing the diatomaceous earth-based depth filter with sodium carbonate prior to filtering the composition.

In some embodiments, the virus prefilter is replaced after one or more filtration cycles.

In some embodiments, the virus prefilter is optionally replaced after each filtration cycle.

In some embodiments, the composition has a pH of less than about 7.2. In some embodiments, the composition has a pH of about 5 to about 7.

In some embodiments, the composition has a conductivity of at least about 10 mS/cm. In some embodiments, the composition has a conductivity of at least about 12 mS/cm.

In some embodiments, the composition has a pH of less than about 7.2 and a conductivity of at least about 10 mS/cm. In some embodiments, the composition has a pH of about 5 to about 7 and a conductivity of at least about 12 mS/cm.

Another aspect of the disclosure provides a method of removing at least one viral contaminant from a composition, comprising filtering the composition through a virus prefilter and a virus filter over at least two filtration cycles, wherein:

the virus prefilter is replaced after each filtration cycle;

the virus filter is loaded to at least about 1500 L/m² over the at least two filtration cycles; and

a ratio of the virus prefilter area to the virus filter area in each filtration cycle is at least about 2:1.

In some embodiments, the composition comprises at least about 10 g/L of a recombinant protein. In some embodiments, the composition comprises at least about 12.5 g/L of a recombinant protein. In some embodiments, the composition comprises at least about 15 g/L of a recombinant protein.

In some embodiments, the virus filter is loaded to at least about 2000 L/m² over the at least two filtration cycles.

In some embodiments, the virus filter is loaded to about 1500 L/m² to about 3000 L/m² over the at least two filtration cycles. In some embodiments, the virus filter is loaded to about 2000 L/m² to about 3000 L/m² over the at least two filtration cycles. In some embodiments, the virus filter is loaded to about 2500 L/m² to about 3000 L/m² over the at least two filtration cycles.

Still another aspect of the disclosure provides a method of removing at least one viral contaminant from a composition, comprising filtering the composition through a virus prefilter and a virus filter over at least two filtration cycles, wherein:

the virus prefilter is replaced after each filtration cycle;

the virus filter is loaded to at least about 30,000 g/m² over the at least two filtration cycles; and

a ratio of the virus prefilter area to the virus filter area in each filtration cycle is at least about 2:1.

In some embodiments, the composition comprises at least about 10 g/L of a recombinant protein. In some embodiments, the composition comprises at least about 12.5 g/L of a recombinant protein. In some embodiments, the composition comprises at least about 15 g/L of a recombinant protein.

Another aspect of the disclosure provides a method of removing at least one viral contaminant from a composition, comprising filtering the composition through a virus prefilter and a virus filter over at least two filtration cycles, wherein:

the virus prefilter is replaced after each filtration cycle;

the virus filter is loaded to at least about 1500 L/m² and/or at least about 30,000 g/m² over the at least two filtration cycles;

the virus prefilter is a depth filter;

the virus filter is comprised of at least one flat sheet; and

a ratio of the virus prefilter area to the virus filter area in each filtration cycle is at least about 2:1.

In some embodiments, the composition comprises at least about 10 g/L of a recombinant protein. In some embodiments, the composition comprises at least about 12.5 g/L of a recombinant protein. In some embodiments, the composition comprises at least about 15 g/L of a recombinant protein.

In some embodiments, the virus filter is loaded to at least about 2000 L/m² over the at least two filtration cycles.

In some embodiments, the virus filter is loaded to about 1500 L/m² to about 3000 L/m² over the at least two filtration cycles. In some embodiments, the virus filter is loaded to about 2000 L/m² to about 3000 L/m² over the at least two filtration cycles. In some embodiments, the virus filter is loaded to about 2500 L/m² to about 3000 L/m² over the at least two filtration cycles.

In some embodiments, the virus prefilter is a diatomaceous earth-based depth filter. In some embodiments, the virus filter comprises polyethersulfone (PES). In some embodiments, the virus prefilter is a diatomaceous earth-based depth filter, and the virus filter comprises polyethersulfone (PES).

In some embodiments, the composition has a pH of less than about 7.2. In some embodiments, the composition has a pH of about 5 to about 7.

In some embodiments, the composition has a conductivity of at least about 10 mS/cm. In some embodiments, the composition has a conductivity of at least about 12 mS/cm.

In some embodiments, the composition has a pH of less than about 7.2 and a conductivity of at least about 10 mS/cm. In some embodiments, the composition has a pH of about 5 to about 7 and a conductivity of at least about 12 mS/cm.

Still another aspect of the disclosure provides a viral filtration skid for use in a method described herein. Yet another aspect of the disclosure provides a viral filtration skid comprising a virus prefilter and a virus filter, wherein the ratio of the virus prefilter area to the virus filter area is at least about 2:1.

### BRIEF DESCRIPTION OF THE DRAWINGS

FIG. 1 shows virus filter flux versus loading from a bench-scale proof of concept run using a 2.9:1 virus prefilter to virus filter area ratio.

FIG. 2 shows bench-scale results for virus filter inlet pressure versus loading for “constant flux” (250 L/m²/hr (LMH)) runs using the same virus filter for three filtration cycles using a 2.9:1 virus prefilter to virus filter area ratio for each filtration cycle (i.e., with a net 8.7:1 virus prefilter to virus filter area ratio).

FIGS. 3A and 3B show delta pressure vs. elapsed time during constant flux (250 LMH) viral filtration over two filtration cycles (cycle 1 (FIG. 3A); cycle 2 (FIG. 3B)) in a bench-scale evaluation using a 2.9:1 virus prefilter to virus filter area ratio for each filtration cycle (i.e., with a net 5.8:1 virus prefilter to virus filter area ratio).

FIG. 4 shows virus filter differential pressure measurements at the end of each filtration cycle in pilot-scale runs with three filtration cycles per virus filter using a 2.6:1 virus prefilter to virus filter area ratio for each filtration cycle (i.e., with a net 7.8:1 virus prefilter to virus filter area ratio).

FIG. 5 shows virus filter inlet pressure measurements at the end of each filtration cycle in pilot-scale runs with three filtration cycles per virus filter using a 2.6:1 virus prefilter to virus filter area ratio for each filtration cycle (i.e., with a net 7.8:1 virus prefilter to virus filter area ratio).

### DETAILED DESCRIPTION

Disclosed herein are methods for removing at least one viral contaminant from a concentrated composition (e.g., a composition comprising at least about 10 g/L of a recombinant protein), comprising filtering the concentrated composition through a virus prefilter and a virus filter over one or more filtration cycles, wherein a ratio of the virus prefilter area to the virus filter area in each filtration cycle is at least about 2:1, as well as viral filtration skids for use in such methods.

### Definitions

The following definitions are provided to assist in understanding the scope of this disclosure. Unless defined otherwise, all technical and scientific terms used herein have the same meaning as is commonly understood by one of ordinary skill in the art to which this disclosure belongs.

In some embodiments, “about,” when used in connection with a measurable numerical variable, refers to the indicated value of the variable and to all values of the variable that are within the experimental error of the indicated value (e.g., within the 95% confidence interval for the mean) or ±10% of the indicated value, whichever is greater. In some embodiments, numeric ranges are inclusive of the numbers defining the range (i.e., the endpoints).

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges may independently be included in the smaller ranges also encompassed within the disclosure, subject to any specifically excluded limit in the stated range. Where the stated range includes one or both of the limits, ranges excluding either or both of those included limits are also included in the disclosure.

As used herein, the terms “a” and “an” mean “one or more” unless specifically indicated otherwise. Additionally, “one or more” and “at least one” are used interchangeably herein. Furthermore, unless otherwise required by context, singular terms include pluralities and plural terms include the singular.

As used herein, the term “acid precipitation” refers to a harvest operation in which cell culture pH is reduced to induce precipitation of one or more cell culture impurities.

As used herein, the term “affinity chromatography” (also referred to as “capture chromatography”) refers to a chromatography operation in which a biomolecule (e.g., a recombinant protein) is separated from a mixture based on a selective interaction between the biomolecule and another substance (i.e., a ligand). Affinity chromatography is commonly used in biomanufacturing processes to isolate and concentrate desired recombinant proteins from harvested cell culture fluid. In a typical affinity chromatography operation, a biomolecule in a moving phase selectively binds to or otherwise interacts with a stationary phase while the rest of the moving phase passes through the chromatography material. The biomolecule is then eluted from the stationary phase by changing the conditions in a manner that reduces the affinity between the ligand and the biomolecule. Non-limiting examples of affinity chromatography materials include Protein A, Protein G, Protein A/G, and Protein L materials. Additionally, immobilized metal affinity chromatography (IMAC) can be used to capture proteins that have or have been engineered to have affinity for metal ions.

In some embodiments, protein A affinity chromatography may be employed to capture a recombinant protein of interest. Protein A ligands are highly selective for a wide range of proteins containing an antibody Fc region and provide robust removal of process-related impurities with high target protein yields. Commercially available protein A materials include, but are not limited to, MABSELECT™ SURE Protein A, Protein A Sepharose FAST FLOW™ MABSELECT™ PrismA (Cytiva, Marborough, MA), PROSEP-A™ (Merck Millipore, U.K), TOYOPEARL™ HC-650F Protein A (TosoHass Co., Philadelphia, PA), and AP Plus, Purolite, King of Prussia, PA).

As used herein, the term “antigen-binding protein” refers to a protein or polypeptide that comprises an antigen-binding region or antigen-binding portion that has affinity for another molecule to which it binds (antigen). Antigen-binding proteins include, but are not limited to, antibodies, fusion proteins, VH, VHH, VL, (s)dAb, Fv, light chain (VL-CL), Fd (VH-CH1), heavy chain, Fab, Fab′, F(ab′)2 or “r IgG” (“half antibody” consisting of a heavy chain and a light chain) or a modified antigen-binding portion of a full-length antibody, such as, e.g., a triple-chain antibody-like molecule, a heavy chain only antibody, single-chain variable fragment (scFv), di-scFv or bi(s) scFv, scFv-Fc, scFv-zipper, single-chain Fab (scFab), Fab₂, Fab₃, diabodies, single-chain diabodies, tandem diabodies (Tandabs), tandem di-scFv, tandem tri-scFv, “minibodies” exemplified by a structure which is as follows: (VH-VL-CH3)₂, (scFv-CH3)₂, ((scFv)₂-CH3+CH3), ((scFv)₂-CH3) or (scFv-CH3-scFv)₂, multibodies, such as triabodies or tetrabodies, and single domain antibodies, such as nanobodies or single variable domain antibodies comprising merely one variable region, which might be VHH, VH, or VL, that specifically binds to an antigen or target independently of other variable regions or domains.

As used herein, the term “antibody” generally refers to a tetrameric immunoglobulin protein comprising two light chain polypeptides (about 25 kDa each) and two heavy chain polypeptides (about 50-70 kDa each).

As used herein, the term “light chain” or “immunoglobulin light chain” refers to a polypeptide comprising, from amino terminus (N-terminus) to carboxyl terminus (C-terminus), a single immunoglobulin light chain variable region (VL) and a single immunoglobulin light chain constant domain (CL). The immunoglobulin light chain constant domain (CL) can be a human kappa (κ) or human lambda (λ) constant domain.

As used herein, the term “heavy chain” or “immunoglobulin heavy chain” refers to a polypeptide comprising, from amino terminus (N-terminus) to carboxyl terminus (C-terminus), a single immunoglobulin heavy chain variable region (VH), an immunoglobulin heavy chain constant domain 1 (CH1), an immunoglobulin hinge region, an immunoglobulin heavy chain constant domain 2 (CH2), an immunoglobulin heavy chain constant domain 3 (CH3), and optionally an immunoglobulin heavy chain constant domain 4 (CH4). Heavy chains are classified as mu (μ), delta (Δ), gamma (γ), alpha (α), and epsilon (ε), and define the antibody's isotype as IgM, IgD, IgG, IgA, and IgE, respectively. The IgG-class and IgA-class antibodies are further divided into subclasses, namely, IgG1, IgG2, IgG3, and IgG4, and IgA1 and IgA2, respectively. The heavy chains in IgG, IgA, and IgD antibodies have three constant domains (CH1, CH2, and CH3), whereas the heavy chains in IgM and IgE antibodies have four constant domains (CH1, CH2, CH3, and CH4). The immunoglobulin heavy chain constant domains can be from any immunoglobulin isotype, including subtypes. The antibody chains are linked together via inter-polypeptide disulfide bonds between the CL domain and the CH1 domain (i.e. between the light and heavy chain) and between the hinge regions of the two antibody heavy chains.

Variable regions of immunoglobulin chains generally exhibit the same overall structure, comprising relatively conserved framework regions (FR) joined by three hypervariable regions, more often called “complementarity determining regions” or CDRs. The CDRs from the two chains of each heavy chain and light chain pair typically are aligned by the framework regions to form a structure that binds specifically to a specific epitope on the target protein. From N-terminus to C-terminus, naturally-occurring light and heavy chain variable regions both typically conform with the following order of these elements: FR1, CDR1, FR2, CDR2, FR3, CDR3, and FR4. A numbering system has been devised for assigning numbers to amino acids that occupy positions in each of these domains. This numbering system is defined in Kabat Sequences of Proteins of Immunological Interest (1987 and 1991, NIH, Bethesda, MD), or Chothia & Lesk, 1987, J. Mol. Biol. 196:901-917; Chothia et al., 1989, Nature 342:878-883. The CDRs and FRs of a given antibody may be identified using this system. Other numbering systems for the amino acids in immunoglobulin chains include IMGT® (the international ImMunoGeneTics information system; Lefranc et al., Dev. Comp. Immunol. 29:185-203; 2005) and AHo (Honegger and Pluckthun, J. Mol. Biol. 309(3):657-670; 2001).

Papain digestion of antibodies produces two identical antigen-binding proteins, called “Fab” fragments, each with a single antigen-binding site, and a residual “Fc” fragment which contains all but the first domain of the immunoglobulin heavy chain constant region. The Fab fragment contains the variable domains from the light and heavy chains, as well as the constant domain of the light chain and the first constant domain (CH1) of the heavy chain. Thus, a “Fab fragment” is comprised of one immunoglobulin light chain (light chain variable region (VL) and constant region (CL)) and the CH1 domain and variable region (VH) of one immunoglobulin heavy chain. The heavy chain of a Fab molecule cannot form a disulfide bond with another heavy chain molecule. The “Fd fragment” comprises the VH and CH1 domains from an immunoglobulin heavy chain. The Fd fragment represents the heavy chain component of the Fab fragment.

The “Fc fragment” or “Fc region” of an immunoglobulin generally comprises two constant domains, a CH2 domain and a CH3 domain, and optionally comprises a CH4 domain. The Fc region may be an Fc region from an IgG1, IgG2, IgG3, or IgG4 immunoglobulin. In some embodiments, the Fc region comprises CH2 and CH3 domains from a human IgG1 or human IgG2 immunoglobulin. The Fc region may retain effector function, such as Clq binding, complement dependent cytotoxicity (CDC), Fc receptor binding, antibody-dependent cell-mediated cytotoxicity (ADCC), and phagocytosis. In other embodiments, the Fc region may be modified to reduce or eliminate effector function.

A “F(ab′)₂ fragment” is a bivalent fragment including two Fab′ fragments linked by a disulfide bridge between the heavy chains at the hinge region.

The “Fv” fragment is the minimum fragment that contains a complete antigen recognition and binding site from an antibody. This fragment consists of a dimer of one immunoglobulin heavy chain variable region (VH) and one immunoglobulin light chain variable region (VL) in tight, non-covalent association. It is in this configuration that the three CDRs of each variable region interact to define an antigen binding site on the surface of the VH-VL dimer. A single light chain or heavy chain variable region (or half of an Fv fragment comprising only three CDRs specific for an antigen) has the ability to recognize and bind antigen, although at a lower affinity than the entire binding site comprising both VH and VL.

A “single-chain variable fragment” or “scFv fragment” comprises the VH and VL regions of an antibody, wherein these regions are present in a single polypeptide chain, and optionally comprising a peptide linker between the VH and VL regions that enables the Fv to form the desired structure for antigen binding (see e.g., Bird et al., Science, Vol. 242:423-426, 1988; and Huston et al., Proc. Natl. Acad. Sci. USA, Vol. 85:5879-5883, 1988).

A “nanobody” is the heavy chain variable region of a heavy-chain antibody. Such variable domains are the smallest fully functional antigen-binding fragment of such heavy-chain antibodies with a molecular mass of only 15 kDa. See Cortez-Retamozo et al., Cancer Research 64:2853-57, 2004. Functional heavy-chain antibodies devoid of light chains are naturally occurring in certain species of animals, such as nurse sharks, wobbegong sharks, and Camelidae, such as camels, dromedaries, alpacas and llamas. The antigen-binding site is reduced to a single domain, the VHH domain, in these animals. These antibodies form antigen-binding regions using only heavy chain variable region, i.e., these functional antibodies are homodimers of heavy chains only having the structure H₂L₂(referred to as “heavy-chain antibodies” or “HCAbs”). Camelized VHH reportedly recombines with IgG2 and IgG3 constant regions that contain hinge, CH2, and CH3 domains and lack a CH1 domain. Camelized VHH domains have been found to bind to antigen with high affinity (Desmyter et al., J. Biol. Chem., Vol. 276:26285-90, 2001) and possess high stability in solution (Ewert et al., Biochemistry, Vol. 41:3628-36, 2002). Methods for generating antibodies having camelized heavy chains are described in, for example, U.S. Patent Publication Nos. 2005/0136049 and 2005/0037421. Alternative scaffolds can be made from human variable-like domains that more closely match the shark V-NAR scaffold and may provide a framework for a long penetrating loop structure.

As used herein, the term “heavy chain-only antibody” refers to an immunoglobulin protein consisting of two heavy chain polypeptides (such as, e.g., heavy chain polypeptides that are about 50-70 kDa each). A “heavy chain-only antibody” lacks the two light chain polypeptides found in a conventional antibody. Heavy-chain antibodies constitute about one-fourth of the IgG antibodies produced by the camelids, e.g., camels and llamas (Hamers-Casterman C., et al. Nature. 363, 446-448 (1993)). These molecules are formed by two heavy chains but are devoid of light chains. As a consequence, the variable antigen binding part is referred to as the VHH domain, and it represents the smallest naturally occurring, intact, antigen-binding site, being only around 120 amino acids in length (Desmyter, A., et al. J. Biol. Chem. 276, 26285-26290 (2001)). Heavy chain antibodies with a high specificity and affinity can be generated against a variety of antigens through immunization (van der Linden, R. H., et al. Biochim. Biophys. Acta. 1431, 3746 (1999)), and the VHH portion can be readily cloned and expressed in yeast (Frenken, L. G. J., et al. J. Biotechnol. 78, 11-21 (2000)). Their levels of expression, solubility and stability are significantly higher than those of classical F(ab) or Fv fragments (Ghahroudi, M. A. et al. FEBS Lett. 414, 521-526 (1997)). Sharks have also been shown to have a single VH-like domain in their antibodies, termed VNAR. (Nuttall et al. Eur. J. Biochem. 270, 3543-3554 (2003); Nuttall et al. Function and Bioinformatics 55, 187-197 (2004); Dooley et al., Molecular Immunology 40, 25-33 (2003).)

In some embodiments, a “heavy chain-only antibody” is a dimeric antibody comprising a VH antigen-binding domain and the CH2 and CH3 constant domains, in the absence of the CH1 domain. In some embodiments, a heavy chain-only antibody is composed of a variable region antigen-binding domain composed of framework 1, CDR1, framework 2, CDR2, framework 3, CDR3, and framework 4. In some embodiments, a heavy chain-only antibody is composed of an antigen-binding domain, at least part of a hinge region, and CH2 and CH3 domains. In some embodiments, a heavy chain-only antibody is composed of an antigen-binding domain, at least part of a hinge region, and a CH2 domain. In some embodiments, a heavy chain-only antibody is composed of an antigen-binding domain, at least part of a hinge region, and a CH3 domain. Heavy chain-only antibodies in which the CH2 and/or CH3 domain is truncated are also included herein. The heavy chain-only antibodies described herein may belong to the IgG subclass, but heavy chain-only antibodies belonging to other subclasses, such as IgM, IgA, IgD and IgE subclass, are also included herein. In some embodiments, a heavy chain-only antibody may belong to the IgG1, IgG2, IgG3, or IgG4 subtype, e.g., the IgG1 or IgG4 subtype. In some embodiments, a heavy chain antibody-only is of the IgG1 or IgG4 subtype, wherein one or more of the CH domains is modified to alter an effector function of the antibody. In some embodiments, a heavy chain-only antibody is of the IgG4 subtype, wherein one or more of the CH domains is modified to alter an effector function of the antibody. In some embodiments, a heavy chain-only antibody is of the IgG1 subtype, wherein one or more of the CH domains is modified to alter an effector function of the antibody. Modifications of CH domains that alter effector function are further described herein. Non-limiting examples of heavy-chain-only antibodies are described, for example, in WO2018/039180, the disclosure of which is incorporated herein by reference herein in its entirety.

As used herein, the term “three-chain antibody like molecule” or “TCA” refers to an antibody-like molecule comprising, consisting essentially of, or consisting of three polypeptide subunits, two of which comprise, consist essentially of, or consist of one heavy and one light chain of a monoclonal antibody, or antigen-binding fragments of such antibody chains, comprising an antigen-binding region and at least one CH domain. This heavy chain/light chain pair has binding specificity for a first antigen. The third polypeptide subunit comprises, consists essentially of, or consists of a heavy-chain only antibody comprising an Fc portion comprising CH2 and/or CH3 and/or CH4 domains, in the absence of a CH1 domain, and one or more antigen binding domains (such as, e.g., two antigen binding domains) that binds an epitope of a second antigen or a different epitope of the first antigen, where such binding domain is derived from or has sequence identity with the variable region of an antibody heavy or light chain. Parts of such variable region may be encoded by V_{H} and/or V_{L} gene segments, D and JH gene segments, or J_{L}gene segments. The variable region may be encoded by rearranged V_{H}DJ_{H}, V_{L}DJ_{H}, V_{H}J_{L}, or V_{L}J_{L} gene segments.

As used herein, the term “bioreactor” means any vessel useful for the growth of a cell culture (e.g., a mammalian cell culture or a bacterial cell culture). “Bioreactor” encompasses the term “fermenter” (i.e., a vessel useful for the growth of a bacterial cell culture, which typically contains a more rigorous agitator and increased gas flow relative to a vessel used for the growth of a mammalian cell culture) herein. Non-limiting examples of bioreactors include stirred tank, airlift, fiber, microfiber, hollow fiber, ceramic matrix, fluidized bed, fixed bed, and/or spouted bed bioreactors. In some embodiments, an example bioreactor can perform one or more (e.g., one, two, three, all) of the following steps: feeding of nutrients (such as, e.g., in perfusion cell culture) and/or carbon sources, injection of suitable gas (such as, e.g., oxygen), inlet and outlet flow of fermentation or cell culture medium (e.g., perfusion of fresh cell culture medium in and removal of spent cell culture medium), separation of gas and liquid phases, maintenance of temperature, maintenance of oxygen and CO₂ levels, maintenance of pH level, agitation (e.g., stirring), and/or cleaning/sterilizing. Unless otherwise indicated by context, a bioreactor can be suitable for batch, semi fed-batch, fed-batch, perfusion, and/or continuous fermentation processes. Any suitable bioreactor diameter can be used. Unless otherwise indicated by context, in some embodiments, the bioreactor can have a volume between 100 mL and 50,000 L. Unless otherwise indicated, a bioreactor can be of any size so long as it is useful for the culturing of cells; typically, a bioreactor is sized appropriate to the volume of cell culture being grown inside of it. In non-limiting embodiments and unless otherwise indicated by context, a bioreactor may be at least 1 liter (L) or may be 2, 5, 10, 50, 100, 200, 250, 500, 1,000, 1500, 2000, 2,500, 5,000, 8,000, 10,000, 12,000, 20,000 liters or more, or any volume in between. The internal conditions of the bioreactor, including, but not limited to, pH, dissolved oxygen (DO), and temperature, can be controlled during the culturing period. Those of ordinary skill in the art will be aware of, and will be able to select, suitable bioreactors based on the relevant considerations.

As used herein, the term “cell culture” or “culture” refers to the growth and propagation of cells outside of a multicellular organism or tissue. Suitable culture conditions for mammalian and bacterial cells are known in the art. (See, e.g., Animal cell culture: A Practical Approach, D. Rickwood, ed., Oxford University Press, New York (1992).) Mammalian cells may be cultured in suspension or while attached to a solid substrate. In some embodiments, fluidized bed bioreactors, hollow fiber bioreactors, roller bottles, shake flasks, and/or stirred tank bioreactors, with or without microcarriers, may be used for cell culture. In some embodiments, 500 L to 2000 L bioreactors are used for cell culture (e.g., as part of a seed train). In some embodiments, 1000 L to 2000 L bioreactors are used for cell culture (e.g., as part of a seed train).

As used herein, the term “cell culturing medium” (also referred to as “media,” “culture medium,” “cell culture media,” “tissue culture media,” and the like) refers to any nutrient solution used for growing cells, e.g., bacterial or mammalian cells. Cell culturing medium generally provides one or more of the following components: an energy source (e.g., in the form of a carbohydrate, such as, e.g., glucose); one or more essential amino acids (e.g., all essential amino acids; the twenty basic amino acids plus cysteine); vitamins and/or other organic compounds typically required at low concentrations; lipids or free fatty acids; and trace elements, such as, e.g., inorganic compounds or naturally occurring elements that are typically required at very low concentrations, such as, e.g., concentrations in the micromolar range. As used herein, cell culturing medium encompasses nutrient solutions that are typically employed in and/or are known for use with any cell culture process, including, but not limited to, batch, extended batch, fed-batch, intensified, and/or perfusion or continuous culturing of cells.

As used herein, the term “cell density” refers to the number of cells in a given volume of culture medium. “Viable cell density” refers to the number of live cells in a given volume of culture medium, as determined by standard viability assays (such as, e.g., a trypan blue dye exclusion method) and may be measured at any point during a specific phase of a cell culture process. As used herein, the term “packed cell volume” (PCV), also referred to as “percent packed cell volume” (% PCV), is the ratio of the volume occupied by the cells, to the total volume of cell culture, expressed as a percentage (see Stettler, et al., (2006) Biotechnol Bioeng. December 20:95(6):1228-33). Packed cell volume is a function of cell density and cell diameter; increases in packed cell volume could arise from increases in cell density or cell diameter or both. Packed cell volume is a measure of the solid content in the cell culture. Since host cells vary in size and cell cultures also contain dead and dying cells and other cellular debris, packed cell volume can describe with a greater degree of accuracy the solid content within a cell culture.

As used herein, the term “continuous,” in reference to unit operations, refers to a direct connection or mechanism that allows for continuous flow between one or more unit operations.

As used herein, the term “dynamic binding capacity,” in reference to a chromatography material, refers to the amount of product, e.g. polypeptide, the material will bind under actual flow conditions before significant breakthrough of unbound product occurs.

As used herein, the term “expression vector” or “expression construct” refers to a recombinant DNA molecule containing a desired coding sequence and appropriate nucleic acid control sequences necessary for the expression of the operably linked coding sequence in a particular host cell, e.g. a mammalian host cell. Vectors can include viral vectors, non-episomal mammalian vectors, plasmids, and other non-viral vectors. An expression vector can include sequences that affect or control transcription, translation, and, if introns are present, affect RNA splicing of a coding region operably linked thereto. “Operably linked” means that the components to which the term is applied are in a relationship that allows them to carry out their inherent functions. For example, a control sequence, e.g., a promoter, in a vector that is “operably linked” to a protein coding sequence are arranged such that normal activity of the control sequence leads to transcription of the protein coding sequence resulting in recombinant expression of the encoded protein.

As used herein, “fed-batch culture” refers to a form of suspension culture, specifically a method of culturing cells in which additional components are provided to the culture at a time or times subsequent to the beginning of the culture process. The provided components typically comprise nutritional supplements for the cells which have been depleted during the culturing process. Additionally or alternatively, the additional components may include supplementary components (such as, e.g., a cell-cycle inhibitory compound). In some embodiments, fed-batch cell culture medium formulations may be richer or more concentrated than basal cell culture medium formulations, which contain components essential for cell survival and growth and are typically used to initiate a cell culture. A fed-batch culture may be stopped at some point, and the cells and/or components in the medium may be harvested and optionally purified.

As used herein, a “fusion protein” is a protein that contains at least one polypeptide fused or linked to a heterologous polypeptide. Typically, a fusion protein is expressed from a fusion gene in which a nucleotide sequence encoding a polypeptide sequence from one protein is appended in frame with, and optionally separated by a linker from, a nucleotide sequence encoding a polypeptide sequence from a different protein. The fusion gene can then be expressed by a recombinant host cell to produce the fusion protein. The fusion protein may comprise a fragment from an immunoglobulin protein, such as an Fc region, fused or linked to a ligand polypeptide, a receptor polypeptide, a hormone, cytokine, growth factor, an enzyme, or other polypeptide that is not a component of an immunoglobulin.

As used herein, a “growth phase” of a cell culture refers to the period of exponential cell growth (i.e. the log phase) where cells are generally rapidly dividing.

As used herein, the term “harvested cell culture fluid” refers to a solution which has been processed by one or more operations to separate cells, cell debris, or other large particulates from the recombinant protein. Such operations, as described above, include, but are not limited to, cooling, flocculation, acidification, centrifugation, neutralization, acoustic wave separation, and various forms of filtration (e.g., depth filtration, microfiltration, ultrafiltration, tangential flow filtration, and alternating tangential flow filtration). Harvested cell culture fluid includes cell culture lysates as well as cell culture supernatants. The harvested cell culture fluid may be further clarified to remove fine particulate matter and soluble aggregates by filtration with a membrane having a pore size between about 0.1 μm and about 0.5 μm, such as, e.g., a membrane having a pore size of about 0.22 μm.

As used herein, a “host cell” refers to a cell that has been transformed, or is capable of being transformed, with a nucleic acid and thereby expresses a gene of interest. The term includes the progeny of the parent cell, whether or not the progeny is identical in morphology or in genetic make-up to the original parent cell, so long as the gene of interest is present. A host cell that comprises a nucleic acid encoding a recombinant protein, e.g., operably linked to at least one expression control sequence (e.g. promoter or enhancer), is a “recombinant host cell.” A host cell, when cultured under appropriate conditions, may synthesize a recombinant protein that can subsequently be collected from the culture medium (if the host cell secretes it into the medium) or directly from the host cell producing it (if it is not secreted).

As used herein, “high molecular weight” or “HMW” species of a recombinant protein of interest refer to dimers, oligomers, and aggregates of the recombinant protein that have a molecular weight greater than the molecular weight of the intact, fully assembled form of the recombinant protein.

As used herein, the term “impurity” refers to a component other than the recombinant protein of interest. Impurities include, but are not limited to, process- and product-related impurities, such as, e.g., host cell proteins, leached resin materials (such as, e.g., leached protein A), nucleic acids, HMW species of the recombinant protein, LMW species of the recombinant protein, endotoxins, viral contaminants, cell culture media components, and the like.

As used herein, the term “loading density” refers to the amount of composition put in contact with a volume of chromatography material.

As used herein, “low molecular weight” or “LMW” species of a recombinant protein of interest refer to fragments, truncated forms, or other incomplete variants of the recombinant protein that have a molecular weight less than the molecular weight of the intact, fully assembled form of the recombinant protein. LMW species can include, but are not limited to, proteolytic fragments, truncated forms resulting from cellular expression of mRNA splice variants, and single component polypeptides in the case of multi-polypeptide chain proteins (e.g. light chain or heavy chain only species when the recombinant protein is an antibody).

As used herein, a “perfusion” cell culture medium refers to a cell culture medium that is typically used in cell cultures that are maintained by perfusion or continuous culture methods and is sufficiently complete to support the cell culture during this process. In some embodiments, perfusion cell culture medium formulations may be richer or more concentrated than base cell culture medium formulations to accommodate the method used to remove the spent medium. In some embodiments, perfusion cell culture medium may be used during both the growth and production phases.

As used herein, the term “polypeptide” refers to a polymer of amino acids comprising at least 50 amino acids, such as, e.g., at least 100 amino acids.

As used herein, a “production” cell culture medium refers to a cell culture medium that is typically used in a cell culture during the transition when exponential growth is ending and protein production takes over (i.e., “transition” and/or “product” phases) and is sufficiently complete to maintain a desired cell density, viability, and/or product titer during this phase. A production cell culture medium may be the same as or different than the cell culture medium used during the exponential growth phase of the cell culture.

As used herein, a “production phase” of a cell culture refers to the period of time during which logarithmic cell growth has ended and recombinant protein production is predominant.

As used herein, the term “polishing chromatography” refers to a chromatography operation performed after a capture or affinity chromatography operation to remove remaining impurities and obtain a more highly purified composition and/or recombinant protein. Common impurities removed during polishing steps include, but are not limited to, product-related impurities (e.g., HMW and LMW species), host cell proteins, DNA, leached protein A, viral contaminants, and endotoxins. In addition, typical chromatography techniques used for polishing include, but are not limited to, ion exchange chromatography (IEX), hydrophobic interaction chromatography (HIC), and multimodal (or mixed mode) chromatography (MMC).

“Anion exchange chromatography” (AEX) refers to a form of ion exchange chromatography performed on a solid phase medium (e.g., resin or membrane) that is positively charged and has the capacity to exchange anions with anions in an aqueous solution passed over or through the solid phase. AEX chromatography is used, for example, for viral clearance and impurity removal. Commercially available anion exchange media include, but are not limited to, sulphopropyl (SP) immobilized on agarose (e.g., Source 15 Q, Capto™ Q, Q-SEPHAROSE FAST FLOW™ (Cytiva), FRACTOGEL TMAE™, FRACTOGEL EDM DEAE™, (EMD Merck), TOYOPEARL Super Q® and TOYOPEARL NH2-750F (Tosoh Bioscience), POROS HQ™, and POROS XQ™, (ThermoFisher).

“Cation exchange chromatography” (CEX) refers to a form of ion exchange chromatography performed on a solid phase medium (e.g., resin or membrane) that is negatively charged and has the capacity to exchange cations with cations in an aqueous solution passed over or through the solid phase. The charge may be provided by attaching one or more charged ligands to the solid phase, e.g., via covalent linkage. Alternatively or additionally, the charge may be an inherent property of the solid phase (e.g., silica, which has an overall negative charge). CEX chromatography is typically used to remove high molecular weight (HMW) contaminants, process related impurities, and/or viral contaminants. Commercially available cation exchange media include, but are not limited to, sulphopropyl (SP) immobilized on agarose (e.g., SPSEPHAROSE FAST FLOW™, SP-SEPHAROSE FAST FLOW XL™ or SP-SEPHAROSE HIGH PERFORMANCE™, CAPTO S™, CAPTO SP ImpRes™, CAPTO S ImpAct™ (Cytiva), FRACTOGEL-SO3™, FRACTOGEL-SE HICAP™, and FRACTOPREP™ (EMD Merck, Darmstadt, Germany), TOYOPEARL® XS, TOYOPEARL® HS (Tosoh Bioscience, King of Prussia, PA), UNOsphere™ (BioRad, Hercules, CA), S Ceramic Hyper™ DF (Pall, Port Washington, NY), POROS™ (ThermoFisher, Waltham, MA), ESHMUNO® CSP and ESHMUNO® CP-FT (Millipore Sigma, Darmstadt, Germany).

“Hydrophobic interaction chromatography” (HIC) refers to chromatography performed on a solid phase medium that makes use of the interaction between hydrophobic ligands and hydrophobic residues on the surface of a solute. Commercially available hydrophobic interaction chromatography media include, but are not limited to, Phenyl Sephrose™ (Cytiva), Tosoh hexyl (Tosoh Bioscience), and Capto™ phenyl (Cytiva).

“Mixed-mode or multi-modal chromatography” (MMC) refers to chromatography that makes use of more than one form of interaction between the stationary phase and analyte to achieve separation. MMC differs from single mode chromatography in that two or more interaction types, such as, e.g., electrostatic, hydrogen bonding, and/or hydrophobic interactions, contribute significantly to the retention of solutes. Commercially available multi-modal chromatography media include, but are not limited to, Capto™ Adhere, Capto™ MMC Impress, Capto MMC, (Cytiva), PPA Hypercel, MEP Hypercell, HEA Hypercell (Pall Corporation, Port Washington, NY). Eshmuno™ HCX, (Merk Millipore), and Toyopearl™ MX-Trp-650M (Tosoh Bioscience).

Polishing chromatography unit operations make use of materials (e.g., resins and/or membranes) containing agents that can be operated in a variety of modes, two of which are bind-and-elute mode and flow-though mode. In bind-and-elute chromatography, a biomolecule of interest is usually loaded onto the chromatography material to maximize dynamic binding capacity and then wash and elution conditions are utilized to maximize product purity in the eluate. By contrast, in flow-through chromatography, load conditions are employed that allow impurities to bind to the chromatography material while the biomolecule of interest passes through. Relative to bind-and-elute chromatography, flow-through chromatography allows for higher load densities for many biomolecules.

In addition to the two most common modes, weak partitioning chromatography, overload chromatography, and frontal chromatography modes may also be employed in purification processes. In weak partitioning chromatography, an isocratic separation method, flow-through mode is altered by identifying solution conditions that promote weak binding of a biomolecule to resin, in addition to binding of one or more impurities, with a low product partition coefficient in the range of 0.1-20. In overload chromatography, the biomolecule of interest is loaded onto the chromatography material beyond the dynamic binding capacity of the material. Additionally, frontal chromatography mode allows for a continuous, high-density feed (containing the protein of interest and at least one impurity) onto the chromatography medium. In frontal chromatography, the separation of the protein of interest from impurities and contaminants is driven by the binding affinity of the components in the load feed for the chromatography medium. The amount of the protein of interest that may be loaded on and bound to the chromatography medium in frontal mode is typically dependent on the amount of more highly charged impurities/contaminants, such as product-related impurities, in the load feed. Initially, all the components in the load feed will bind to the chromatography medium. Separation of the product of interest from the impurities/contaminants is driven by affinity for the chromatography medium. When the chromatography medium reaches saturation binding, those components in the load feed having a greater affinity for the chromatography medium (typically product-related impurities such as a HMW species) will displace proteins having a weaker affinity (e.g., the product of interest) resulting in the separation of the proteins with weaker affinity from the chromatography medium. These proteins exit the column in the load flow through. As loading proceeds the bound proteins are continuously displaced in order of increasing affinity for the chromatography medium until the column is at or near saturation with proteins having greater affinity than the protein of interest.

As used herein, the term “partition coefficient” or “product partition coefficient” (Kp) refers to the molar concentration of product, e.g. recombinant protein, bound to the stationary phase divided by the molar concentration of the product in the mobile phase during a chromatography step.

As used herein, the term “purified,” when used in relation to a composition, refers to a composition wherein at least one impurity is present at a lower concentration in the purified composition relative to the composition as it existed prior to one or more unit operations. Additionally, a “purified” recombinant protein (e.g., a purified antibody) refers to a recombinant purity which has been increased in purity, such that it exists in a form that is more pure than it exists in its natural environment and/or when initially synthesized and/or amplified under laboratory conditions. Purity is a relative term and does not necessarily refer to absolute purity.

As used herein, the term “recombinant protein” refers to a heterologous protein produced by a host cell transfected with a nucleic acid encoding the protein when the host cell is cultivated in cell culture.

As used herein, the term “unit operation” refers to a functional step that is performed as part of a process of purifying a recombinant protein of interest. Unit operations can be designed to achieve a single objective or multiple objectives, such as capture and virus inactivating steps. Unit operations can also include holding or storing steps between processing steps.

As used herein, the term “virus prefilter” refers to a filter upstream of and in fluid communication with a virus filter, which is capable of binding one or more bioprocess impurities to increase the flux and/or throughput of the virus filter.

As used herein, the term “filtration cycle” refers to a time period (such as, e.g., a continuous time period, such as, e.g., a continuous time period prior to a scheduled break) in which a composition is filtered through one virus filter. One virus filter may be used for one or more (e.g., one, two, three, four or more) filtration cycles, wherein a break occurs between each filtration cycle and the virus prefilter is optionally replaced for each filtration cycle.

As used herein, the phrase “the ratio of the virus prefilter area to the virus filter area” refers to the ratio of the virus prefilter area to the virus filter area in a given filtration cycle.

As used herein, the phrase “the net ratio of the virus prefilter area to the virus filter area” refers to the ratio of the cumulative virus prefilter area to the virus filter area in one or more filtration cycles (i.e., the ratio of the area of all virus prefilters used during the lifetime of a virus filter to the virus filter's area). The ratio of the virus prefilter area to the virus filter area and the net ratio of the virus prefilter area to the virus filter area may be the same (e.g., when the virus prefilter is not replaced during the lifetime of the virus filter) or different (e.g., when the virus prefilter is replaced between one or more filtration cycles during the lifetime of the virus filter).

### NON-LIMITING EXAMPLE FEATURES

Without limitation, some example embodiments/features of the present disclosure include:

E1. A method of removing at least one viral contaminant from a composition, comprising filtering the composition through a virus prefilter and a virus filter, wherein the ratio of the virus prefilter area to the virus filter area is at least about 2:1.
E2. The method according to E1, wherein the virus prefilter is a depth filter.
E3. The method according to E1 or E2, wherein the virus prefilter is a diatomaceous earth-based depth filter.
E4. The method according to E3, further comprising flushing the diatomaceous earth-based depth filter with water or buffer prior to filtering the composition.
E5. The method according to any one of E1 to E4, wherein the virus filter is comprised of at least one flat sheet.
E6. The method according to any one of E1 to E5, wherein the virus filter comprises polyethersulfone (PES).
E7. The method according to any one of E1 to E6, wherein the virus filter is a flat sheet PES membrane.
E8. The method according to any one of E1 to E7, wherein the virus filter is a small virus filter.
E9. The method according to any one of E1 to E7, wherein the virus filter is a large virus filter.
E10. The method according to any one of E1 to E9, wherein the ratio of the virus prefilter area to the virus filter area is about 2:1 to about 4:1.
E11. The method according to any one of E1 to E10, wherein the ratio of the virus prefilter area to the virus filter area is about 2:1 to about 3:1.
E12. The method according to any one of E1 to E11, wherein the ratio of the virus prefilter area to the virus filter area is about 2.5:1 to about 3:1.
E13. The method according to any one of E1 to E12, further comprising adjusting the pH of the composition to less than about 7.2 prior to filtering.
E14. The method according to any one of E1 to E12, further comprising adjusting the pH of the composition to about 5 to about 7 prior to filtering.
E15. The method according to any one of E1 to E14, further comprising adjusting the conductivity of the composition to at least about 10 mS/cm prior to filtering.
E16. The method according to any one of E1 to E15, further comprising adjusting the conductivity of the composition to at least about 12 mS/cm prior to filtering.
E17. The method according to any one of E1 to E15, further comprising adjusting the conductivity of the composition to about 10 mS/cm to about 20 mS/cm prior to filtering.
E18. The method according to any one of E1 to E17, comprising at least two filtration cycles, wherein the virus prefilter is optionally replaced after each filtration cycle.
E19. The method according to any one of E1 to E17, comprising at least two filtration cycles, wherein the virus prefilter is optionally replaced after each filtration cycle.
E20. The method according to any one of E1 to E17, comprising at least two filtration cycles, wherein the virus prefilter is replaced after each filtration cycle.
E21. The method according to any one of E1 to E17, comprising three filtration cycles, wherein the net ratio of the virus prefilter area to the virus filter area is at least about 6:1.
E22. The method according to E21, wherein the net ratio of the virus prefilter area to the virus filter area is about 6:1 to about 9:1.
E23. The method according to any one of E1 to E22, wherein the composition is filtered through the virus filter at a flux of about 100 L/m²/hr to about 500 L/m²/hr.
E24. The method according to any one of E1 to E23, wherein the composition is filtered through the virus filter at a flux of about 200 L/m²/hr to about 300 L/m²/hr.
E25. The method according to any one of E1 to E24, wherein the composition is filtered through the virus filter at a flux of about 250 L/m²/hr.
E26. The method according to any one of E1 to E25, wherein the composition is filtered through the virus filter at a pressure of about 10 psi to about 60 psi.
E27. The method according to any one of E1 to E26, wherein the composition is filtered through the virus filter at a pressure of about 30 psi.
E28. The method according to any one of E1 to E27, wherein the method comprises loading the virus filter to at least about 1500 L/m² over one or more filtration cycles.
E29. The method according to any one of E1 to E28, wherein the method comprises loading the virus filter to at least about 1500 L/m² over three filtration cycles.
E30. The method according to E29, wherein the method comprises loading the virus filter to at least about 500 L/m² for each of the three filtration cycles.
E31. The method according to E29 or E30, wherein the composition is filtered through the virus filter at a flux of at least about 250 L/m²/hr for each of the three filtration cycles.
E32. The method according to any one of E1 to E31, wherein the method comprises loading the virus filter to at least about 30,000 g/m² over one or more filtration cycles.
E33. The method according to E32, wherein the method comprises loading the virus filter to at least about 30,000 g/m² over three filtration cycles.
E34. The method according to any one of E1 to E33, wherein the at least one viral contaminant is selected from parvoviruses, retroviruses, pseudorabies viruses, and reoviruses.
E35. The method according to any one of E1 to E34, wherein the composition comprises a recombinant protein.
E36. The method according to E35, wherein the composition comprises at least about 15 g/L of the recombinant protein.
E37. The method according to E35 or E36, wherein the composition comprises about 15 g/L to about 25 g/L of the recombinant protein.
E38. The method according to any one of E1 to E37, wherein the filtering results in a log reduction value (LRV) of the at least one viral contaminant of at least about 4 for each of one or more filtration cycles.
E39. The method according to any one of E1 to E38, wherein the filtering results in a log reduction value (LRV) of the at least one viral contaminant of at least about 4 for each of three filtration cycles.
E40. A viral filtration skid comprising a virus prefilter and a virus filter, wherein the ratio of the virus prefilter area to the virus filter area is at least about 2:1.
E41. The viral filtration skid according to E40, wherein the virus prefilter is a depth filter.
E42. The viral filtration skid according to E40 or E41, wherein the virus prefilter is a diatomaceous earth-based depth filter.
E43. The viral filtration skid according to any one of E40 to E42, wherein the virus filter is comprised of at least one flat sheet.
E44. The viral filtration skid according to any one of E40 to E43, wherein the virus filter comprises polyethersulfone (PES).
E45. The viral filtration skid according to any one of E40 to E44, wherein the virus filter is a flat sheet PES membrane.
E46. The viral filtration skid according to any one of E40 to E45, wherein the virus filter is a small virus filter.
E47. The viral filtration skid according to any one of E40 to E45, wherein the virus filter is a large virus filter.
E48. The viral filtration skid according to any one of E40 to E47, wherein the ratio of the virus prefilter area to the virus filter area is about 2:1 to about 4:1.
E49. The viral filtration skid according to any one of E40 to E48, wherein the ratio of the virus prefilter area to the virus filter area is about 2:1 to about 3:1.
E50. The viral filtration skid according to any one of E40 to E49, wherein the ratio of the virus prefilter area to the virus filter area is about 2.5:1 to about 3:1.
E51. The viral filtration skid according to any one of E40 to E50, further comprising at least one in-line monitoring system.
E52. The viral filtration skid according to E51, wherein the at least one in-line monitoring system monitors at least one property selected from pressure, flow, pH, conductivity, and UV.
E53. The viral filtration skid according to any one of E40 to E52, wherein the virus prefilter is positioned in series with the virus filter.

Additionally, without limitation, some further example embodiments/features of the present disclosure include:

F1. A method of removing at least one viral contaminant from a composition, comprising filtering the composition through a virus prefilter and a virus filter, wherein:

the virus filter is loaded to at least about 1500 L/m² over one or more filtration cycles; and

a ratio of the virus prefilter area to the virus filter area in each filtration cycle is at least about 2:1.

F2. A method of removing at least one viral contaminant from a composition, comprising filtering the composition through a virus prefilter and a virus filter, wherein:

the virus filter is loaded to at least about 30,000 g/m² over one or more filtration cycles; and

a ratio of the virus prefilter area to the virus filter area in each filtration cycle is at least about 2:1.

F3. The method according to F1 or F2, comprising at least two filtration cycles, wherein the virus prefilter is optionally replaced after one or more filtration cycles.
F4. The method according to any one of F1 to F3, comprising at least two filtration cycles, wherein the virus prefilter is optionally replaced after each filtration cycle.
F5. The method according to F1 or F2, comprising at least two filtration cycles, wherein the virus prefilter is replaced after one or more filtration cycles.
F6. The method according to F1 or F2, comprising at least two filtration cycles, wherein the virus prefilter is replaced after each filtration cycle.
F7. A method of removing at least one viral contaminant from a composition, comprising filtering the composition through a virus prefilter and a virus filter over at least two filtration cycles, wherein the virus prefilter is replaced after each filtration cycle, wherein:

the virus filter is loaded to at least about 1500 L/m² over the at least two filtration cycles; and

a ratio of the virus prefilter area to the virus filter area in each filtration cycle is at least about 2:1.

F8. A method of removing at least one viral contaminant from a composition, comprising filtering the composition through a virus prefilter and a virus filter over at least two filtration cycles, wherein the virus prefilter is replaced after each filtration cycle, wherein:

the virus filter is loaded to at least about 30,000 g/m² over the at least two filtration cycles; and

a ratio of the virus prefilter area to the virus filter area in each filtration cycle is at least about 2:1.

F9. The method according to any one of F1 to F8, wherein the virus prefilter is a depth filter.
F10. The method according to any one of F1 to F9, wherein the virus prefilter is a diatomaceous earth-based depth filter.
F11. The method according to F10, further comprising flushing the diatomaceous earth-based depth filter with water or buffer prior to filtering the composition.
F12. The method according to any one of F1 to F11, wherein the virus filter is comprised of at least one flat sheet.
F13. The method according to any one of F1 to F12, wherein the virus filter comprises polyethersulfone (PES).
F14. The method according to any one of F1 to F13, wherein the virus filter is a flat sheet PES membrane.
F15. The method according to any one of F1 to F14, wherein the virus prefilter is a depth filter and the virus filter is a flat sheet PES membrane.
F16. The method according to any one of F1 to F8, wherein the virus prefilter is a diatomaceous earth-based depth filter and the virus filter is a flat sheet PES membrane.
F17. The method according to any one of F1 to F8, wherein the virus filter is a small virus filter.
F18. The method according to any one of F1 to F8, wherein the virus filter is a large virus filter.
F19. The method according to any one of F1 to F18, wherein the ratio of the virus prefilter area to the virus filter area in each filtration cycle is about 2:1 to about 4:1.
F20. The method according to any one of F1 to F19, wherein the ratio of the virus prefilter area to the virus filter area in each filtration cycle is about 2:1 to about 3:1.
F21. The method according to any one of F1 to F20, wherein the ratio of the virus prefilter area to the virus filter area in each filtration cycle is about 2.5:1 to about 3:1.
F22. The method according to any one of F1 to F21, further comprising adjusting the pH of the composition to less than about 7.2 prior to filtering.
F23. The method according to any one of F1 to F22, further comprising adjusting the pH of the composition to about 5 to about 7 prior to filtering.
F24. The method according to any one of F1 to F23, further comprising adjusting the conductivity of the composition to at least about 10 mS/cm prior to filtering.
F25. The method according to any one of F1 to F24, further comprising adjusting the conductivity of the composition to at least about 12 mS/cm prior to filtering.
F26. The method according to any one of F1 to F23, further comprising adjusting the conductivity of the composition to about 10 mS/cm to about 20 mS/cm prior to filtering.
F27. The method according to any one of F1 to F26, comprising three filtration cycles, wherein the net ratio of the virus prefilter area to the virus filter area over the three filtration cycles is at least about 6:1.
F28. The method according to F27, wherein the net ratio of the virus prefilter area to the virus filter area is about 6:1 to about 9:1.
F29. The method according to any one of F1 to F28, wherein the composition is filtered through the virus filter at a flux of about 100 L/m²/hr to about 500 L/m²/hr.
F30. The method according to any one of F1 to F29, wherein the composition is filtered through the virus filter at a flux of about 200 L/m²/hr to about 300 L/m²/hr.
F31. The method according to any one of F1 to F30, wherein the composition is filtered through the virus filter at a flux of about 250 L/m²/hr.
F32. The method according to any one of F1 to F31, wherein the composition is filtered through the virus filter at a pressure of about 10 psi to about 60 psi.
F33. The method according to any one of F1 to F32, wherein the composition is filtered through the virus filter at a pressure of about 30 psi.
F34. The method according to any one of F1 to F33, wherein the method comprises loading the virus filter to at least about 1500 L/m² (e.g., at least about 2000 L/m²; about 1500 L/m² to about 3000 L/m²) over three filtration cycles.
F35. The method according to F34, wherein the method comprises loading the virus filter to at least about 500 L/m² for each of the three filtration cycles.
F36. The method according to F34 or F35, wherein the composition is filtered through the virus filter at a flux of at least about 250 L/m²/hr for each of the three filtration cycles.
F37. The method according to any one of F1 to F36, wherein the method comprises loading the virus filter to at least about 30,000 g/m² over three filtration cycles.
F38. The method according to any one of F1 to F37, wherein the at least one viral contaminant is selected from parvoviruses, retroviruses, pseudorabies viruses, and reoviruses.
F39. The method according to any one of F1 to F38, wherein the composition comprises a recombinant protein.
F40. The method according to F39, wherein the recombinant protein is an antibody (e.g., an IgG2 antibody).
F41. The method according to any one of F1-F16 or F19-F40, wherein:

the virus prefilter is a diatomaceous earth-based depth filter;

the virus filter comprises polyethersulfone (PES); and

the method further comprises flushing the diatomaceous earth-based depth filter with a carbonate-containing solution prior to filtering the composition.

F42. The method according to F41, wherein:

the virus prefilter is a diatomaceous earth-based depth filter;

the virus filter comprises polyethersulfone (PES);

the method further comprises flushing the diatomaceous earth-based depth filter with a carbonate-containing solution prior to filtering the composition; and

after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L).

F43. The method according to F41 or F42, wherein the carbonate-containing solution comprises sodium carbonate, potassium carbonate, or a mixture thereof.
F44. The method according to any one of F41 to F43, wherein, after filtering the composition, the composition has a β-glucan concentration of less than about 10 μg/L.
F45. The method according to any one of F1-F16 or F19-F40, wherein:

the virus prefilter is a diatomaceous earth-based depth filter;

the virus filter comprises polyethersulfone (PES); and

the method further comprises flushing the diatomaceous earth-based depth filter with sodium carbonate prior to filtering the composition.

F46. The method according to F45, wherein, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L).
F47. The method according to any one of F1 to F40, wherein, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L).
F48. The method according to any one of F1 to F47, wherein the composition comprises at least about 10 g/L of a recombinant protein.
F49. The method according to any one of F1 to F47, wherein the composition comprises at least about 12.5 g/L of a recombinant protein.
F50. The method according to any one of F1 to F47, wherein the composition comprises at least about 15 g/L of a recombinant protein.
F51. The method according to any one of F1 to F47, wherein the composition comprises about 15 g/L to about 25 g/L of a recombinant protein.
F52. The method according to any one of F1 to F47, wherein the composition comprises about 15 g/L to about 20 g/L of a recombinant protein.
F53. The method according to any one of F1 to F52, wherein the filtering results in a log reduction value (LRV) of the at least one viral contaminant of at least about 4 for each of one or more filtration cycles.
F54. The method according to any one of F1 to F53, wherein the filtering results in a log reduction value (LRV) of the at least one viral contaminant of at least about 4 for each of three filtration cycles.
F55. A viral filtration skid for use in a method according to any one of F1 to F54.

### Viral Filtration Methods Using an Oversized Prefilter

Provided herein is a method of removing at least one viral contaminant from a composition, comprising filtering the composition through a virus prefilter and a virus filter, wherein the ratio of the virus prefilter area to the virus filter area is at least about 2:1.

In some embodiments, the virus prefilter is a depth filter. In some embodiments, the virus prefilter is a diatomaceous earth-based depth filter. In some embodiments, the virus prefilter is a depth filter comprising diatomaceous earth, cellulose fibers, and a binder comprising cationic imine groups.

In some embodiments, the virus prefilter is a diatomaceous earth-based depth filter, and the method further comprises flushing the diatomaceous earth-based depth filter with water or buffer prior to filtering the composition.

In some embodiments, the virus prefilter is a microfiltration membrane. In some embodiments, the virus prefilter is an about 0.2 μm membrane. In some embodiments, the virus prefilter is an about 0.1 μm membrane. In some embodiments, the virus prefilter is an about 75 nm membrane.

In some embodiments, the virus prefilter is an absorptive membrane. In some embodiments, the virus prefilter is an absorptive membrane with ion exchange functionality.

In some embodiments, the virus prefilter is a flat sheet membrane. In some embodiments, the virus prefilter is a flat sheet membrane with a polyethersulfone (PES) membrane surface modified via cross-linked polymeric sulfonic acid cation exchange chemistry. In some embodiments, the virus prefilter is a flat sheet membrane with a PES membrane surface modified via cross-linked mixed-mode chemistry.

In some embodiments, the virus prefilter is a triple layer, flat sheet membrane. In some embodiments, the virus prefilter is a polyamide triple layer, flat sheet membrane.

In some embodiments, the virus prefilter is a pleated sheet membrane. In some embodiments, the virus prefilter is a pleated sheet membrane comprising nylon. In some embodiments, the virus prefilter is a pleated sheet membrane comprising hydrophilic acrylate-modified PVDF.

In some embodiments, the virus prefilter is an asymmetric, single layer hollow fiber membrane. In some embodiments, the virus prefilter is an asymmetric, single layer hollow fiber membrane, and the virus prefilter comprises hydrophilic cuprammonium regenerated cellulose.

In some embodiments, the virus filter is comprised of at least one flat sheet. In some embodiments, the virus filter comprises an asymmetric, double layer flat sheet. In some embodiments, the virus filter comprises an asymmetric, double layer flat sheet, and the virus filter comprises hydrophilic polyethersulfone (PES).

In some embodiments, the virus filter is comprised of at least one pleated sheet.

In some embodiments, the virus filter is a pleated sheet. In some embodiments, the virus filter is a pleated sheet, and the virus filter comprises hydrophilic PES.

In some embodiments, the virus filter comprises an asymmetric, double layer pleated sheet. In some embodiments, the virus filter comprises an asymmetric, double layer pleated sheet, and the virus filter comprises hydrophilic PES. In some embodiments, the virus filter comprises an asymmetric, double layer pleated sheet, and the virus filter comprises surface modified PES. In some embodiments, the virus filter comprises an asymmetric, triple layer pleated sheet. In some embodiments, the virus filter comprises an asymmetric, triple layer pleated sheet, and the virus filter comprises hydrophilic PES. In some embodiments, the virus filter comprises an asymmetric, triple layer pleated sheet, and the virus filter comprises hydrophilic polyvinylidene fluoride (PVDF).

In some embodiments, the virus filter comprises a symmetric, double layer pleated sheet. In some embodiments, the virus filter comprises a symmetric, double layer pleated sheet, and the virus filter comprises hydrophilic acrylate-modified PVDF. In some embodiments, the virus filter comprises a symmetric, triple layer pleated sheet. In some embodiments, the virus filter comprises a symmetric, triple layer pleated sheet, and the virus filter comprises hydrophilic acrylate-modified PVDF.

In some embodiments, the virus filter is comprised of hollow fibers. In some embodiments, the virus filter is an asymmetric, single layer hollow fiber membrane. In some embodiments, the virus filter is an asymmetric, single layer hollow fiber membrane, and the virus filter comprises hydrophilic cuprammonium regenerated cellulose. In some embodiments, the virus filter is an asymmetric, single layer hollow fiber membrane, and the virus filter comprises modified PVDF. In some embodiments, the virus filter is an asymmetric, single layer hollow fiber membrane, and the virus filter comprises hydrophilic PES.

In some embodiments, the virus filter comprises hydrophilic PES. In some embodiments, the virus filter comprises surface modified PES.

In some embodiments, the virus filter comprises modified PVDF. In some embodiments, the virus filter comprises hydrophilic PVDF. In some embodiments, the virus filter comprises hydrophilic acrylate-modified PVDF.

In some embodiments, the virus filter comprises hydrophilic cuprammonium regenerated cellulose.

In some embodiments, the virus filter is a small virus filter.

In some embodiments, the virus filter is a large virus filter.

In some embodiments, the ratio of the virus prefilter area to the virus filter area is about 2:1 to about 4:1. In some embodiments, the ratio of the virus prefilter area to the virus filter area is about 2:1 to about 3:1. In some embodiments, the ratio of the virus prefilter area to the virus filter area is about 2.5:1 to about 3:1.

In some embodiments, the ratio of the virus prefilter area to the virus filter area is about 2.4:1. In some embodiments, the ratio of the virus prefilter area to the virus filter area is about 2.6:1. In some embodiments, the ratio of the virus prefilter area to the virus filter area is about 2.9:1.

In some embodiments, the method further comprises pre-conditioning the composition prior to filtering. In some embodiments, the method further comprises in-line pre-conditioning the composition prior to filtering.

In some embodiments, the method further comprises adjusting the pH of the composition to less than about 7.5 prior to filtering. In some embodiments, the method further comprises adjusting the pH of the composition to less than about 7.2 prior to filtering. In some embodiments, the method further comprises adjusting the pH of the composition to less than about 7 prior to filtering. In some embodiments, the method further comprises adjusting the pH of the composition to about 5 to about 7 prior to filtering. In some embodiments, the method further comprises adjusting the pH of the composition to about 6 to about 7 prior to filtering.

In some embodiments, the method further comprises adjusting the conductivity of the composition to at least about 10 mS/cm prior to filtering. In some embodiments, the method further comprises adjusting the conductivity of the composition to at least about 12 mS/cm prior to filtering. In some embodiments, the method further comprises adjusting the conductivity of the composition to about 10 mS/cm to about 20 mS/cm prior to filtering.

In some embodiments, the composition is filtered through the virus filter in normal flow filtration mode. In some embodiments, the composition is filtered through the virus filter in tangential flow filtration mode.

In some embodiments, the composition is filtered through the virus prefilter and the virus filter in normal flow filtration mode.

In some embodiments, the composition is filtered through the virus filter at a flux of about 100 L/m²/hr to about 500 L/m²/hr. In some embodiments, the composition is filtered through the virus filter at a flux of about 200 L/m²/hr to about 400 L/m²/hr. In some embodiments, the composition is filtered through the virus filter at a flux of about 200 L/m²/hr to about 300 L/m²/hr.

In some embodiments, the composition is filtered through the virus filter at a flux of about 100 L/m²/hr. In some embodiments, the composition is filtered through the virus filter at a flux of about 150 L/m²/hr. In some embodiments, the composition is filtered through the virus filter at a flux of about 200 L/m²/hr. In some embodiments, the composition is filtered through the virus filter at a flux of about 250 L/m²/hr. In some embodiments, the composition is filtered through the virus filter at a flux of about 300 L/m²/hr. In some embodiments, the composition is filtered through the virus filter at a flux of about 350 L/m²/hr. In some embodiments, the composition is filtered through the virus filter at a flux of about 400 L/m²/hr.

In some embodiments, the composition is filtered through the virus filter at a pressure of about 10 psi to about 60 psi. In some embodiments, the composition is filtered through the virus filter at a pressure of about 20 psi to about 50 psi.

In some embodiments, the composition is filtered through the virus filter at an inlet pressure and/or a differential pressure of about 10 psi/psid to about 60 psi/psid. In some embodiments, the composition is filtered through the virus filter at an inlet pressure and/or a differential pressure of about 20 psi/psid to about 50 psi/psid.

In some embodiments, the composition is filtered through the virus filter in a constant flow mode at an inlet pressure of about 10 psi to about 60 psi. In some embodiments, the composition is filtered through the virus filter in a constant flow mode at an inlet pressure of about 20 psi to about 50 psi.

In some embodiments, the composition is filtered through the virus filter in a constant pressure mode at a differential pressure of about 10 psid to about 60 psid. In some embodiments, the composition is filtered through the virus filter in a constant pressure mode at an inlet pressure of about 20 psid to about 50 psid.

In some embodiments, the composition is filtered through the virus filter at a pressure of about 10 psi. In some embodiments, the composition is filtered through the virus filter at a pressure of about 20 psi. In some embodiments, the composition is filtered through the virus filter at a pressure of about 30 psi. In some embodiments, the composition is filtered through the virus filter at a pressure of about 40 psi. In some embodiments, the composition is filtered through the virus filter at a pressure of about 50 psi. In some embodiments, the composition is filtered through the virus filter at a pressure of about 60 psi.

In some embodiments, the composition is filtered through the virus filter in a constant flow mode at an inlet pressure of about 10 psi. In some embodiments, the composition is filtered through the virus filter in a constant flow mode at an inlet pressure of about 20 psi. In some embodiments, the composition is filtered through the virus filter in a constant flow mode at an inlet pressure of about 30 psi. In some embodiments, the composition is filtered through the virus filter in a constant flow mode at an inlet pressure of about 40 psi. In some embodiments, the composition is filtered through the virus filter in a constant flow mode at an inlet pressure of about 50 psi. In some embodiments, the composition is filtered through the virus filter in a constant flow mode at an inlet pressure of about 60 psi.

In some embodiments, the composition is filtered through the virus filter in a constant pressure mode at a differential pressure of about 10 psid. In some embodiments, the composition is filtered through the virus filter in a constant pressure mode at a differential pressure of about 20 psid. In some embodiments, the composition is filtered through the virus filter in a constant pressure mode at a differential pressure of about 30 psid. In some embodiments, the composition is filtered through the virus filter in a constant pressure mode at a differential pressure of about 40 psid. In some embodiments, the composition is filtered through the virus filter in a constant pressure mode at a differential pressure of about 50 psid. In some embodiments, the composition is filtered through the virus filter in a constant pressure mode at a differential pressure of about 60 psid.

In some embodiments, the composition is filtered through the virus filter at an inlet pressure and/or a differential pressure of about 10 psi/psid. In some embodiments, the composition is filtered through the virus filter at an inlet pressure and/or a differential pressure of about 20 psi/psid. In some embodiments, the composition is filtered through the virus filter at an inlet pressure and/or a differential pressure of about 30 psi/psid. In some embodiments, the composition is filtered through the virus filter at an inlet pressure and/or a differential pressure of about 40 psi/psid. In some embodiments, the composition is filtered through the virus filter at an inlet pressure and/or a differential pressure of about 50 psi/psid. In some embodiments, the composition is filtered through the virus filter at an inlet pressure and/or a differential pressure of about 60 psi/psid.

In some embodiments, the method comprises loading the virus filter to at least about 1500 L/m² over one or more filtration cycles. In some embodiments, the method comprises loading the virus filter to at least about 1500 L/m² over one filtration cycle. In some embodiments, the method comprises loading the virus filter to at least about 1500 L/m² over two filtration cycles. In some embodiments, the method comprises loading the virus filter to at least about 1500 L/m² over three filtration cycles. In some embodiments, the method comprises loading the virus filter to at least about 1500 L/m² over more than three filtration cycles.

In some embodiments, the method comprises loading the virus filter to about 1500 L/m² to about 3000 L/m² over one or more filtration cycles. In some embodiments, the method comprises loading the virus filter to about 1500 L/m² to about 3000 about L/m² over one filtration cycle. In some embodiments, the method comprises loading the virus filter to about 1500 L/m² to about 3000 about L/m² over two filtration cycles. In some embodiments, the method comprises loading the virus filter to about 1500 L/m² to about 3000 about L/m² over three filtration cycles. In some embodiments, the method comprises loading the virus filter to about 1500 L/m² to about 3000 about L/m² over more than three filtration cycles.

In some embodiments, the method comprises loading the virus filter to about 1500 L/m² to about 2000 L/m² over one or more filtration cycles. In some embodiments, the method comprises loading the virus filter to about 1500 L/m² to about 2000 about L/m² over one filtration cycle. In some embodiments, the method comprises loading the virus filter to about 1500 L/m² to about 2000 about L/m² over two filtration cycles. In some embodiments, the method comprises loading the virus filter to about 1500 L/m² to about 2000 about L/m² over three filtration cycles. In some embodiments, the method comprises loading the virus filter to about 1500 L/m² to about 2000 about L/m² over more than three filtration cycles.

In some embodiments, the method comprises loading the virus filter to at most about 3000 L/m² over one or more filtration cycles. In some embodiments, the method comprises loading the virus filter to at most about 3000 L/m² over one filtration cycle. In some embodiments, the method comprises loading the virus filter to at most about 3000 L/m² over two filtration cycles. In some embodiments, the method comprises loading the virus filter to at most about 3000 L/m² over three filtration cycles. In some embodiments, the method comprises loading the virus filter to at most about 3000 L/m² over more than three filtration cycles.

In some embodiments, the method comprises loading the virus filter to at most about 2000 L/m² over one or more filtration cycles. In some embodiments, the method comprises loading the virus filter to at most about 2000 L/m² over one filtration cycle. In some embodiments, the method comprises loading the virus filter to at most about 2000 L/m² over two filtration cycles. In some embodiments, the method comprises loading the virus filter to at most about 2000 L/m² over three filtration cycles. In some embodiments, the method comprises loading the virus filter to at most about 2000 L/m² over more than three filtration cycles.

In some embodiments, the method comprises loading the virus filter to at least about 30,000 g/m² over one or more filtration cycles. In some embodiments, the method comprises loading the virus filter to at least about 30,000 g/m² over one filtration cycle. In some embodiments, the method comprises loading the virus filter to at least about 30,000 g/m² over two filtration cycles. In some embodiments, the method comprises loading the virus filter to at least about 30,000 g/m² over three filtration cycles. In some embodiments, the method comprises loading the virus filter to at least about 30,000 g/m² over more than three filtration cycles.

In some embodiments, the method comprises loading the virus filter to at least about 50,000 g/m² over one or more filtration cycles. In some embodiments, the method comprises loading the virus filter to at least about 50,000 g/m² over one filtration cycle. In some embodiments, the method comprises loading the virus filter to at least about 50,000 g/m² over two filtration cycles. In some embodiments, the method comprises loading the virus filter to at least about 50,000 g/m² over three filtration cycles. In some embodiments, the method comprises loading the virus filter to at least about 50,000 g/m² over more than three filtration cycles.

In some embodiments, the method comprises loading the virus filter to at least about 60,000 g/m² over one or more filtration cycles. In some embodiments, the method comprises loading the virus filter to at least about 60,000 g/m² over one filtration cycle. In some embodiments, the method comprises loading the virus filter to at least about 60,000 g/m² over two filtration cycles. In some embodiments, the method comprises loading the virus filter to at least about 60,000 g/m² over three filtration cycles. In some embodiments, the method comprises loading the virus filter to at least about 60,000 g/m² over more than three filtration cycles.

In some embodiments, the at least one viral contaminant is selected from parvoviruses, retroviruses, pseudorabies viruses, and reoviruses. In some embodiments, the at least one viral contaminant is a parvovirus. In some embodiments, the at least one viral contaminant is a retrovirus. In some embodiments, the at least one viral contaminant is a pseudorabies virus. In some embodiments, the at least one viral contaminant is a reovirus.

In some embodiments, the composition comprises a recombinant protein. In some embodiments, the recombinant protein is an antibody. In some embodiments, the recombinant protein is a bispecific antibody. In some embodiments, the recombinant protein is an antibody fragment. In some embodiments, the recombinant protein is a single-chain variable fragment. In some embodiments, the recombinant protein is a fusion protein.

In some embodiments, the composition comprises at least about 15 g/L of a recombinant protein. In some embodiments, the composition comprises at least about 17.5 g/L of a recombinant protein. In some embodiments, the composition comprises at least about 20 g/L of a recombinant protein. In some embodiments, the composition comprises at least about 25 g/L of a recombinant protein. In some embodiments, the composition comprises at least about 30 g/L of a recombinant protein. In some embodiments, the composition comprises about 15 g/L to about 25 g/L of a recombinant protein. In some embodiments, the composition comprises about 15 g/L to about 50 g/L of a recombinant protein.

In some embodiments, the filtering results in a log reduction value (LRV) of the at least one viral contaminant of at least about 4 for each of one or more filtration cycles. In some embodiments, the filtering results in a log reduction value (LRV) of the at least one viral contaminant of at least about 4 for one filtration cycle. In some embodiments, the filtering results in a log reduction value (LRV) of the at least one viral contaminant of at least about 4 for each of two filtration cycles. In some embodiments, the filtering results in a log reduction value (LRV) of the at least one viral contaminant of at least about 4 for each of three filtration cycles. In some embodiments, the filtering results in a log reduction value (LRV) of the at least one viral contaminant of at least about 4 for each of more than three filtration cycles.

In some embodiments, the filtering results in a log reduction value (LRV) of at least one parvovirus of at least about 4 for each of one or more filtration cycles. In some embodiments, the filtering results in a log reduction value (LRV) of at least one parvovirus of at least about 4 for one filtration cycle. In some embodiments, the filtering results in a log reduction value (LRV) of at least one parvovirus of at least about 4 for each of two filtration cycles. In some embodiments, the filtering results in a log reduction value (LRV) of at least one parvovirus of at least about 4 for each of three filtration cycles. In some embodiments, the filtering results in a log reduction value (LRV) of at least one parvovirus of at least about 4 for each of more than three filtration cycles.

In some embodiments, the filtering results in a log reduction value (LRV) of the at least one viral contaminant of about 4 to about 7 for each of one or more filtration cycles. In some embodiments, the filtering results in a log reduction value (LRV) of the at least one viral contaminant of about 4 to about 7 for one filtration cycle. In some embodiments, the filtering results in a log reduction value (LRV) of the at least one viral contaminant of about 4 to about 7 for each of two filtration cycles. In some embodiments, the filtering results in a log reduction value (LRV) of the at least one viral contaminant of about 4 to about 7 for each of three filtration cycles. In some embodiments, the filtering results in a log reduction value (LRV) of the at least one viral contaminant of about 4 to about 7 for each of more than three filtration cycles.

In some embodiments, the filtering results in a log reduction value (LRV) of at least one parvovirus of about 4 to about 7 for each of one or more filtration cycles. In some embodiments, the filtering results in a log reduction value (LRV) of at least one parvovirus of about 4 to about 7 for one filtration cycle. In some embodiments, the filtering results in a log reduction value (LRV) of at least one parvovirus of about 4 to about 7 for each of two filtration cycles. In some embodiments, the filtering results in a log reduction value (LRV) of at least one parvovirus of about 4 to about 7 for each of three filtration cycles. In some embodiments, the filtering results in a log reduction value (LRV) of at least one parvovirus of about 4 to about 7 for each of more than three filtration cycles.

Provided herein a method of removing at least one viral contaminant from a composition, comprising filtering the composition through a virus prefilter and a virus filter, wherein:

the virus filter is loaded to at least about 1500 L/m² and/or at least about 30,000 g/m² over one or more filtration cycles; and

a ratio of the virus prefilter area to the virus filter area in each filtration cycle is at least about 2:1.

In some embodiments, the virus filter is loaded to at least about 1500 L/m² over one or more filtration cycles. In some embodiments, the virus filter is loaded to at least about 2000 L/m² over one or more filtration cycles.

In some embodiments, the virus filter is loaded to about 1500 L/m² to about 3000 L/m² over one or more filtration cycles. In some embodiments, the virus filter is loaded to about 2000 L/m² to about 3000 L/m² over one or more filtration cycles. In some embodiments, the virus filter is loaded to about 2500 L/m² to about 3000 L/m² over one or more filtration cycles.

In some embodiments, the virus filter is loaded to at least about 30,000 g/m² over one or more filtration cycles.

In some embodiments, the composition comprises a recombinant protein.

In some embodiments, the composition comprises at least about 10 g/L of a recombinant protein (e.g., at least about 10.5 g/L, at least about 11 g/L, at least about 11.5 g/L, at least about 12 g/L, at least about 12.5 g/L, at least about 13 g/L, at least about 13.5 g/L, at least about 14 g/L, at least about 14.5 g/L, at least about 15 g/L; about 10 g/L; about 10.5 g/L, about 11 g/L; about 11.5 g/L; about 12 g/L; about 12.5 g/L; about 13 g/L; about 13.5 g/L; about 14 g/L; about 14.5 g/L; about 15 g/L; about 15.5 g/L; about 16 g/L; about 16.5 g/L; about 17 g/L; about 17.5 g/L; about 18 g/L; about 18.5 g/L; about 19 g/L; about 19.5 g/L; about 20 g/L; about 20.5 g/L; about 21 g/L; about 21.5 g/L; about 22 g/L; about 22.5 g/L; about 23 g/L; about 23.5 g/L; about 24 g/L; about 24.5 g/L; about 25 g/L).

In some embodiments, the composition comprises at least about 12.5 g/L of a recombinant protein. In some embodiments, the composition comprises at least about 15 g/L of a recombinant protein.

In some embodiments, the composition comprises at least about 17.5 g/L of a recombinant protein. In some embodiments, the composition comprises at least about 20 g/L of a recombinant protein. In some embodiments, the composition comprises at least about 25 g/L of a recombinant protein. In some embodiments, the composition comprises at least about 30 g/L of a recombinant protein. In some embodiments, the composition comprises about 15 g/L to about 25 g/L of a recombinant protein. In some embodiments, the composition comprises about 15 g/L to about 50 g/L of a recombinant protein.

In some embodiments, the composition comprises about 15 g/L to about 25 g/L of a recombinant protein. In some embodiments, the composition comprises about 15 g/L to about 20 g/L of a recombinant protein.

In some embodiments, the method comprises at least two filtration cycles, wherein the virus prefilter is optionally replaced after one or more filtration cycles. In some embodiments, the method comprises at least two filtration cycles, wherein the virus prefilter is replaced after one or more filtration cycles.

In some embodiments, the method comprises at least two filtration cycles, wherein the virus prefilter is optionally replaced after each filtration cycle. In some embodiments, the method comprises at least two filtration cycles, wherein the virus prefilter is replaced after each filtration cycle.

In some embodiments, the virus prefilter is a depth filter. In some embodiments, the virus prefilter is a diatomaceous earth-based depth filter. In some embodiments, the virus prefilter is a depth filter comprising diatomaceous earth, cellulose fibers, and a binder comprising cationic imine groups.

In some embodiments, the virus prefilter is a diatomaceous earth-based depth filter, and the method further comprises flushing the diatomaceous earth-based depth filter with water or buffer prior to filtering the composition.

In some embodiments, the virus prefilter is a diatomaceous earth-based depth filter, and the method further comprises flushing the diatomaceous earth-based depth filter with a carbonate-containing solution prior to filtering the composition. In some embodiments, the virus prefilter is a diatomaceous earth-based depth filter, the method further comprises flushing the diatomaceous earth-based depth filter with a carbonate-containing solution prior to filtering the composition, and, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, the carbonate-containing solution comprises sodium carbonate, potassium carbonate, or a mixture thereof. In some embodiments, the carbonate-containing solution comprises sodium carbonate.

In some embodiments, the virus prefilter is a diatomaceous earth-based depth filter, the virus filter comprises polyethersulfone (PES), and the method further comprises flushing the diatomaceous earth-based depth filter with a carbonate-containing solution prior to filtering the composition. In some embodiments, the virus prefilter is a diatomaceous earth-based depth filter, the virus filter comprises polyethersulfone (PES), and the method further comprises flushing the diatomaceous earth-based depth filter with a carbonate-containing solution prior to filtering the composition, and, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, the carbonate-containing solution comprises sodium carbonate, potassium carbonate, or a mixture thereof. In some embodiments, the carbonate-containing solution comprises sodium carbonate.

In some embodiments, the virus prefilter is a diatomaceous earth-based depth filter, the virus filter comprises polyethersulfone (PES), and the method further comprises flushing the diatomaceous earth-based depth filter with sodium carbonate prior to filtering the composition.

In some embodiments, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, after filtering the composition, the composition has a β-glucan concentration of less than about 10 μg/L. In some embodiments, after filtering the composition, the composition has a β-glucan concentration of about 5 μg/L to less than about 15 μg/L. In some embodiments, after filtering the composition, the composition has a β-glucan concentration of about 5 μg/L to less than about 12.5 μg/L. In some embodiments, after filtering the composition, the composition has a β-glucan concentration of about 5 μg/L to less than about 10 μg/L.

In some embodiments, the virus prefilter is a microfiltration membrane. In some embodiments, the virus prefilter is an about 0.2 μm membrane. In some embodiments, the virus prefilter is an about 0.1 μm membrane. In some embodiments, the virus prefilter is an about 75 nm membrane.

In some embodiments, the virus prefilter is an absorptive membrane. In some embodiments, the virus prefilter is an absorptive membrane with ion exchange functionality.

In some embodiments, the virus prefilter is a flat sheet membrane. In some embodiments, the virus prefilter is a flat sheet membrane with a polyethersulfone (PES) membrane surface modified via cross-linked polymeric sulfonic acid cation exchange chemistry. In some embodiments, the virus prefilter is a flat sheet membrane with a PES membrane surface modified via cross-linked mixed-mode chemistry.

In some embodiments, the virus prefilter is a triple layer, flat sheet membrane. In some embodiments, the virus prefilter is a polyamide triple layer, flat sheet membrane.

In some embodiments, the virus prefilter is a pleated sheet membrane. In some embodiments, the virus prefilter is a pleated sheet membrane comprising nylon. In some embodiments, the virus prefilter is a pleated sheet membrane comprising hydrophilic acrylate-modified PVDF.

In some embodiments, the virus prefilter is an asymmetric, single layer hollow fiber membrane. In some embodiments, the virus prefilter is an asymmetric, single layer hollow fiber membrane, and the virus prefilter comprises hydrophilic cuprammonium regenerated cellulose.

In some embodiments, the virus filter is comprised of at least one flat sheet. In some embodiments, the virus filter comprises an asymmetric, double layer flat sheet. In some embodiments, the virus filter comprises an asymmetric, double layer flat sheet, and the virus filter comprises hydrophilic polyethersulfone (PES).

In some embodiments, the virus filter is comprised of at least one pleated sheet.

In some embodiments, the virus filter is a pleated sheet. In some embodiments, the virus filter is a pleated sheet, and the virus filter comprises hydrophilic PES.

In some embodiments, the virus filter comprises an asymmetric, double layer pleated sheet. In some embodiments, the virus filter comprises an asymmetric, double layer pleated sheet, and the virus filter comprises hydrophilic PES. In some embodiments, the virus filter comprises an asymmetric, double layer pleated sheet, and the virus filter comprises surface modified PES. In some embodiments, the virus filter comprises an asymmetric, triple layer pleated sheet. In some embodiments, the virus filter comprises an asymmetric, triple layer pleated sheet, and the virus filter comprises hydrophilic PES. In some embodiments, the virus filter comprises an asymmetric, triple layer pleated sheet, and the virus filter comprises hydrophilic polyvinylidene fluoride (PVDF).

In some embodiments, the virus filter comprises a symmetric, double layer pleated sheet. In some embodiments, the virus filter comprises a symmetric, double layer pleated sheet, and the virus filter comprises hydrophilic acrylate-modified PVDF. In some embodiments, the virus filter comprises a symmetric, triple layer pleated sheet. In some embodiments, the virus filter comprises a symmetric, triple layer pleated sheet, and the virus filter comprises hydrophilic acrylate-modified PVDF.

In some embodiments, the virus filter is comprised of hollow fibers. In some embodiments, the virus filter is an asymmetric, single layer hollow fiber membrane. In some embodiments, the virus filter is an asymmetric, single layer hollow fiber membrane, and the virus filter comprises hydrophilic cuprammonium regenerated cellulose. In some embodiments, the virus filter is an asymmetric, single layer hollow fiber membrane, and the virus filter comprises modified PVDF. In some embodiments, the virus filter is an asymmetric, single layer hollow fiber membrane, and the virus filter comprises hydrophilic PES.

In some embodiments, the virus filter comprises hydrophilic PES. In some embodiments, the virus filter comprises surface modified PES.

In some embodiments, the virus filter comprises modified PVDF. In some embodiments, the virus filter comprises hydrophilic PVDF. In some embodiments, the virus filter comprises hydrophilic acrylate-modified PVDF.

In some embodiments, the virus filter comprises hydrophilic cuprammonium regenerated cellulose.

In some embodiments, the virus filter is a small virus filter.

In some embodiments, the virus filter is a large virus filter.

In some embodiments, the ratio of the virus prefilter area to the virus filter area in each filtration cycle is about 2:1 to about 4:1. In some embodiments, the ratio of the virus prefilter area to the virus filter area in each filtration cycle is about 2:1 to about 3:1. In some embodiments, the ratio of the virus prefilter area to the virus filter area in each filtration cycle is about 2.5:1 to about 3:1.

In some embodiments, the ratio of the virus prefilter area to the virus filter area in each filtration cycle is about 2.4:1. In some embodiments, the ratio of the virus prefilter area to the virus filter area in each filtration cycle is about 2.6:1. In some embodiments, the ratio of the virus prefilter area to the virus filter area in each filtration cycle is about 2.9:1.

In some embodiments, the method further comprises pre-conditioning the composition prior to filtering. In some embodiments, the method further comprises in-line pre-conditioning the composition prior to filtering.

In some embodiments, the method further comprises adjusting the pH of the composition to less than about 7.5 prior to filtering. In some embodiments, the method further comprises adjusting the pH of the composition to less than about 7.2 prior to filtering. In some embodiments, the method further comprises adjusting the pH of the composition to less than about 7 prior to filtering. In some embodiments, the method further comprises adjusting the pH of the composition to about 5 to about 7 prior to filtering. In some embodiments, the method further comprises adjusting the pH of the composition to about 6 to about 7 prior to filtering.

In some embodiments, the method further comprises adjusting the conductivity of the composition to at least about 10 mS/cm prior to filtering. In some embodiments, the method further comprises adjusting the conductivity of the composition to at least about 12 mS/cm prior to filtering. In some embodiments, the method further comprises adjusting the conductivity of the composition to about 10 mS/cm to about 20 mS/cm prior to filtering.

In some embodiments, the pH of the composition is less than about 7.5. In some embodiments, the pH of the composition is less than about 7.2. In some embodiments, the pH of the composition is less than about 7. In some embodiments, the pH of the composition is about 5 to about 7. In some embodiments, the pH of the composition is about 6 to about 7.

In some embodiments, the conductivity of the composition is at least about 10 mS/cm. In some embodiments, the conductivity of the composition is at least about 12 mS/cm. In some embodiments, the conductivity of the composition is about 10 mS/cm to about 20 mS/cm.

In some embodiments, the pH of the composition is less than about 7.5, and the conductivity of the composition is at least about 10 mS/cm. In some embodiments, the pH of the composition is less than about 7.2, and the conductivity of the composition is at least about 10 mS/cm. In some embodiments, the pH of the composition is less than about 7, and the conductivity of the composition is at least about 10 mS/cm. In some embodiments, the pH of the composition is about 5 to about 7, and the conductivity of the composition is at least about 10 mS/cm. In some embodiments, the pH of the composition is about 6 to about 7, and the conductivity of the composition is at least about 10 mS/cm.

In some embodiments, the pH of the composition is less than about 7.5, and the conductivity of the composition is at least about 12 mS/cm. In some embodiments, the pH of the composition is less than about 7.2, and the conductivity of the composition is at least about 12 mS/cm. In some embodiments, the pH of the composition is less than about 7, and the conductivity of the composition is at least about 12 mS/cm. In some embodiments, the pH of the composition is about 5 to about 7, and the conductivity of the composition is at least about 12 mS/cm. In some embodiments, the pH of the composition is about 6 to about 7, and the conductivity of the composition is at least about 12 mS/cm.

In some embodiments, the composition is filtered through the virus filter in normal flow filtration mode. In some embodiments, the composition is filtered through the virus filter in tangential flow filtration mode.

In some embodiments, the composition is filtered through the virus prefilter and the virus filter in normal flow filtration mode.

In some embodiments, the composition is filtered through the virus filter at a flux of about 100 L/m²/hr to about 500 L/m²/hr. In some embodiments, the composition is filtered through the virus filter at a flux of about 200 L/m²/hr to about 400 L/m²/hr. In some embodiments, the composition is filtered through the virus filter at a flux of about 200 L/m²/hr to about 300 L/m²/hr.

In some embodiments, the composition is filtered through the virus filter at a flux of about 100 L/m²/hr. In some embodiments, the composition is filtered through the virus filter at a flux of about 150 L/m²/hr. In some embodiments, the composition is filtered through the virus filter at a flux of about 200 L/m²/hr. In some embodiments, the composition is filtered through the virus filter at a flux of about 250 L/m²/hr. In some embodiments, the composition is filtered through the virus filter at a flux of about 300 L/m²/hr. In some embodiments, the composition is filtered through the virus filter at a flux of about 350 L/m²/hr. In some embodiments, the composition is filtered through the virus filter at a flux of about 400 L/m²/hr.

In some embodiments, the composition is filtered through the virus filter at a pressure of about 10 psi to about 60 psi. In some embodiments, the composition is filtered through the virus filter at a pressure of about 20 psi to about 50 psi.

In some embodiments, the composition is filtered through the virus filter at an inlet pressure and/or a differential pressure of about 10 psi/psid to about 60 psi/psid. In some embodiments, the composition is filtered through the virus filter at an inlet pressure and/or a differential pressure of about 20 psi/psid to about 50 psi/psid.

In some embodiments, the composition is filtered through the virus filter in a constant flow mode at an inlet pressure of about 10 psi to about 60 psi. In some embodiments, the composition is filtered through the virus filter in a constant flow mode at an inlet pressure of about 20 psi to about 50 psi.

In some embodiments, the composition is filtered through the virus filter in a constant pressure mode at a differential pressure of about 10 psid to about 60 psid. In some embodiments, the composition is filtered through the virus filter in a constant pressure mode at an inlet pressure of about 20 psid to about 50 psid.

In some embodiments, the composition is filtered through the virus filter at a pressure of about 10 psi. In some embodiments, the composition is filtered through the virus filter at a pressure of about 20 psi. In some embodiments, the composition is filtered through the virus filter at a pressure of about 30 psi. In some embodiments, the composition is filtered through the virus filter at a pressure of about 40 psi. In some embodiments, the composition is filtered through the virus filter at a pressure of about 50 psi. In some embodiments, the composition is filtered through the virus filter at a pressure of about 60 psi.

In some embodiments, the composition is filtered through the virus filter in a constant flow mode at an inlet pressure of about 10 psi. In some embodiments, the composition is filtered through the virus filter in a constant flow mode at an inlet pressure of about 20 psi. In some embodiments, the composition is filtered through the virus filter in a constant flow mode at an inlet pressure of about 30 psi. In some embodiments, the composition is filtered through the virus filter in a constant flow mode at an inlet pressure of about 40 psi. In some embodiments, the composition is filtered through the virus filter in a constant flow mode at an inlet pressure of about 50 psi. In some embodiments, the composition is filtered through the virus filter in a constant flow mode at an inlet pressure of about 60 psi.

In some embodiments, the composition is filtered through the virus filter in a constant pressure mode at a differential pressure of about 10 psid. In some embodiments, the composition is filtered through the virus filter in a constant pressure mode at a differential pressure of about 20 psid. In some embodiments, the composition is filtered through the virus filter in a constant pressure mode at a differential pressure of about 30 psid. In some embodiments, the composition is filtered through the virus filter in a constant pressure mode at a differential pressure of about 40 psid. In some embodiments, the composition is filtered through the virus filter in a constant pressure mode at a differential pressure of about 50 psid. In some embodiments, the composition is filtered through the virus filter in a constant pressure mode at a differential pressure of about 60 psid.

In some embodiments, the composition is filtered through the virus filter at an inlet pressure and/or a differential pressure of about 10 psi/psid. In some embodiments, the composition is filtered through the virus filter at an inlet pressure and/or a differential pressure of about 20 psi/psid. In some embodiments, the composition is filtered through the virus filter at an inlet pressure and/or a differential pressure of about 30 psi/psid. In some embodiments, the composition is filtered through the virus filter at an inlet pressure and/or a differential pressure of about 40 psi/psid. In some embodiments, the composition is filtered through the virus filter at an inlet pressure and/or a differential pressure of about 50 psi/psid. In some embodiments, the composition is filtered through the virus filter at an inlet pressure and/or a differential pressure of about 60 psi/psid.

In some embodiments, the at least one viral contaminant is selected from parvoviruses, retroviruses, pseudorabies viruses, and reoviruses. In some embodiments, the at least one viral contaminant is a parvovirus. In some embodiments, the at least one viral contaminant is a retrovirus. In some embodiments, the at least one viral contaminant is a pseudorabies virus. In some embodiments, the at least one viral contaminant is a reovirus.

In some embodiments, the composition comprises a recombinant protein. In some embodiments, the recombinant protein is an antibody. In some embodiments, the recombinant protein is an IgG1, IgG2, or IgG4 antibody. In some embodiments, the recombinant protein is an IgG1 antibody. In some embodiments, the recombinant protein is an IgG2 antibody. In some embodiments, the recombinant protein is an IgG4 antibody. In some embodiments, the recombinant protein is a human antibody. In some embodiments, the recombinant protein is a human IgG1, IgG2, or IgG4 antibody. In some embodiments, the recombinant protein is a human IgG1 antibody. In some embodiments, the recombinant protein is a human IgG2 antibody. In some embodiments, the recombinant protein is a human IgG4 antibody.

In some embodiments, the recombinant protein is a bispecific antibody.

In some embodiments, the recombinant protein is an antibody fragment. In some embodiments, the recombinant protein is a single-chain variable fragment.

In some embodiments, the recombinant protein is a fusion protein.

In some embodiments, the filtering results in a log reduction value (LRV) of the at least one viral contaminant of at least about 4 for each of one or more filtration cycles. In some embodiments, the filtering results in a log reduction value (LRV) of the at least one viral contaminant of at least about 4 for one filtration cycle. In some embodiments, the filtering results in a log reduction value (LRV) of the at least one viral contaminant of at least about 4 for each of two filtration cycles. In some embodiments, the filtering results in a log reduction value (LRV) of the at least one viral contaminant of at least about 4 for each of three filtration cycles. In some embodiments, the filtering results in a log reduction value (LRV) of the at least one viral contaminant of at least about 4 for each of more than three filtration cycles.

In some embodiments, the filtering results in a log reduction value (LRV) of at least one parvovirus of at least about 4 for each of one or more filtration cycles. In some embodiments, the filtering results in a log reduction value (LRV) of at least one parvovirus of at least about 4 for one filtration cycle. In some embodiments, the filtering results in a log reduction value (LRV) of at least one parvovirus of at least about 4 for each of two filtration cycles. In some embodiments, the filtering results in a log reduction value (LRV) of at least one parvovirus of at least about 4 for each of three filtration cycles. In some embodiments, the filtering results in a log reduction value (LRV) of at least one parvovirus of at least about 4 for each of more than three filtration cycles.

In some embodiments, the filtering results in a log reduction value (LRV) of the at least one viral contaminant of about 4 to about 7 for each of one or more filtration cycles. In some embodiments, the filtering results in a log reduction value (LRV) of the at least one viral contaminant of about 4 to about 7 for one filtration cycle. In some embodiments, the filtering results in a log reduction value (LRV) of the at least one viral contaminant of about 4 to about 7 for each of two filtration cycles. In some embodiments, the filtering results in a log reduction value (LRV) of the at least one viral contaminant of about 4 to about 7 for each of three filtration cycles. In some embodiments, the filtering results in a log reduction value (LRV) of the at least one viral contaminant of about 4 to about 7 for each of more than three filtration cycles.

In some embodiments, the filtering results in a log reduction value (LRV) of at least one parvovirus of about 4 to about 7 for each of one or more filtration cycles. In some embodiments, the filtering results in a log reduction value (LRV) of at least one parvovirus of about 4 to about 7 for one filtration cycle. In some embodiments, the filtering results in a log reduction value (LRV) of at least one parvovirus of about 4 to about 7 for each of two filtration cycles. In some embodiments, the filtering results in a log reduction value (LRV) of at least one parvovirus of about 4 to about 7 for each of three filtration cycles. In some embodiments, the filtering results in a log reduction value (LRV) of at least one parvovirus of about 4 to about 7 for each of more than three filtration cycles.

Also provided herein is a method of removing at least one viral contaminant from a composition, comprising filtering the composition through a virus prefilter and a virus filter, wherein:

the virus filter is loaded to at least about 1500 L/m² and/or at least about 30,000 g/m² over one or more filtration cycles;

the virus prefilter is a depth filter;

the virus filter is comprised of at least one flat sheet; and

a ratio of the virus prefilter area to the virus filter area in each filtration cycle is at least about 2:1.

In some embodiments, the virus filter is loaded to at least about 2000 L/m² over one or more filtration cycles.

In some embodiments, the virus filter is loaded to about 1500 L/m² to about 3000 L/m² over one or more filtration cycles. In some embodiments, the virus filter is loaded to about 2000 L/m² to about 3000 L/m² over one or more filtration cycles. In some embodiments, the virus filter is loaded to about 2500 L/m² to about 3000 L/m² over one or more filtration cycles.

In some embodiments, the virus prefilter is a diatomaceous earth-based depth filter. In some embodiments, the virus filter comprises polyethersulfone (PES). In some embodiments, the virus prefilter is a diatomaceous earth-based depth filter, and the virus filter comprises polyethersulfone (PES).

In some embodiments, the composition comprises a recombinant protein.

In some embodiments, the composition comprises at least about 10 g/L of a recombinant protein (e.g., at least about 10.5 g/L, at least about 11 g/L, at least about 11.5 g/L, at least about 12 g/L, at least about 12.5 g/L, at least about 13 g/L, at least about 13.5 g/L, at least about 14 g/L, at least about 14.5 g/L, at least about 15 g/L; about 10 g/L; about 10.5 g/L, about 11 g/L; about 11.5 g/L; about 12 g/L; about 12.5 g/L; about 13 g/L; about 13.5 g/L; about 14 g/L; about 14.5 g/L; about 15 g/L; about 15.5 g/L; about 16 g/L; about 16.5 g/L; about 17 g/L; about 17.5 g/L; about 18 g/L; about 18.5 g/L; about 19 g/L; about 19.5 g/L; about 20 g/L; about 20.5 g/L; about 21 g/L; about 21.5 g/L; about 22 g/L; about 22.5 g/L; about 23 g/L; about 23.5 g/L; about 24 g/L; about 24.5 g/L; about 25 g/L).

In some embodiments, the composition comprises at least about 12.5 g/L of a recombinant protein. In some embodiments, the composition comprises at least about 15 g/L of a recombinant protein.

In some embodiments, the composition comprises at least about 17.5 g/L of a recombinant protein. In some embodiments, the composition comprises at least about 20 g/L of a recombinant protein. In some embodiments, the composition comprises at least about 25 g/L of a recombinant protein. In some embodiments, the composition comprises at least about 30 g/L of a recombinant protein. In some embodiments, the composition comprises about 15 g/L to about 25 g/L of a recombinant protein. In some embodiments, the composition comprises about 15 g/L to about 50 g/L of a recombinant protein.

In some embodiments, the composition comprises about 15 g/L to about 25 g/L of a recombinant protein. In some embodiments, the composition comprises about 15 g/L to about 20 g/L of a recombinant protein.

In some embodiments, the virus prefilter is a diatomaceous earth-based depth filter, and the method further comprises flushing the diatomaceous earth-based depth filter with a carbonate-containing solution prior to filtering the composition. In some embodiments, the virus prefilter is a diatomaceous earth-based depth filter, the method further comprises flushing the diatomaceous earth-based depth filter with a carbonate-containing solution prior to filtering the composition, and, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, the carbonate-containing solution comprises sodium carbonate, potassium carbonate, or a mixture thereof. In some embodiments, the carbonate-containing solution comprises sodium carbonate.

In some embodiments, the virus prefilter is a diatomaceous earth-based depth filter, the virus filter comprises polyethersulfone (PES), and the method further comprises flushing the diatomaceous earth-based depth filter with a carbonate-containing solution prior to filtering the composition. In some embodiments, the virus prefilter is a diatomaceous earth-based depth filter, the virus filter comprises polyethersulfone (PES), and the method further comprises flushing the diatomaceous earth-based depth filter with a carbonate-containing solution prior to filtering the composition, and, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, the carbonate-containing solution comprises sodium carbonate, potassium carbonate, or a mixture thereof. In some embodiments, the carbonate-containing solution comprises sodium carbonate.

In some embodiments, the virus prefilter is a diatomaceous earth-based depth filter, the virus filter comprises polyethersulfone (PES), and the method further comprises flushing the diatomaceous earth-based depth filter with sodium carbonate prior to filtering the composition.

In some embodiments, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, after filtering the composition, the composition has a β-glucan concentration of less than about 10 μg/L. In some embodiments, after filtering the composition, the composition has a β-glucan concentration of about 5 μg/L to less than about 15 μg/L. In some embodiments, after filtering the composition, the composition has a β-glucan concentration of about 5 μg/L to less than about 12.5 μg/L. In some embodiments, after filtering the composition, the composition has a β-glucan concentration of about 5 μg/L to less than about 10 μg/L.

In some embodiments, the virus filter is loaded to at least about 1500 L/m² over one or more filtration cycles.

In some embodiments, the virus filter is loaded to at least about 30,000 g/m² over one or more filtration cycles.

In some embodiments, the method comprises at least two filtration cycles, wherein the virus prefilter is optionally replaced after one or more filtration cycles. In some embodiments, the method comprises at least two filtration cycles, wherein the virus prefilter is replaced after one or more filtration cycles.

In some embodiments, the method comprises at least two filtration cycles, wherein the virus prefilter is optionally replaced after each filtration cycle. In some embodiments, the method comprises at least two filtration cycles, wherein the virus prefilter is replaced after each filtration cycle.

In some embodiments, the virus prefilter is a diatomaceous earth-based depth filter. In some embodiments, the virus prefilter is a depth filter comprising diatomaceous earth, cellulose fibers, and a binder comprising cationic imine groups.

In some embodiments, the virus prefilter is a diatomaceous earth-based depth filter, and the method further comprises flushing the diatomaceous earth-based depth filter with water or buffer prior to filtering the composition.

In some embodiments, the virus prefilter is a flat sheet membrane. In some embodiments, the virus prefilter is a flat sheet membrane with a polyethersulfone (PES) membrane surface modified via cross-linked polymeric sulfonic acid cation exchange chemistry. In some embodiments, the virus prefilter is a flat sheet membrane with a PES membrane surface modified via cross-linked mixed-mode chemistry.

In some embodiments, the virus prefilter is a diatomaceous earth-based depth filter, and the virus prefilter is a flat sheet membrane with a polyethersulfone (PES) membrane surface.

In some embodiments, the ratio of the virus prefilter area to the virus filter area in each filtration cycle is about 2:1 to about 4:1. In some embodiments, the ratio of the virus prefilter area to the virus filter area in each filtration cycle is about 2:1 to about 3:1. In some embodiments, the ratio of the virus prefilter area to the virus filter area in each filtration cycle is about 2.5:1 to about 3:1.

In some embodiments, the ratio of the virus prefilter area to the virus filter area in each filtration cycle is about 2.4:1. In some embodiments, the ratio of the virus prefilter area to the virus filter area in each filtration cycle is about 2.6:1. In some embodiments, the ratio of the virus prefilter area to the virus filter area in each filtration cycle is about 2.9:1.

In some embodiments, the pH of the composition is less than about 7.5. In some embodiments, the pH of the composition is less than about 7.2. In some embodiments, the pH of the composition is less than about 7. In some embodiments, the pH of the composition is about 5 to about 7. In some embodiments, the pH of the composition is about 6 to about 7.

In some embodiments, the conductivity of the composition is at least about 10 mS/cm. In some embodiments, the conductivity of the composition is at least about 12 mS/cm. In some embodiments, the conductivity of the composition is about 10 mS/cm to about 20 mS/cm.

In some embodiments, the pH of the composition is less than about 7.5, and the conductivity of the composition is at least about 10 mS/cm. In some embodiments, the pH of the composition is less than about 7.2, and the conductivity of the composition is at least about 10 mS/cm. In some embodiments, the pH of the composition is less than about 7, and the conductivity of the composition is at least about 10 mS/cm. In some embodiments, the pH of the composition is about 5 to about 7, and the conductivity of the composition is at least about 10 mS/cm. In some embodiments, the pH of the composition is about 6 to about 7, and the conductivity of the composition is at least about 10 mS/cm.

In some embodiments, the pH of the composition is less than about 7.5, and the conductivity of the composition is at least about 12 mS/cm. In some embodiments, the pH of the composition is less than about 7.2, and the conductivity of the composition is at least about 12 mS/cm. In some embodiments, the pH of the composition is less than about 7, and the conductivity of the composition is at least about 12 mS/cm. In some embodiments, the pH of the composition is about 5 to about 7, and the conductivity of the composition is at least about 12 mS/cm. In some embodiments, the pH of the composition is about 6 to about 7, and the conductivity of the composition is at least about 12 mS/cm.

In some embodiments, the composition is filtered through the virus filter in normal flow filtration mode. In some embodiments, the composition is filtered through the virus filter in tangential flow filtration mode.

In some embodiments, the composition is filtered through the virus prefilter and the virus filter in normal flow filtration mode.

In some embodiments, the composition is filtered through the virus filter at a flux of about 100 L/m²/hr to about 500 L/m²/hr. In some embodiments, the composition is filtered through the virus filter at a flux of about 200 L/m²/hr to about 400 L/m²/hr. In some embodiments, the composition is filtered through the virus filter at a flux of about 200 L/m²/hr to about 300 L/m²/hr.

In some embodiments, the composition is filtered through the virus filter at a flux of about 100 L/m²/hr. In some embodiments, the composition is filtered through the virus filter at a flux of about 150 L/m²/hr. In some embodiments, the composition is filtered through the virus filter at a flux of about 200 L/m²/hr. In some embodiments, the composition is filtered through the virus filter at a flux of about 250 L/m²/hr. In some embodiments, the composition is filtered through the virus filter at a flux of about 300 L/m²/hr. In some embodiments, the composition is filtered through the virus filter at a flux of about 350 L/m²/hr. In some embodiments, the composition is filtered through the virus filter at a flux of about 400 L/m²/hr.

In some embodiments, the composition is filtered through the virus filter at a pressure of about 10 psi to about 60 psi. In some embodiments, the composition is filtered through the virus filter at a pressure of about 20 psi to about 50 psi.

In some embodiments, the composition is filtered through the virus filter at an inlet pressure and/or a differential pressure of about 10 psi/psid to about 60 psi/psid. In some embodiments, the composition is filtered through the virus filter at an inlet pressure and/or a differential pressure of about 20 psi/psid to about 50 psi/psid.

In some embodiments, the composition is filtered through the virus filter in a constant flow mode at an inlet pressure of about 10 psi to about 60 psi. In some embodiments, the composition is filtered through the virus filter in a constant flow mode at an inlet pressure of about 20 psi to about 50 psi.

In some embodiments, the composition is filtered through the virus filter in a constant pressure mode at a differential pressure of about 10 psid to about 60 psid. In some embodiments, the composition is filtered through the virus filter in a constant pressure mode at an inlet pressure of about 20 psid to about 50 psid.

In some embodiments, the composition is filtered through the virus filter at a pressure of about 10 psi. In some embodiments, the composition is filtered through the virus filter at a pressure of about 20 psi. In some embodiments, the composition is filtered through the virus filter at a pressure of about 30 psi. In some embodiments, the composition is filtered through the virus filter at a pressure of about 40 psi. In some embodiments, the composition is filtered through the virus filter at a pressure of about 50 psi. In some embodiments, the composition is filtered through the virus filter at a pressure of about 60 psi.

In some embodiments, the composition is filtered through the virus filter in a constant flow mode at an inlet pressure of about 10 psi. In some embodiments, the composition is filtered through the virus filter in a constant flow mode at an inlet pressure of about 20 psi. In some embodiments, the composition is filtered through the virus filter in a constant flow mode at an inlet pressure of about 30 psi. In some embodiments, the composition is filtered through the virus filter in a constant flow mode at an inlet pressure of about 40 psi. In some embodiments, the composition is filtered through the virus filter in a constant flow mode at an inlet pressure of about 50 psi. In some embodiments, the composition is filtered through the virus filter in a constant flow mode at an inlet pressure of about 60 psi.

In some embodiments, the composition is filtered through the virus filter in a constant pressure mode at a differential pressure of about 10 psid. In some embodiments, the composition is filtered through the virus filter in a constant pressure mode at a differential pressure of about 20 psid. In some embodiments, the composition is filtered through the virus filter in a constant pressure mode at a differential pressure of about 30 psid. In some embodiments, the composition is filtered through the virus filter in a constant pressure mode at a differential pressure of about 40 psid. In some embodiments, the composition is filtered through the virus filter in a constant pressure mode at a differential pressure of about 50 psid. In some embodiments, the composition is filtered through the virus filter in a constant pressure mode at a differential pressure of about 60 psid.

In some embodiments, the composition is filtered through the virus filter at an inlet pressure and/or a differential pressure of about 10 psi/psid. In some embodiments, the composition is filtered through the virus filter at an inlet pressure and/or a differential pressure of about 20 psi/psid. In some embodiments, the composition is filtered through the virus filter at an inlet pressure and/or a differential pressure of about 30 psi/psid. In some embodiments, the composition is filtered through the virus filter at an inlet pressure and/or a differential pressure of about 40 psi/psid. In some embodiments, the composition is filtered through the virus filter at an inlet pressure and/or a differential pressure of about 50 psi/psid. In some embodiments, the composition is filtered through the virus filter at an inlet pressure and/or a differential pressure of about 60 psi/psid.

In some embodiments, the at least one viral contaminant is selected from parvoviruses, retroviruses, pseudorabies viruses, and reoviruses. In some embodiments, the at least one viral contaminant is a parvovirus. In some embodiments, the at least one viral contaminant is a retrovirus. In some embodiments, the at least one viral contaminant is a pseudorabies virus. In some embodiments, the at least one viral contaminant is a reovirus.

In some embodiments, the composition comprises a recombinant protein. In some embodiments, the recombinant protein is an antibody. In some embodiments, the recombinant protein is an IgG1, IgG2, or IgG4 antibody. In some embodiments, the recombinant protein is an IgG1 antibody. In some embodiments, the recombinant protein is an IgG2 antibody. In some embodiments, the recombinant protein is an IgG4 antibody. In some embodiments, the recombinant protein is a human antibody. In some embodiments, the recombinant protein is a human IgG1, IgG2, or IgG4 antibody. In some embodiments, the recombinant protein is a human IgG1 antibody. In some embodiments, the recombinant protein is a human IgG2 antibody. In some embodiments, the recombinant protein is a human IgG4 antibody.

In some embodiments, the recombinant protein is a bispecific antibody.

In some embodiments, the recombinant protein is an antibody fragment. In some embodiments, the recombinant protein is a single-chain variable fragment.

In some embodiments, the recombinant protein is a fusion protein.

In some embodiments, the filtering results in a log reduction value (LRV) of the at least one viral contaminant of at least about 4 for each of one or more filtration cycles. In some embodiments, the filtering results in a log reduction value (LRV) of the at least one viral contaminant of at least about 4 for one filtration cycle. In some embodiments, the filtering results in a log reduction value (LRV) of the at least one viral contaminant of at least about 4 for each of two filtration cycles. In some embodiments, the filtering results in a log reduction value (LRV) of the at least one viral contaminant of at least about 4 for each of three filtration cycles. In some embodiments, the filtering results in a log reduction value (LRV) of the at least one viral contaminant of at least about 4 for each of more than three filtration cycles.

In some embodiments, the filtering results in a log reduction value (LRV) of at least one parvovirus of at least about 4 for each of one or more filtration cycles. In some embodiments, the filtering results in a log reduction value (LRV) of at least one parvovirus of at least about 4 for one filtration cycle. In some embodiments, the filtering results in a log reduction value (LRV) of at least one parvovirus of at least about 4 for each of two filtration cycles. In some embodiments, the filtering results in a log reduction value (LRV) of at least one parvovirus of at least about 4 for each of three filtration cycles. In some embodiments, the filtering results in a log reduction value (LRV) of at least one parvovirus of at least about 4 for each of more than three filtration cycles.

In some embodiments, the filtering results in a log reduction value (LRV) of the at least one viral contaminant of about 4 to about 7 for each of one or more filtration cycles. In some embodiments, the filtering results in a log reduction value (LRV) of the at least one viral contaminant of about 4 to about 7 for one filtration cycle. In some embodiments, the filtering results in a log reduction value (LRV) of the at least one viral contaminant of about 4 to about 7 for each of two filtration cycles. In some embodiments, the filtering results in a log reduction value (LRV) of the at least one viral contaminant of about 4 to about 7 for each of three filtration cycles. In some embodiments, the filtering results in a log reduction value (LRV) of the at least one viral contaminant of about 4 to about 7 for each of more than three filtration cycles.

In some embodiments, the filtering results in a log reduction value (LRV) of at least one parvovirus of about 4 to about 7 for each of one or more filtration cycles. In some embodiments, the filtering results in a log reduction value (LRV) of at least one parvovirus of about 4 to about 7 for one filtration cycle. In some embodiments, the filtering results in a log reduction value (LRV) of at least one parvovirus of about 4 to about 7 for each of two filtration cycles. In some embodiments, the filtering results in a log reduction value (LRV) of at least one parvovirus of about 4 to about 7 for each of three filtration cycles. In some embodiments, the filtering results in a log reduction value (LRV) of at least one parvovirus of about 4 to about 7 for each of more than three filtration cycles.

Also provided herein is a method of removing at least one viral contaminant from a composition, comprising filtering the composition through a virus prefilter and a virus filter over at least two filtration cycles, wherein:

the virus prefilter is replaced after each filtration cycle;

the virus filter is loaded to at least about 1500 L/m² and/or at least about 30,000 g/m² over the at least two filtration cycles; and

a ratio of the virus prefilter area to the virus filter area in each filtration cycle is at least about 2:1.

In some embodiments, the composition comprises a recombinant protein.

In some embodiments, the composition comprises at least about 10 g/L of a recombinant protein (e.g., at least about 10.5 g/L, at least about 11 g/L, at least about 11.5 g/L, at least about 12 g/L, at least about 12.5 g/L, at least about 13 g/L, at least about 13.5 g/L, at least about 14 g/L, at least about 14.5 g/L, at least about 15 g/L; about 10 g/L; about 10.5 g/L, about 11 g/L; about 11.5 g/L; about 12 g/L; about 12.5 g/L; about 13 g/L; about 13.5 g/L; about 14 g/L; about 14.5 g/L; about 15 g/L; about 15.5 g/L; about 16 g/L; about 16.5 g/L; about 17 g/L; about 17.5 g/L; about 18 g/L; about 18.5 g/L; about 19 g/L; about 19.5 g/L; about 20 g/L; about 20.5 g/L; about 21 g/L; about 21.5 g/L; about 22 g/L; about 22.5 g/L; about 23 g/L; about 23.5 g/L; about 24 g/L; about 24.5 g/L; about 25 g/L).

In some embodiments, the composition comprises at least about 12.5 g/L of a recombinant protein. In some embodiments, the composition comprises at least about 15 g/L of a recombinant protein.

In some embodiments, the composition comprises at least about 17.5 g/L of a recombinant protein. In some embodiments, the composition comprises at least about 20 g/L of a recombinant protein. In some embodiments, the composition comprises at least about 25 g/L of a recombinant protein. In some embodiments, the composition comprises at least about 30 g/L of a recombinant protein. In some embodiments, the composition comprises about 15 g/L to about 25 g/L of a recombinant protein. In some embodiments, the composition comprises about 15 g/L to about 50 g/L of a recombinant protein.

In some embodiments, the composition comprises about 15 g/L to about 25 g/L of a recombinant protein. In some embodiments, the composition comprises about 15 g/L to about 20 g/L of a recombinant protein.

In some embodiments, the virus filter is loaded to at least about 2000 L/m² over the at least two filtration cycles.

In some embodiments, the virus filter is loaded to about 1500 L/m² to about 3000 L/m² over the at least two filtration cycles. In some embodiments, the virus filter is loaded to about 2000 L/m² to about 3000 L/m² over the at least two filtration cycles. In some embodiments, the virus filter is loaded to about 2500 L/m² to about 3000 L/m² over the at least two filtration cycles.

In some embodiments, the virus prefilter is a depth filter, and the virus filter is comprised of at least one flat sheet.

In some embodiments, the virus prefilter is a diatomaceous earth-based depth filter. In some embodiments, the virus filter comprises polyethersulfone (PES). In some embodiments, the virus prefilter is a diatomaceous earth-based depth filter, and the virus filter comprises polyethersulfone (PES).

In some embodiments, the virus prefilter is a depth filter comprising diatomaceous earth, cellulose fibers, and a binder comprising cationic imine groups.

In some embodiments, the virus prefilter is a diatomaceous earth-based depth filter, and the method further comprises flushing the diatomaceous earth-based depth filter with water or buffer prior to filtering the composition.

In some embodiments, the virus prefilter is a flat sheet membrane. In some embodiments, the virus prefilter is a flat sheet membrane with a polyethersulfone (PES) membrane surface modified via cross-linked polymeric sulfonic acid cation exchange chemistry. In some embodiments, the virus prefilter is a flat sheet membrane with a PES membrane surface modified via cross-linked mixed-mode chemistry.

In some embodiments, the virus prefilter is a diatomaceous earth-based depth filter, and the virus prefilter is a flat sheet membrane with a polyethersulfone (PES) membrane surface.

In some embodiments, the virus prefilter is a diatomaceous earth-based depth filter, and the method further comprises flushing the diatomaceous earth-based depth filter with a carbonate-containing solution prior to filtering the composition. In some embodiments, the virus prefilter is a diatomaceous earth-based depth filter, the method further comprises flushing the diatomaceous earth-based depth filter with a carbonate-containing solution prior to filtering the composition, and, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, the carbonate-containing solution comprises sodium carbonate, potassium carbonate, or a mixture thereof. In some embodiments, the carbonate-containing solution comprises sodium carbonate.

In some embodiments, the virus prefilter is a diatomaceous earth-based depth filter, the virus filter comprises polyethersulfone (PES), and the method further comprises flushing the diatomaceous earth-based depth filter with a carbonate-containing solution prior to filtering the composition. In some embodiments, the virus prefilter is a diatomaceous earth-based depth filter, the virus filter comprises polyethersulfone (PES), and the method further comprises flushing the diatomaceous earth-based depth filter with a carbonate-containing solution prior to filtering the composition, and, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, the carbonate-containing solution comprises sodium carbonate, potassium carbonate, or a mixture thereof. In some embodiments, the carbonate-containing solution comprises sodium carbonate.

In some embodiments, the virus prefilter is a diatomaceous earth-based depth filter, the virus filter comprises polyethersulfone (PES), and the method further comprises flushing the diatomaceous earth-based depth filter with sodium carbonate prior to filtering the composition.

In some embodiments, after filtering the composition, the composition has a β-glucan concentration of less than about 15 μg/L (e.g., less than about 14 μg/L, less than about 13 μg/L, less than about 12 μg/L, less than about 11 μg/L, less than about 10 μg/L; about 5 μg/L to less than about 15 μg/L; about 5 μg/L to less than about 12.5 μg/L; about 5 μg/L to less than about 10 μg/L). In some embodiments, after filtering the composition, the composition has a β-glucan concentration of less than about 10 μg/L. In some embodiments, after filtering the composition, the composition has a β-glucan concentration of about 5 μg/L to less than about 15 μg/L. In some embodiments, after filtering the composition, the composition has a β-glucan concentration of about 5 μg/L to less than about 12.5 μg/L. In some embodiments, after filtering the composition, the composition has a β-glucan concentration of about 5 μg/L to less than about 10 μg/L.

In some embodiments, the ratio of the virus prefilter area to the virus filter area in each filtration cycle is about 2:1 to about 4:1. In some embodiments, the ratio of the virus prefilter area to the virus filter area in each filtration cycle is about 2:1 to about 3:1. In some embodiments, the ratio of the virus prefilter area to the virus filter area in each filtration cycle is about 2.5:1 to about 3:1.

In some embodiments, the ratio of the virus prefilter area to the virus filter area in each filtration cycle is about 2.4:1. In some embodiments, the ratio of the virus prefilter area to the virus filter area in each filtration cycle is about 2.6:1. In some embodiments, the ratio of the virus prefilter area to the virus filter area in each filtration cycle is about 2.9:1.

In some embodiments, the pH of the composition is less than about 7.5. In some embodiments, the pH of the composition is less than about 7.2. In some embodiments, the pH of the composition is less than about 7. In some embodiments, the pH of the composition is about 5 to about 7. In some embodiments, the pH of the composition is about 6 to about 7.

In some embodiments, the conductivity of the composition is at least about 10 mS/cm. In some embodiments, the conductivity of the composition is at least about 12 mS/cm. In some embodiments, the conductivity of the composition is about 10 mS/cm to about 20 mS/cm.

In some embodiments, the pH of the composition is less than about 7.5, and the conductivity of the composition is at least about 10 mS/cm. In some embodiments, the pH of the composition is less than about 7.2, and the conductivity of the composition is at least about 10 mS/cm. In some embodiments, the pH of the composition is less than about 7, and the conductivity of the composition is at least about 10 mS/cm. In some embodiments, the pH of the composition is about 5 to about 7, and the conductivity of the composition is at least about 10 mS/cm. In some embodiments, the pH of the composition is about 6 to about 7, and the conductivity of the composition is at least about 10 mS/cm.

In some embodiments, the pH of the composition is less than about 7.5, and the conductivity of the composition is at least about 12 mS/cm. In some embodiments, the pH of the composition is less than about 7.2, and the conductivity of the composition is at least about 12 mS/cm. In some embodiments, the pH of the composition is less than about 7, and the conductivity of the composition is at least about 12 mS/cm. In some embodiments, the pH of the composition is about 5 to about 7, and the conductivity of the composition is at least about 12 mS/cm. In some embodiments, the pH of the composition is about 6 to about 7, and the conductivity of the composition is at least about 12 mS/cm.

In some embodiments, the composition is filtered through the virus filter in normal flow filtration mode. In some embodiments, the composition is filtered through the virus filter in tangential flow filtration mode.

In some embodiments, the composition is filtered through the virus prefilter and the virus filter in normal flow filtration mode.

In some embodiments, the composition is filtered through the virus filter at a flux of about 100 L/m²/hr to about 500 L/m²/hr. In some embodiments, the composition is filtered through the virus filter at a flux of about 200 L/m²/hr to about 400 L/m²/hr. In some embodiments, the composition is filtered through the virus filter at a flux of about 200 L/m²/hr to about 300 L/m²/hr.

In some embodiments, the composition is filtered through the virus filter at a flux of about 100 L/m²/hr. In some embodiments, the composition is filtered through the virus filter at a flux of about 150 L/m²/hr. In some embodiments, the composition is filtered through the virus filter at a flux of about 200 L/m²/hr. In some embodiments, the composition is filtered through the virus filter at a flux of about 250 L/m²/hr. In some embodiments, the composition is filtered through the virus filter at a flux of about 300 L/m²/hr. In some embodiments, the composition is filtered through the virus filter at a flux of about 350 L/m²/hr. In some embodiments, the composition is filtered through the virus filter at a flux of about 400 L/m²/hr.

In some embodiments, the composition is filtered through the virus filter at a pressure of about 10 psi to about 60 psi. In some embodiments, the composition is filtered through the virus filter at a pressure of about 20 psi to about 50 psi.

In some embodiments, the composition is filtered through the virus filter at an inlet pressure and/or a differential pressure of about 10 psi/psid to about 60 psi/psid. In some embodiments, the composition is filtered through the virus filter at an inlet pressure and/or a differential pressure of about 20 psi/psid to about 50 psi/psid.

In some embodiments, the composition is filtered through the virus filter in a constant flow mode at an inlet pressure of about 10 psi to about 60 psi. In some embodiments, the composition is filtered through the virus filter in a constant flow mode at an inlet pressure of about 20 psi to about 50 psi.

In some embodiments, the composition is filtered through the virus filter in a constant pressure mode at a differential pressure of about 10 psid to about 60 psid. In some embodiments, the composition is filtered through the virus filter in a constant pressure mode at an inlet pressure of about 20 psid to about 50 psid.

In some embodiments, the composition is filtered through the virus filter at a pressure of about 10 psi. In some embodiments, the composition is filtered through the virus filter at a pressure of about 20 psi. In some embodiments, the composition is filtered through the virus filter at a pressure of about 30 psi. In some embodiments, the composition is filtered through the virus filter at a pressure of about 40 psi. In some embodiments, the composition is filtered through the virus filter at a pressure of about 50 psi. In some embodiments, the composition is filtered through the virus filter at a pressure of about 60 psi.

In some embodiments, the composition is filtered through the virus filter in a constant flow mode at an inlet pressure of about 10 psi. In some embodiments, the composition is filtered through the virus filter in a constant flow mode at an inlet pressure of about 20 psi. In some embodiments, the composition is filtered through the virus filter in a constant flow mode at an inlet pressure of about 30 psi. In some embodiments, the composition is filtered through the virus filter in a constant flow mode at an inlet pressure of about 40 psi. In some embodiments, the composition is filtered through the virus filter in a constant flow mode at an inlet pressure of about 50 psi. In some embodiments, the composition is filtered through the virus filter in a constant flow mode at an inlet pressure of about 60 psi.

In some embodiments, the composition is filtered through the virus filter in a constant pressure mode at a differential pressure of about 10 psid. In some embodiments, the composition is filtered through the virus filter in a constant pressure mode at a differential pressure of about 20 psid. In some embodiments, the composition is filtered through the virus filter in a constant pressure mode at a differential pressure of about 30 psid. In some embodiments, the composition is filtered through the virus filter in a constant pressure mode at a differential pressure of about 40 psid. In some embodiments, the composition is filtered through the virus filter in a constant pressure mode at a differential pressure of about 50 psid. In some embodiments, the composition is filtered through the virus filter in a constant pressure mode at a differential pressure of about 60 psid.

In some embodiments, the composition is filtered through the virus filter at an inlet pressure and/or a differential pressure of about 10 psi/psid. In some embodiments, the composition is filtered through the virus filter at an inlet pressure and/or a differential pressure of about 20 psi/psid. In some embodiments, the composition is filtered through the virus filter at an inlet pressure and/or a differential pressure of about 30 psi/psid. In some embodiments, the composition is filtered through the virus filter at an inlet pressure and/or a differential pressure of about 40 psi/psid. In some embodiments, the composition is filtered through the virus filter at an inlet pressure and/or a differential pressure of about 50 psi/psid. In some embodiments, the composition is filtered through the virus filter at an inlet pressure and/or a differential pressure of about 60 psi/psid.

In some embodiments, the at least one viral contaminant is selected from parvoviruses, retroviruses, pseudorabies viruses, and reoviruses. In some embodiments, the at least one viral contaminant is a parvovirus. In some embodiments, the at least one viral contaminant is a retrovirus. In some embodiments, the at least one viral contaminant is a pseudorabies virus. In some embodiments, the at least one viral contaminant is a reovirus.

In some embodiments, the composition comprises a recombinant protein. In some embodiments, the recombinant protein is an antibody. In some embodiments, the recombinant protein is an IgG1, IgG2, or IgG4 antibody. In some embodiments, the recombinant protein is an IgG1 antibody. In some embodiments, the recombinant protein is an IgG2 antibody. In some embodiments, the recombinant protein is an IgG4 antibody. In some embodiments, the recombinant protein is a human antibody. In some embodiments, the recombinant protein is a human IgG1, IgG2, or IgG4 antibody. In some embodiments, the recombinant protein is a human IgG1 antibody. In some embodiments, the recombinant protein is a human IgG2 antibody. In some embodiments, the recombinant protein is a human IgG4 antibody.

In some embodiments, the recombinant protein is a bispecific antibody.

In some embodiments, the recombinant protein is an antibody fragment. In some embodiments, the recombinant protein is a single-chain variable fragment.

In some embodiments, the recombinant protein is a fusion protein.

In some embodiments, the composition comprises at least about 17.5 g/L of a recombinant protein. In some embodiments, the composition comprises at least about 20 g/L of a recombinant protein. In some embodiments, the composition comprises at least about 25 g/L of a recombinant protein. In some embodiments, the composition comprises at least about 30 g/L of a recombinant protein. In some embodiments, the composition comprises about 15 g/L to about 25 g/L of a recombinant protein. In some embodiments, the composition comprises about 15 g/L to about 50 g/L of a recombinant protein.

In some embodiments, the filtering results in a log reduction value (LRV) of the at least one viral contaminant of at least about 4 for each of one or more filtration cycles. In some embodiments, the filtering results in a log reduction value (LRV) of the at least one viral contaminant of at least about 4 for one filtration cycle. In some embodiments, the filtering results in a log reduction value (LRV) of the at least one viral contaminant of at least about 4 for each of two filtration cycles. In some embodiments, the filtering results in a log reduction value (LRV) of the at least one viral contaminant of at least about 4 for each of three filtration cycles. In some embodiments, the filtering results in a log reduction value (LRV) of the at least one viral contaminant of at least about 4 for each of more than three filtration cycles.

In some embodiments, the filtering results in a log reduction value (LRV) of at least one parvovirus of at least about 4 for each of one or more filtration cycles. In some embodiments, the filtering results in a log reduction value (LRV) of at least one parvovirus of at least about 4 for one filtration cycle. In some embodiments, the filtering results in a log reduction value (LRV) of at least one parvovirus of at least about 4 for each of two filtration cycles. In some embodiments, the filtering results in a log reduction value (LRV) of at least one parvovirus of at least about 4 for each of three filtration cycles. In some embodiments, the filtering results in a log reduction value (LRV) of at least one parvovirus of at least about 4 for each of more than three filtration cycles.

In some embodiments, the filtering results in a log reduction value (LRV) of the at least one viral contaminant of about 4 to about 7 for each of one or more filtration cycles. In some embodiments, the filtering results in a log reduction value (LRV) of the at least one viral contaminant of about 4 to about 7 for one filtration cycle. In some embodiments, the filtering results in a log reduction value (LRV) of the at least one viral contaminant of about 4 to about 7 for each of two filtration cycles. In some embodiments, the filtering results in a log reduction value (LRV) of the at least one viral contaminant of about 4 to about 7 for each of three filtration cycles. In some embodiments, the filtering results in a log reduction value (LRV) of the at least one viral contaminant of about 4 to about 7 for each of more than three filtration cycles.

In some embodiments, the filtering results in a log reduction value (LRV) of at least one parvovirus of about 4 to about 7 for each of one or more filtration cycles. In some embodiments, the filtering results in a log reduction value (LRV) of at least one parvovirus of about 4 to about 7 for one filtration cycle. In some embodiments, the filtering results in a log reduction value (LRV) of at least one parvovirus of about 4 to about 7 for each of two filtration cycles. In some embodiments, the filtering results in a log reduction value (LRV) of at least one parvovirus of about 4 to about 7 for each of three filtration cycles. In some embodiments, the filtering results in a log reduction value (LRV) of at least one parvovirus of about 4 to about 7 for each of more than three filtration cycles.

### Viral Filtration Skids

Provided herein is a viral filtration skid for use in a method described herein. For example, provided herein is a viral filtration skid comprising a virus prefilter and a virus filter, wherein the ratio of the virus prefilter area to the virus filter area is at least about 2:1.

In some embodiments, the virus prefilter is a depth filter. In some embodiments, the virus prefilter is a diatomaceous earth-based depth filter. In some embodiments, the virus prefilter is a depth filter comprising diatomaceous earth, cellulose fibers, and a binder comprising cationic imine groups.

In some embodiments, the virus prefilter is a diatomaceous earth-based depth filter, and the method further comprises flushing the diatomaceous earth-based depth filter with water or buffer prior to filtering the composition.

In some embodiments, the virus prefilter is a microfiltration membrane. In some embodiments, the virus prefilter is an about 0.2 μm membrane. In some embodiments, the virus prefilter is an about 0.1 μm membrane. In some embodiments, the virus prefilter is an about 75 nm membrane.

In some embodiments, the virus prefilter is an absorptive membrane. In some embodiments, the virus prefilter is an absorptive membrane with ion exchange functionality.

In some embodiments, the virus prefilter is a flat sheet membrane. In some embodiments, the virus prefilter is a flat sheet membrane with a polyethersulfone (PES) membrane surface modified via cross-linked polymeric sulfonic acid cation exchange chemistry. In some embodiments, the virus prefilter is a flat sheet membrane with a PES membrane surface modified via cross-linked mixed-mode chemistry.

In some embodiments, the virus prefilter is a triple layer, flat sheet membrane. In some embodiments, the virus prefilter is a polyamide triple layer, flat sheet membrane.

In some embodiments, the virus prefilter is a pleated sheet membrane. In some embodiments, the virus prefilter is a pleated sheet membrane comprising nylon. In some embodiments, the virus prefilter is a pleated sheet membrane comprising hydrophilic acrylate-modified PVDF.

In some embodiments, the virus prefilter is an asymmetric, single layer hollow fiber membrane. In some embodiments, the virus prefilter is an asymmetric, single layer hollow fiber membrane, and the virus prefilter comprises hydrophilic cuprammonium regenerated cellulose.

In some embodiments, the virus filter is comprised of at least one flat sheet. In some embodiments, the virus filter comprises an asymmetric, double layer flat sheet. In some embodiments, the virus filter comprises an asymmetric, double layer flat sheet, and the virus filter comprises hydrophilic polyethersulfone (PES).

In some embodiments, the virus filter is comprised of at least one pleated sheet.

In some embodiments, the virus filter is a pleated sheet. In some embodiments, the virus filter is a pleated sheet, and the virus filter comprises hydrophilic PES.

In some embodiments, the virus filter comprises an asymmetric, double layer pleated sheet. In some embodiments, the virus filter comprises an asymmetric, double layer pleated sheet, and the virus filter comprises hydrophilic PES. In some embodiments, the virus filter comprises an asymmetric, double layer pleated sheet, and the virus filter comprises surface modified PES. In some embodiments, the virus filter comprises an asymmetric, triple layer pleated sheet. In some embodiments, the virus filter comprises an asymmetric, triple layer pleated sheet, and the virus filter comprises hydrophilic PES. In some embodiments, the virus filter comprises an asymmetric, triple layer pleated sheet, and the virus filter comprises hydrophilic polyvinylidene fluoride (PVDF).

In some embodiments, the virus filter comprises a symmetric, double layer pleated sheet. In some embodiments, the virus filter comprises a symmetric, double layer pleated sheet, and the virus filter comprises hydrophilic acrylate-modified PVDF. In some embodiments, the virus filter comprises a symmetric, triple layer pleated sheet. In some embodiments, the virus filter comprises a symmetric, triple layer pleated sheet, and the virus filter comprises hydrophilic acrylate-modified PVDF.

In some embodiments, the virus filter is comprised of hollow fibers. In some embodiments, the virus filter is an asymmetric, single layer hollow fiber membrane. In some embodiments, the virus filter is an asymmetric, single layer hollow fiber membrane, and the virus filter comprises hydrophilic cuprammonium regenerated cellulose. In some embodiments, the virus filter is an asymmetric, single layer hollow fiber membrane, and the virus filter comprises modified PVDF. In some embodiments, the virus filter is an asymmetric, single layer hollow fiber membrane, and the virus filter comprises hydrophilic PES.

In some embodiments, the virus filter comprises hydrophilic PES. In some embodiments, the virus filter comprises surface modified PES.

In some embodiments, the virus filter comprises modified PVDF. In some embodiments, the virus filter comprises hydrophilic PVDF. In some embodiments, the virus filter comprises hydrophilic acrylate-modified PVDF.

In some embodiments, the virus filter comprises hydrophilic cuprammonium regenerated cellulose.

In some embodiments, the virus filter is a small virus filter.

In some embodiments, the virus filter is a large virus filter.

In some embodiments, the ratio of the virus prefilter area to the virus filter area is about 2:1 to about 4:1. In some embodiments, the ratio of the virus prefilter area to the virus filter area is about 2:1 to about 3:1. In some embodiments, the ratio of the virus prefilter area to the virus filter area is about 2.5:1 to about 3:1.

In some embodiments, the ratio of the virus prefilter area to the virus filter area is about 2.4:1. In some embodiments, the ratio of the virus prefilter area to the virus filter area is about 2.6:1. In some embodiments, the ratio of the virus prefilter area to the virus filter area is about 2.9:1.

In some embodiments, the viral filtration skid further comprises at least one in-line monitoring system. In some embodiments, the at least one in-line monitoring system monitors at least one property selected from pressure, flow, pH, conductivity, and UV.

In some embodiments, the virus pre-filter and the virus filter are positioned in series.

### Host Cells

Compositions subjected to the virus filtration methods disclosed herein may derive from a biomanufacturing process (such as, e.g., harvested cell culture fluid or a product pool following one or more unit operations). Cell lines (also referred to as “cells” or “host cells”) used in such biomanufacturing processes are genetically engineered to express a recombinant protein of commercial or scientific interest. Cells may be suitable for adherent, monolayer, and/or suspension culture, transfection, and expression of recombinant proteins, such as, e.g., antibodies. The cells can be used, for example, with batch, fed batch, and perfusion or continuous culture methods. Such cells are typically cell lines obtained or derived from mammals and are able to grow and survive when placed in either monolayer culture or suspension culture in medium containing appropriate nutrients and/or other factors, such as those described herein. Host cells are typically selected that can express and secrete proteins, or that can be molecularly engineered to express and secrete, large quantities of a particular protein, more particularly, a glycoprotein of interest, into the culture medium. The selection of an appropriate host cell for expressing a recombinant protein will depend upon various factors, such as desired expression levels, polypeptide modifications that are desirable or necessary for activity (such as glycosylation or phosphorylation), and ease of folding into a biologically active molecule. In some embodiments, the host cell used to produce a recombinant protein is a mammalian host cell.

Cell lines are typically derived from a lineage arising from a primary culture that can be maintained in culture for an unlimited time. The cells can contain introduced, e.g., via transformation, transfection, infection, or injection, expression vectors (constructs), such as plasmids and the like, that harbor coding sequences, or portions thereof, encoding the proteins for expression and production in the culturing process. Such expression vectors contain the necessary elements for the transcription and translation of the inserted coding sequence. Methods which are well known to and practiced by those skilled in the art can be used to construct expression vectors containing sequences encoding the desired proteins and polypeptides, as well as the appropriate transcriptional and translational control elements. These methods include, but are not limited to, in vitro recombinant DNA techniques, synthetic techniques, and in vivo genetic recombination. Such techniques are described in J. Sambrook et al., 2012, Molecular Cloning, A Laboratory Manual, 4^{th} edition Cold Spring Harbor Press, Plainview, N.Y. or any of the previous editions; F. M. Ausubel et al., 2013, Current Protocols in Molecular Biology, John Wiley & Sons, New York, N.Y, or any of the previous editions; Kaufman, R. J., Large Scale Mammalian Cell Culture, 1990, all of which are incorporated herein for any purpose.

Suitable host cells include, but are not limited to, those that are commercially available, for example, from culture collections such as the DSMZ (Deutsche Sammlung von Mikroorganismen and Zellkulturen GmbH, Braunschweig, Germany) or the American Type Culture Collection (ATCC).

Example host cells include, but are not limited to, prokaryote, yeast, or higher eukaryote cells. Prokaryotic host cells include eubacteria, such as Gram-negative or Gram-positive organisms, for example, Enterobacteriaceae such as Escherichia, e.g., E. coli, Enterobacter, Erwinia, Klebsiella, Proteus, Salmonella, e.g., Salmonella typhimurium, Serratia, e.g., Serratia marcescans, and Shigella, as well as Bacillus, such as B. subtilis and B. licheniformis, Pseudomonas, and Streptomyces. In some embodiments, eukaryotic microbes such as filamentous fungi or yeast are suitable cloning or expression hosts for recombinant polypeptides. Saccharomyces cerevisiae, or common baker's yeast, is the most commonly used among lower eukaryotic host microorganisms. However, a number of other genera, species, and strains are commonly available and useful herein, such as Pichia, e.g. P. pastoris, Schizosaccharomyces pombe; Kluyveromyces, Yarrowia; Candida; Trichoderma reesia; Neurospora crassa; Schwanniomyces, such as Schwanniomyces occidentalis; and filamentous fungi, such as, e.g., Neurospora, Penicillium, Tolypocladium, and Aspergillus hosts such as A. nidulans and A. niger.

Vertebrate host cells are also suitable hosts for expressing recombinant proteins. Mammalian cell lines suitable as hosts for recombinant protein expression are well-known in the art and include, but are not limited to, immortalized cell lines available from the American Type Culture Collection (ATCC), including, but not limited to, Chinese hamster ovary (CHO) cells, including CHOK1 cells (ATCC CCL61), DXB-11, DG-44, and Chinese hamster ovary cells/-DHFR (CHO, Urlaub et al., Proc. Natl. Acad. Sci. USA 77: 4216, 1980); monkey kidney CV1 line transformed by SV40 (COS-7, ATCC CRL 1651); human embryonic kidney line (293 or 293 cells subcloned for growth in suspension culture, (Graham et al., J. Gen Virol. 36: 59, 1977); baby hamster kidney cells (BHK, ATCC CCL 10); mouse sertoli cells (TM4, Mather, Biol. Reprod. 23: 243-251, 1980); monkey kidney cells (CV1 ATCC CCL 70); African green monkey kidney cells (VERO-76, ATCC CRL-1587); human cervical carcinoma cells (HELA, ATCC CCL 2); canine kidney cells (MDCK, ATCC CCL 34); buffalo rat liver cells (BRL 3A, ATCC CRL 1442); human lung cells (W138, ATCC CCL 75); human hepatoma cells (Hep G2, HB 8065); mouse mammary tumor (MMT 060562, ATCC CCL51); TRI cells (Mather et al., Annals N.Y Acad. Sci. 383: 44-68, 1982); MRC 5 cells or FS4 cells; mammalian myeloma cells, and a number of other cell lines. In some embodiments, the host cells are selected from CHO cells.

In some embodiments, the host cells are eukaryotic cells, such as, e.g., mammalian cells. The mammalian cells can be, for example, human or rodent or bovine cell lines or cell strains. Examples of such cells, cell lines, or cell strains include, but are not limited to, mouse myeloma (NSO)-cell lines, Chinese hamster ovary (CHO)-cell lines, FIT 1080, H9, HepG2, MCF7, MDBK Jurkat, NIH3T3, PC12, BF1K (baby hamster kidney cell), VERO, SP2/0, YB2/0, Y0, C127, L cell, COS, e.g., COS1 and COS7, QC1-3, HEK-293, VERO, PER.C6, HeLa, EB1, EB2, EB3, oncolytic, or hybridoma-cell lines. In some embodiments, the mammalian cells are CHO-cell lines. In some embodiments, the mammalian cells are CHO cells. In some embodiments, the mammalian cells are selected from CHO-K1 cells, CHO-K1 SV cells, DG44 CHO cells, DUXB11 CHO cells, CHOS cells, CHO GS knock-out cells, CHO FUT8 GS knock-out cells, CHOZN cells, and CHO derived cells. In some embodiments, a CHO GS knock-out cell (such as, e.g., a GSKO cell) is, for example, a CHO-K1 SV GS knockout cell. Additionally, the CHO FUT8 knockout cell is, for example, the Potelligent® CHOK1 SV (Lonza, Inc.). In some embodiments, the eukaryotic cells can also be avian cells, cell lines, or cell strains, such as, e.g., EBx® cells, EB14, EB24, EB26, EB66, or EBv13.

CHO cells, including CHOK1 cells (ATCC CCL61), are widely used to produce complex recombinant proteins. In some embodiments, the dihydrofolate reductase (DHFR)-deficient mutant cell lines (Urlaub et al., 1980, Proc Natl Acad Sci USA 77: 4216-4220), DXB11 and DG-44, are desirable CHO host cell lines because the efficient DHFR selectable and amplifiable gene expression system allows high level recombinant protein expression in these cell lines (Kaufman R. J., 1990, Meth Enzymol 185:537-566). Also included are the glutamine synthase (GS)-knockout CHOKlSV cell lines, making use of glutamine synthetase (GS)-based methionine sulfoximine (MSX) selection. Other suitable CHO host cells for use in a bioreactor include, but are not limited to, the following (ECACC accession numbers in parenthesis): CHO (85050302); CHO (PROTEIN FREE) (00102307); CHO-K1 (85051005); CHO-K1/SF (93061607); CHO/dhFr-(94060607); CHO/dhFr-AC-free (05011002); and RR-CHOK1 (92052129).

Large-scale production of proteins for commercial applications may be carried out in suspension culture. Therefore, mammalian host cells used to generate the recombinant mammalian cells described herein can, but need not be, adapted to growth in suspension culture. A variety of host cells adapted to growth in suspension culture are known, including mouse myeloma NSO cells and CLIO cells from CFIO-S, DG44, and DXB11 cell lines. Other suitable cell lines include, but are not limited to, mouse myeloma SP2/0 cells, baby hamster kidney BF1K-21 cells, human PER.C6© cells, human embryonic kidney F1EK-293 cells, and cell lines derived or engineered from any of the cell lines described herein.

In some embodiments, the eukaryotic cells are selected from lower eukaryotic cells, such as, e.g., yeast cells (e.g., Pichia genus (e.g., Pichia pastoris, Pichia methanolica, Pichia kluyveri, and Pichia angusta), Komagataella genus (e.g., Komagataella pastoris, Komagataella pseudopastoris, or Komagataella phaffii), cells of the Saccharomyces genus (e.g., Saccharomyces cerevisae, Saccharomyces kluyveri, Saccharomyces uvarum), cells of the Kluyveromyces genus (e.g., Kluyveromyces lactis, Kluyveromyces marxianus), cells of the Candida genus (e.g., Candida utilis, Candida cacaoi, Candida boidinii), cells of the Geotrichum genus (e.g., Geotrichum fermentans), Yarrowia lipolytica, or Schizosaccharomyces pombe. In some embodiments, the eukaryotic cells are selected from Pichia pastoris strains. Non-limiting examples of Pichia pastoris strains include X33, GS115, KM71, KM71H, and CBS7435.

In some embodiments, the eukaryotic cells are selected from fungal cells (e.g., cells of Aspergillus (such as, e.g., A. niger, A. fumigatus, A. orzyae, A. nidula), Acremonium (such as, e.g., A. thermophilum), Chaetomium (such as, e.g., C. thermophilum), Chrysosporium (such as, e.g., C. thermophile), Cordyceps (such as, e.g., C. militaris), Corynascus, Ctenomyces, Fusarium (such as, e.g., F. oxysporum), Glomerella (such as, e.g., G. graminicola), Hypocrea (such as, e.g., H. jecorina), Magnaporthe (such as, e.g., M. orzyae), Myceliophthora (such as, e.g., M. thermophile), Nectria (such as, e.g., N. heamatococca), Neurospora (such as, e.g., N. crassa), Penicillium, Sporotrichum (such as, e.g., S. thermophile), Thielavia (such as, e.g., T. terrestris, T. heterothallica), Trichoderma (such as, e.g., T. reesei), or Verticillium (such as, e.g., V. dahlia)).

In some embodiments, the eukaryotic cells are selected from insect cells (such as, e.g., Sf9, Mimic™ Sf9, Sf21, High Five™ (BT1-TN-5B1-4), or BT1-Ea88 cells), algae cells (such as, e.g., of the genus Amphora, Bacillariophyceae, Dunaliella, Chlorella, Chlamydomonas, Cyanophyta (cyanobacteria), Nannochloropsis, Spirulina, or Ochromonas), and plant cells (such as, e.g., cells from monocotyledonous plants (such as, e.g., maize, rice, wheat, or Setaria), or cells from a dicotyledonous plants (such as, e.g., cassava, potato, soybean, tomato, tobacco, alfalfa, Physcomitrella patens or Arabidopsis)).

To generate host cell lines (e.g., mammalian cell lines) engineered to express a recombinant protein of interest, one or more nucleic acids encoding the recombinant protein (or components thereof in the case of multi-chain proteins) is initially inserted into one or more expression vectors. Nucleic acid control sequences useful in expression vectors for expression in mammalian cells include promoters, enhancers, and termination and polyadenylation signals. A secretory signal peptide sequence can also, optionally, be encoded by the expression vector, operably linked to the coding sequence of interest, so that the expressed protein can be secreted by the recombinant host cell, for more facile isolation of the recombinant protein from the cell, if desired. Vectors may also include one or more selectable marker genes to facilitate selection of host cells into which the vectors have been introduced. In some embodiments, vectors are used that employ protein-fragment complementation assays using protein reporters, such as dihydrofolate reductase (see, for example, U.S. Pat. No. 6,270,964). Suitable mammalian expression vectors are known in the art and are also commercially available.

Typically, vectors used in any of the host cells will contain sequences for plasmid maintenance and for cloning and expression of exogenous nucleotide sequences. Such sequences will typically include one or more of the following nucleotide sequences: a promoter, one or more enhancer sequences, an origin of replication, transcriptional and translational control sequences, a transcriptional termination sequence, a complete intron sequence containing a donor and acceptor splice site, a native or heterologous signal peptide sequence (leader sequence or signal peptide) for polypeptide secretion, a ribosome binding site, a polyadenylation sequence, a polylinker region for inserting the polynucleotide encoding the polypeptide to be expressed, and a selectable marker element. Vectors may be constructed from a starting vector such as a commercially available vector, and additional elements may be individually obtained and ligated into the vector.

### Bioreactors

Compositions subjected to the virus filtration methods disclosed herein may derive from a biomanufacturing process performed in one or more bioreactors. In some embodiments, the growth and/or production phase of such a biomanufacturing process is conducted within a bioreactor. Suitable culture conditions for mammalian cells are known in the art. A bioreactor “run” typically comprises the steps of inoculating a prepared bioreactor with a seed culture, subjecting the cells to one or more growth phase and/or production phases until one or more predetermined parameters are met (e.g., time, viable cell density, packed cell volume) and then harvesting the contents of the bioreactor.

In some embodiments, one or more bioreactor(s) used in the biomanufacturing method is a stainless-steel bioreactor, such as, e.g., a built-in-place large-scale stainless-steel bioreactor capable of operating at volumes of about 2,000 liters to about 50,000 liters or more.

In some embodiments, one or more bioreactor(s) used in the biomanufacturing method is a single-use bioreactor. Single-use technology minimizes the infrastructure requirements associated with traditional cell culture, such as steel/glass commercial-scale vessels and associated machinery. Single-use bioreactors provide flexibility to the manufacturing process, and site assembly, reconfiguration, sterilization, and validation for single-use bioreactors may be faster, easier, and less costly than traditional built-in-place stainless steel cell culture plants. Single-use bioreactors comprise disposable, plastic sterile bags supported by a non-disposable support structure. The culture is agitated by a stirrer within the bag or by rocking, air and oxygen spargers are also supplied as well as sensors to measure and adjust various parameters of the culture, such as pH, temperature, oxygen, cell density, and the like. Single-use bioreactors are commercially available, for example, Bio STR®, Sartorius, Gattingen Germany; MOBIUS®, Millipore, Burlington, MA; XCELLEREX®, Cytiva, Marlborough, MA.

Bioreactor volume is divided into the working volume space and the headspace. The working volume of the bioreactor refers to the volume within the bioreactor in which the cell culture is operated, typically expressed as a percentage of the bioreactor volume. In some embodiments, the working volume of the bioreactor is at least about 70% of the bioreactor volume. In some embodiments, the working volume of the bioreactor is at least about 70% to about 100% of the bioreactor volume. In some embodiments, the working volume of the bioreactor is at least about 75% of the bioreactor volume. In some embodiments, the working volume of the bioreactor is at least about 80% of the bioreactor volume. In some embodiments, the working volume of the bioreactor is at least about 85% of the bioreactor volume. In some embodiments, the working volume of the bioreactor is at least about 90% of the bioreactor volume. In some embodiments, the working volume of the bioreactor is at least about 91% of the bioreactor volume. In some embodiments, the working volume of the bioreactor is at least about 92% of the bioreactor volume. In some embodiments, the working volume of the bioreactor is at least about 93% of the bioreactor volume. In some embodiments, the working volume of the bioreactor is at least about 94% of the bioreactor volume. In some embodiments, the working volume of the bioreactor is at least about 95% of the bioreactor volume. In some embodiments, the working volume of the bioreactor is at least about 96% of the bioreactor volume. In some embodiments, the working volume of the bioreactor is at least about 97% of the bioreactor volume. In some embodiments, the working volume of the bioreactor is at least about 98% of the bioreactor volume. In some embodiments, the working volume of the bioreactor is at least about 99% of the bioreactor volume. In some embodiments, the working volume of the bioreactor is about 100% of the bioreactor volume.

### Virus Prefilters

Virus prefilters, which are commercially available from several sources (e.g., MilliporeSigma, Sartorius, Pall, Asahi Kasei), remove protein aggregates and other process impurities that may otherwise foul virus filters. Common virus prefilters use a variety of membrane chemistries, such as a PES membrane surface modified via cross-linked polymeric sulfonic acid cation exchange chemistry (Viresolve® Shield, MilliporeSigma) and a PES membrane surface modified via cross-linked mixed-mode chemistry (Viresolve® Shield-H, MilliporeSigma). Additionally, depth filters composed of diatomaceous earth, cellulose fibers, and a binder comprising cationic imine groups (Viresolve® Prefilter, MilliporeSigma), pleated sheet membranes (Pegasus™ Protect, Pall; Pegasus™ grade UL6, Pall), and triple layer, flat sheet membranes (Virosart® Max, Sartorius) are commonly used as prefilters.

Virus prefilters commonly act at least in part through size exclusion, for example, with size exclusion cutoffs between about 75 nm and about 0.2 μm (e.g., 75 nm (Planova 75N, Asahi Kasei); 0.1 μm (Virosart® Max, Sartorius; Viresolve® Prefilter, MilliporeSigma); 0.2 μm (Viresolve® Shield, MilliporeSigma; Viresolve® Shield-H, MilliporeSigma; Pegasus™ Protect, Pall)).

### Virus Filters

Virus filters are polymeric membranes with various membrane chemistries and complex pore structures designed to retain viral particles. Virus filters are commercially available from a variety of manufacturers (e.g., MilliporeSigma, Sartorius, Pall, and Asahi Kasei) and include large virus filters and small virus filters. Large virus filters are designed to retain viruses larger than 60 nm, while small virus filters are designed to retain viruses larger than 20 nm. Virus filters can be used in normal flow filter (NFF) or a tangential flow filtration (TFF) mode. In either TFF mode or NFF mode, filtration is conducted under conditions to retain viral contaminants (e.g., a virus having a 20 to 100 nm diameter) on the membrane surface while permitting passage of a recombinant protein through the filter membrane.

Non-limiting examples of virus filters include those formed from regenerated cellulose (e.g., cuprammonium-regenerated cellulose), polyethersulfone, polyarylsulphones, polysulfone, polyimide, polyamide, polyvinylidenedifluoride (PVDF), and the like. For example, non-limiting examples of virus filters include VIRESOLVE® membranes and RETROPORE™ membranes available from EMD Millipore, Billerica, Mass. These can be supplied in either a cartridge (NFF) form, such as VIRESOLVE® NFP viral filters, or as cassettes (for TFF), such as PELLICON® cassettes, available from EMD Millipore, Billerica, Mass.

A further non-limiting example is the Sartorius Virosart® CPV small virus filter, which comprises a polyethersulfone membrane. Other PES membrane filters include, but are not limited to, Viresolve® NFR, Viresolve® Pro, Virosart® CPV, Virosart® HF, Virosart® HC, and Pegasus™ grade Prime. Additional non-limiting example filters include the Planova™ BioEX filter and the Viresolve® NFP filter, both of which comprise a polyvinylidene fluoride (PVDF) membrane, as well as Asahi Kasei's 15N, 20N, and 35N filters, which comprise a cuprammonium-regenerated cellulose membrane (e.g., a hollow fiber cuprammonium-regenerated cellulose membrane). Alternative examples of virus filters are known in the art and include hydrophilic acrylate-modified PVDF membranes from Pall, such as, e.g., Ultipor® VF grade DV20, Ultipor® VF grade DV50, and Pegasus™ grade PV4.

### Viral Contaminants

Non-limiting examples of viral contaminants of concern in biomanufacturing processes include bovine enterovirus (BEV), bovine parvovirus (BPV), bovine viral diarrhea virus (BVDV), encephalomyocarditis virus (EMCV), feline calicivirus (FCV), hepatitis A virus (HAV), human immunodeficiency virus (HIV), human poliovirus-1 (HPV-1), human herpesvirus 1 (HSV-1), bovine herpesvirus 1 (IBRV), porcine enterovirus (PEV), pseudorabies virus (PRV), reovirus type 3 (Reo-3), Semliki Forest virus (SFV), Sindbis virus (SINV), simian virus 40 (SV40), Theiler's murine encephalomyelitis virus (TMEV), vesicular stomatitis virus (VSV), West Nile virus (WNV), and xenotropic murine leukemia virus (xMuLV).

### Culture Methods

Various culture methods may be used to produce a recombinant protein of interest, including, but not limited to, batch culture, fed-batch culture, perfusion culture, and intensified cell culture. Compositions subjected to the virus filtration methods disclosed herein may derive from any culture method and may be subjected to one or more unit operations prior to virus filtration.

Batch culture is a discontinuous method where cells are grown in a fixed volume of culture media for a short period of time followed by a full harvest. Cultures grown using the batch method experience an increase in cell density until a maximum cell density is reached, followed by a decline in viable cell density as the media components are consumed and levels of metabolic by-products (such as lactate and ammonia) accumulate. Harvest typically occurs at the point when the maximum cell density is achieved (e.g., 5×10⁶ cells/mL or greater, depending on media formulation, cell line, etc.). The batch process is the simplest culture method; however, viable cell density is limited by nutrient availability and once the cells are at maximum density, the culture declines and production decreases. There is no ability to extend a production phase in batch culture because the accumulation of waste products and nutrient depletion rapidly lead to culture decline, typically around 3 to 7 days.

Fed-batch culture improves on the batch process by providing bolus or continuous media feeds to replenish those media components that have been consumed. Since fed-batch cultures receive additional nutrients throughout the run, they have the potential to achieve higher cell densities (>10 to 30×10⁶ cells/mL, depending on media formulation, cell line, etc.) and increased product titers, when compared to the batch method. Unlike the batch process, a biphasic culture can be created and sustained by manipulating feeding strategies and media formulations to distinguish the period of cell proliferation to achieve a desired cell density (the growth phase) from the period of suspended or slow cell growth (the production phase). As such, fed-batch cultures have the potential to achieve higher product titers compared to batch cultures. Typically, a batch method is used during the growth phase and a fed-batch method used during the production phase, but a fed-batch feeding strategy can be used throughout the entire process. However, unlike the batch process, bioreactor volume is a limiting factor which limits the amount of feed. Also, as with the batch method, metabolic by-product accumulation will lead to culture decline, which limits the duration of the production phase, often around 10 to 21 days. Fed-batch cultures are discontinuous, and harvest typically occurs when metabolic by-product levels or culture viability reach predetermined levels. When compared to a batch culture, in which no feeding occurs, a fed-batch culture can produce greater amounts of recombinant protein. (See, e.g., U.S. Pat. No. 5,672,502.)

Perfusion methods offer potential improvements over the batch and fed-batch methods by adding fresh media and simultaneously removing spent media during culture. Typical perfusion cultures begin with a batch culture start-up lasting for a day or two followed by continuous, step-wise, and/or intermittent addition of fresh feed media to the culture and simultaneous removal of spent media with the retention of cells and additional high molecular weight compounds such as proteins (based on the filter molecular weight cutoff) throughout the growth and production phases of the culture. Various methods, such as sedimentation, centrifugation, or filtration, can be used to remove spent media, while maintaining cell density. Non-limiting examples of filtration methods include alternating tangential flow filtration and recirculating tangential flow. Alternating tangential flow is maintained by pumping medium through hollow-fiber filter modules. See e.g. U.S. Pat. No. 6,544,424; Furey, 2002, Gen. Eng. News. 22 (7):62-63.

Perfusion can be continuous, stepwise, intermittent, or a combination of any or all of any of these. Perfusion rates can be less than a working volume to many working volumes per day. The cells are retained in the culture, and the spent medium that is removed is substantially free of cells or has significantly fewer cells than the culture. Recombinant proteins expressed by the cell culture can also be retained in the culture.

Typical large scale commercial cell culture strategies strive to reach high cell densities, such as, e.g., 30-90(+)×10⁶ cells/mL, where almost a third to over one-half of the reactor volume is biomass. With perfusion culture, extreme cell densities of >1×10⁸ cells/mL have been achieved. A potential advantage of the perfusion process is that the production culture can be maintained for longer periods than batch or fed-batch culture methods. However, increased media preparation, use, storage, and disposal are necessary to support a long-term perfusion culture, particularly for a culture with high cell density, which also needs even more nutrients. All of this can increase production costs compared to batch and fed-batch methods. In addition, higher cell densities can cause problems during production, such as, e.g., maintaining dissolved oxygen levels and problems with increased gassing, including supplying more oxygen and removing more carbon dioxide, which could result in more foaming and the need for alterations to antifoam strategies; as well as during harvest and downstream processing where the efforts required to remove the excessive cell material can result in loss of product, negating the benefit of increased titer due to increased cell mass.

Suitable culture conditions, including temperature, dissolved oxygen content, agitation rate, and the like, for mammalian cells are known in the art and may vary by the phase or stage of the cell culture. In some embodiments, the methods disclosed herein further comprise taking samples during the cell culture processes, evaluating the samples to quantitatively and/or qualitatively monitor characteristics of the recombinant protein and/or the cell culture process. In some embodiments, the samples are quantitatively and/or qualitatively monitored using process analytical techniques. For examples, dissolved oxygen levels may be monitored during the cell culture processes using methods known in the art, such as, e.g., a basic chemical analysis method (titration method), an electrochemical analysis method (diaphragm electrode method), and a photochemical analysis method (fluorescence method).

During recombinant protein production, it is desirable to have a controlled system where cells are grown for a desired time or to a desired density and then the physiological state of the cells is switched to a growth-limited or arrested, high productivity state where the cells use energy and substrates to produce the recombinant protein in favor of increasing cell density. For commercial scale cell culture and the manufacture of biological therapeutics, the ability to limit or arrest cell growth and to maintain the cells in a growth-limited or arrested state during the production phase is very desirable. Such methods include, for example, temperature shifts, use of chemical inducers of protein production, nutrient limitation or starvation and cell cycle inhibitors, either alone or in combination. Illustratively, a typical cell culture undergoes a growth phase, a period of exponential growth where cell density is increased. During the growth phase, cells are cultured in a cell culture medium containing the necessary nutrients and additives under conditions (generally at about a temperature of 25°-40° C., in a humidified, controlled atmosphere) such that optimal growth is achieved for the particular cell line. Cells are typically maintained in the growth phase for a period of between one and eight days, e.g., between three to seven days, e.g., seven days. The length of the growth phase for a particular cell line can be determined by a person of ordinary skill in the art and will generally be the period of time sufficient to allow the particular cells to reproduce to a viable cell density within a range of about 20%-80% of the maximal possible viable cell density if the culture was maintained under the growth conditions. The growth phase is followed by a transition phase when exponential cell growth is slowing and protein production starts to increase. This marks the start of the stationary phase, a production phase, where cell density typically levels off and product titer increases. During the production phase, the medium is generally supplemented to support continued recombinant protein production.

In certain embodiments, the culture conditions may be adjusted to facilitate the transition from the growth phase of the cell culture to the production phase. For instance, a growth phase of the cell culture may occur at a higher temperature than a production phase of the cell culture. In some embodiments, a growth phase may occur at a first temperature from about 35° C. to about 38° C., and a production phase may occur at a second temperature from about 29° C. to about 37° C., optionally from about 30° C. to about 36° C. or from about 30° C. to about 34° C. In one embodiment, a shift in temperature from about 35° C. to about 37° C. to a temperature of about 31° C. to about 33° C. may be employed to facilitate the transition from the growth phase of the culture to the production phase. Chemical inducers of protein production, such as, for example, caffeine, butyrate, and hexamethylene bisacetamide (HMBA), may be added at the same time as, before, and/or after a temperature shift, or in place of a temperature shift. If inducers are added after a temperature shift, they can be added from one hour to five days after the temperature shift, optionally from one to two days after the temperature shift.

Additionally, any cell culture media capable of supporting growth of the appropriate host cell in culture can be used. Typically, the cell culture medium contains a buffer, salts, energy source, amino acids, vitamins and trace essential elements. Cell culture media, which may be further supplemented with other components to maximize cell growth, cell viability, and/or recombinant protein production in a particular cultured host cell, are commercially available and include RPMI-1640 Medium, RPMI-1641 Medium, Dulbecco's Modified Eagle's Medium (DMEM), Minimum Essential Medium Eagle, F-12K Medium, Ham's F12 Medium, Iscove's Modified Dulbecco's Medium, McCoy's 5A Medium, Leibovitz's L-15 Medium, and serum-free media such as EX-CELL™ 300 Series, among others, which can be obtained from the American Type Culture Collection or SAFC Biosciences, as well as other vendors. Cell culture media can be serum-free, protein-free, growth factor-free, and/or peptone-free media. Cell culture media may also be enriched by the addition of nutrients or other supplements, which may be used at greater than usual, recommended concentrations. In certain embodiments, the culture medium is a chemically defined medium, which refers to a cell culture medium in which all of the components have known chemical structures and concentrations. Chemically defined media are typically serum-free and do not contain hydrolysates or animal-derived components.

Various media formulations can be used during the life of the culture, for example, to facilitate the transition from one stage (e.g., the growth stage or phase) to another (e.g., the production stage or phase) and/or to optimize conditions during cell culture (e.g. concentrated media provided during a perfusion culture). A growth medium formulation can be used to promote cell growth and minimize protein expression. A production medium formulation can be used to promote production of the recombinant protein of interest and maintenance of the cells, with minimal new cell growth. A feed medium is typically a cell culture medium containing more concentrated components such as nutrients and amino acids, which are consumed during the course of the production phase of the cell culture. Feed media may be used to supplement and maintain an active culture, particularly a culture operated in fed batch, semi-perfusion, or perfusion mode. Such a concentrated feed medium can contain most of the components of the cell culture medium at, for example, about 5×, 6×, 7×, 8×, 9×, 10×, 12×, 14×, 16×, 20×, 30×, 50×, 100×, 200×, 400×, 600×, 800×, or even about 1000× of their normal amount.

In some embodiments, the mammalian cell is cultured for a defined period of time during which the recombinant protein is expressed and secreted by the mammalian cell. This period of time (i.e. the duration of the production phase of the cell culture) is at least 3 days, at least 7 days, at least 10 days, or at least 15 days. In certain embodiments, the duration of the production phase of the cell culture is about 7 days to about 28 days, about 10 days to about 30 days, about 7 days to about 14 days, about 10 days to about 18 days, about 3 days to about 15 days, about 5 days to about 8 days, about 12 days to about 15 days, about 12 days to about 18 days, or about 15 days to about 21 days. In some embodiments, the duration of the production phase of the cell culture is 7 days, 8 days, 9 days, 12 days, 15 days, 18 days, or 21 days.

In some embodiments, the biomanufacturing process comprises a production phase with a viable cell density of at least 100×10⁵ cells/mL, for example between about 100×10⁵ cells/mL and about 10×10⁷ cells/mL, between about 250×10⁵ cells/mL and about 900×10⁵ cells/mL, between about 300×10⁵ cells/mL and 800×10⁵ cells/mL, or between about 450×10⁵ cells/mL and 650×10⁵ cells/mL. Cell density may be measured using a hemacytometer, a Coulter counter, or an automated cell analyzer (e.g. Cedex automated cell counter). Viable cell density may be determined by staining a culture sample with Trypan blue, which is taken up only by dead cells. Viable cell density is then determined by counting the total number of cells, dividing the number of stained cells by the total number of cells, and taking the reciprocal.

In some embodiments, the biomanufacturing process comprises a production phase with a packed cell volume less than or equal to 35%. In some embodiments, the packed cell volume is less than or equal to 30%.

Critical attributes and performance indicators of the recombinant protein of interest can be measured to better inform decisions regarding performance of each step during manufacture. These critical attributes and parameters can be monitored real-time, near real-time, and/or offline. Critical parameters that can be measured during cell culture may include cell culture media components that are consumed (such as, e.g., glucose), levels of metabolic by-products (such as, e.g., lactate and ammonia) that accumulate, as well as those related to cell maintenance and survival, such as dissolved oxygen content. Additionally, critical attributes such as specific productivity, viable cell density, packed cell volume, pH, osmolality, aggregation, percent yield, and titer may be monitored during appropriated stages in the manufacturing process. Monitoring and measurements can be performed using known techniques and commercially available equipment.

### Purification Processes

Compositions subjected to the virus filtration methods disclosed herein may derive from a cell culture process and may be subjected to one or more purification processes prior to virus filtration. Illustratively, the expressed recombinant proteins may be secreted into the culture medium from which they can be recovered and/or collected. Harvest operations comprising an acid precipitation may be combined with additional harvest strategies, including centrifugation, such as disk-stack centrifugation, intermittent discharge centrifugation, or continuous solid discharge centrifugation; filtration, including tangential flow filtration, microfiltration, ultrafiltration, and depth filtration; precipitation/sedimentation methods, such as flocculation; and chromatography media-based separations.

Additionally, the present disclosure encompasses methods involving all known post-harvest recovery technologies, such as, e.g., protein A purification of immunoglobulin and immunoglobulin-like biologics, as well as chromatography-based separations and polishing steps that include column and alternative modes of chromatographic separations by ion exchange chromatography (IEX), including anion exchange chromatography (AEX) and/or cation exchange chromatography (CEX), hydrophobic interaction chromatography (HIC), mixed modal or multimodal chromatography (MM), hydroxyapatite chromatography (HA), reverse-phase chromatography, size exclusion chromatography (SEC), gel filtration, or any other known form of chromatographic separation of biological and/or biochemical substances. Such post-harvest recovery technologies may be employed before or after virus filtration.

In some embodiments, recombinant protein recovered from the host cells or cell culture medium may be further purified or partially purified to remove cell culture media components, host cell proteins, or nucleic acids, or other process or product-related impurities by one or more unit operations, before or after virus filtration. One of ordinary skill in the art can select the appropriate unit operation(s) for further purification of a recombinant protein based on the characteristics of the recombinant protein to be purified, the characteristics of host cell from which the recombinant protein is expressed, and the composition of the culture medium in which the host cells were grown. Illustratively, in some embodiments, the recombinant protein is purified from the harvest permeate by one or more of flocculation, precipitation, centrifugation, depth filtration, affinity chromatography, size exclusion chromatography, ion exchange chromatography, mixed mode anion exchange chromatography, hydrophobic interaction chromatography, or hydroxyapatite chromatography.

A capture unit operation may include capture chromatography that makes use of resins and/or membranes containing agents that will bind to the recombinant protein of interest, for example, affinity chromatography, size exclusion chromatography, ion exchange chromatography, hydrophobic interaction chromatography (HIC), immobilized metal affinity chromatography (IMAC), and the like. Such chromatographic materials are known in the art and are commercially available. For instance, if the recombinant protein is an antibody or contains components derived from an antibody (e.g., a Fc domain), affinity chromatography using ligands such as Protein A, Protein G, Protein A/G, or Protein L may be employed as a capture chromatography unit operation to further purify the recombinant protein. In other embodiments, the recombinant protein of interest may comprise a polyhistidine tag at its amino or carboxyl terminus and subsequently purified using IMAC. Recombinant proteins can be engineered to include other purification tags, such as a FLAG® tag or c-myc epitope and subsequently purified by affinity chromatography using a specific antibody directed to such tag or epitope.

Additional unit operations to inactivate, reduce, and/or eliminate viral contaminants may include filtration processes and/or adjusting solution conditions. One method for achieving viral inactivation is incubation at low pH (e.g., pH<4). A low pH viral inactivation operation can be followed with a neutralization unit operation that readjusts the virus inactivated solution to a pH more compatible with the requirements of the subsequent unit operations. A low pH viral inactivation operation may also be followed by filtration, such as depth filtration, to remove any resulting turbidity or precipitation. Adjusting the temperature or chemical composition (e.g., use of detergents) can also be used to achieve viral inactivation.

A polishing unit operation may make use of various chromatographic methods for the purification of the protein of interest and clearance of contaminants and impurities. The polishing chromatography unit operation may make use of resins and/or membranes containing agents that can be used in either a “flow-through mode,” in which the protein of interest is contained in the eluent and the contaminants and impurities are bound to the chromatographic medium, or “bind and elute mode,” in which the protein of interest is bound to the chromatographic medium and eluted after the contaminants and impurities have flowed through or been washed off the chromatographic medium. Examples of such polish chromatography methods include, but are not limited to, ion exchange chromatography (IEX), such as anion exchange chromatography (AEX) and cation exchange chromatography (CEX); hydrophobic interaction chromatography (HIC); mixed modal or multimodal chromatography (MM), hydroxyapatite chromatography (HA); reverse phase chromatography, and size-exclusion chromatography (e.g. gel filtration).

### UF/DF

Purified recombinant protein (e.g., recombinant protein that has been subjected to one or more purification processes in addition to virus filtration) may be formulated, i.e., buffer exchanged, sterilized, bulk-packaged, and/or packaged for a final user. Illustratively, product concentration and buffer exchange of the recombinant protein of interest into a desired formulation buffer for bulk storage of the drug substance or drug product can be accomplished by ultrafiltration and/or diafiltration. Suitable formulations for pharmaceutical compositions include those described in Remington's Pharmaceutical Sciences, 18th ed. 1995, Mack Publishing Company, Easton, PA.

A UF/DF operation may take place at one or more stages in a downstream process. Typically, a UF/DF operation is performed prior to bulk storage of the drug substance. Instead of storage, unit operations related to drug product fill/finish can also immediately follow a UF/DF operation. One or more stability-enhancing excipients may optionally be added directly to the UF/DF retentate feed tank containing the formulated purified protein resulting in formulated drug substance or added to the UF/DF eluate pool. An example UF/DF process is described in WO 2020/159838. Filters for use in a UF/DF operation are well-known in the art and are commercially available from many sources. There are many types of materials available, such as regenerated cellulose, Pellicon™ (MilliporeSigma, Danvers, MA), stabilized cellulose, Sartocon® Slice, Sartocon® ECO Hydrosart® (Sartorius, Goettingen, Germany), and polyethersulfone (PES) membrane, Omega (Pall Corporation, Port Washington, NY).

### Recombinant Proteins

Compositions comprising any type of recombinant protein, including proteins containing single polypeptide chains or multiple polypeptide chains, can be purified according to the methods of the present disclosure. Such recombinant proteins include, but are not limited to, secreted proteins, non-secreted proteins, intracellular proteins, or membrane-bound proteins. Illustratively, recombinant proteins can include, but are not limited to, cytokines, growth factors, hormones, muteins, fusion proteins, antibodies, antibody fragments, peptibodies, T-cell engaging molecules, and multi-specific antigen binding proteins. In some embodiments, the recombinant protein is a fusion protein.

In other embodiments, the recombinant protein in a composition to be purified according to a method of the present disclosure is an antigen-binding protein. Antigen-binding proteins include, but are not limited to, antibodies, peptibodies, antibody derivatives, antibody analogs, fusion proteins (including, e.g., single chain variable fragments (scFvs), double-chain (divalent) scFvs, and IgGscFv (see, e.g., Orcutt et al., 2010, Protein Eng Des Sel 23:221-228)), hetero-IgG molecules (see, e.g., Liu et al., 2015, J Biol Chem 290:7535-7562), muteins, and XmAb® (Xencor, Inc., Monrovia, CA). Additional antigen-binding proteins include, but are not limited to, bispecific T cell engagers (BiTE®), bispecific T cell engagers having extensions, such as, e.g., half-life extensions, such as, e.g., HLE BiTE molecules, HeteroIg BITE molecules, and others, chimeric antigen receptors (CARs, CAR Ts), and T cell receptors (TCRs).

In some embodiments, the antigen-binding protein binds to one of more of the following, alone or in any combination: CD proteins including, but not limited to, CD3, CD4, CD5, CD7, CD8, CD19, CD20, CD22, CD25, CD30, CD33, CD34, CD38, CD40, CD70, CD123, CD133, CD138, CD171, and CD174, HER receptor family proteins, including, for instance, HER2, HER3, HER4, and the EGF receptor, EGFRvIII, cell adhesion molecules, for example, LFA-1, Mol, p150,95, VLA-4, ICAM-1, VCAM, and alpha v/beta 3 integrin, growth factors, including but not limited to, for example, vascular endothelial growth factor (“VEGF”); VEGFR2, growth hormone, thyroid stimulating hormone, follicle stimulating hormone, luteinizing hormone, growth hormone releasing factor, parathyroid hormone, mullerian-inhibiting substance, human macrophage inflammatory protein (MIP-1-alpha), erythropoietin (EPO), nerve growth factor, such as NGF-beta, platelet-derived growth factor (PDGF), fibroblast growth factors, including, for instance, aFGF and bFGF, epidermal growth factor (EGF), Cripto, transforming growth factors (TGF), including, among others, TGF-α and TGF-β, including TGF-β1, TGF-β2, TGF-β3, TGF-β4, or TGF-β5, insulin-like growth factors-I and -II (IGF-I and IGF-II), des(1-3)-IGF-I (brain IGF-I), and osteoinductive factors, insulins and insulin-related proteins, including, but not limited to, insulin, insulin A-chain, insulin B-chain, proinsulin, and insulin-like growth factor binding proteins; (coagulation and coagulation-related proteins, such as, among others, factor VIII, tissue factor, von Willebrand factor, protein C, alpha-1-antitrypsin, plasminogen activators, such as urokinase and tissue plasminogen activator (“t-PA”), bombazine, thrombin, thrombopoietin, and thrombopoietin receptor, colony stimulating factors (CSFs), including the following, among others, M-CSF, GM-CSF, and G-CSF, other blood and serum proteins, including but not limited to albumin, IgE, and blood group antigens, receptors and receptor-associated proteins, including, for example, flk2/flt3 receptor, obesity (OB) receptor, growth hormone receptors, and T-cell receptors; neurotrophic factors, including but not limited to, bone-derived neurotrophic factor (BDNF) and neurotrophin-3, -4, -5, or -6 (NT-3, NT-4, NT-5, or NT-6); relaxin A-chain, relaxin B-chain, and prorelaxin, interferons, including for example, interferon-alpha, -beta, and -gamma, interleukins (ILs), e.g., IL-1 to IL-10, IL-12, IL-15, IL-17, IL-23, IL-12/IL-23, IL-2Ra, IL1-R1, IL-6 receptor, IL-4 receptor and/or IL-13 to the receptor, IL-13RA2, or IL-17 receptor, IL-1RAP; viral antigens, including but not limited to, an AIDS envelope viral antigen, lipoproteins, calcitonin, glucagon, atrial natriuretic factor, lung surfactant, tumor necrosis factor-alpha and -beta, enkephalinase, BCMA, IgKappa, ROR-1, ERBB2, mesothelin, RANTES (regulated on activation normally T-cell expressed and secreted), mouse gonadotropin-associated peptide, DNase, FR-alpha, inhibin, and activin, integrin, protein A or D, rheumatoid factors, immunotoxins, bone morphogenetic protein (BMP), superoxide dismutase, surface membrane proteins, decay accelerating factor (DAF), AIDS envelope, transport proteins, homing receptors, MIC (MIC-a, MIC-B), ULBP 1-6, EPCAM, addressins, regulatory proteins, immunoadhesins, antigen-binding proteins, somatropin, CTGF, CTLA4, eotaxin-1, MUC1, CEA, c-MET, Claudin-18, GPC-3, EPHA2, FPA, LMP1, MG7, NY-ESO-1, PSCA, ganglioside GD2, ganglioside GM2, BAFF, OPGL (RANKL), myostatin, Dickkopf-1 (DKK-1), Ang2, NGF, IGF-1 receptor, hepatocyte growth factor (HGF), TRAIL-R2, c-Kit, B7RP-1, PSMA, NKG2D-1, programmed cell death protein 1 and ligand, PD1 and PDL1, mannose receptor/hCGβ, hepatitis-C virus, mesothelin dsFv[PE38] conjugate, Legionella pneumophila (lly), IFN gamma, interferon gamma induced protein 10 (IP10), IFNAR, TALL-1, thymic stromal lymphopoietin (TSLP), proprotein convertase subtilisin/Kexin Type 9 (PCSK9), stem cell factors, Flt-3, calcitonin gene-related peptide (CGRP), OX40L, a407, platelet specific (platelet glycoprotein IIb/IIIb (PAC-1), transforming growth factor beta (TFGP), Zona pellucida sperm-binding protein 3 (ZP-3), TWEAK, platelet derived growth factor receptor alpha (PDGFRa), sclerostin, and biologically active fragments or variants of any of the foregoing.

In other embodiments, the recombinant protein in a composition to be purified according to a method of the present disclosure is an antibody. In some embodiments, the antibody is a human antibody.

In some embodiments, the antibody is selected from abrilumab, brazikumab, brodalumab, crizanlizumab, denosumab, eculizumab, erenumab, evolocumab, fremanezumab, meplazumab, nemolizumab, ontamalimab, panitumumab, prezalumab, ravulizumab, rilotumumab, romosozumab, satralizumab, tafolecimab, tanezumab, tezepelumab, tremelimumab, utomilumab, and volagidemab. In some embodiments, the antibody is selected from denosumab, erenumab, evolocumab, panitumumab, romosozumab, and tezepelumab. In some embodiments, the antibody is denosumab. In some embodiments, the antibody is erenumab. In some embodiments, the antibody is evolocumab. In some embodiments, the antibody is panitumumab. In some embodiments, the antibody is romosozumab. In some embodiments, the antibody is tezepelumab.

In some embodiments, the antibody is an IgG1, IgG2, or IgG4 antibody. In some embodiments, the antibody is a human IgG1, IgG2, or IgG4 antibody.

In some embodiments, the antibody is an IgG1 antibody. In some embodiments, the antibody is a human IgG1 antibody.

In some embodiments, the antibody is an IgG2 antibody. In some embodiments, the antibody is a human IgG2 antibody.

In some embodiments, the antibody is an IgG4 antibody. In some embodiments, the antibody is a human IgG4 antibody.

### EXAMPLES

In order that the present disclosure may be more fully understood, the following examples are set forth. It should be understood that these examples are for illustrative purposes only and are not to be construed as limiting this disclosure in any manner.

### Example 1. Use of an Oversized Prefilter to Enable Robust Viral Clearance with High Concentration (>15 g/L) Feed Streams Over Multiple Filtration Cycles

To achieve high flux, throughput, and cycling capability for a highly concentrated feed stream of a human IgG2 antibody (“mAb”), a virus filter prefilter that is oversized in area relative to the virus filter was employed in virus filtration operations at the bench scale and the pilot run scale. Specifically, all tested ratios of the prefilter area to viral filter area were in excess of 2:1 (2.4:1, 2.6:1, 2.9:1) for each filtration cycle, where the prefilter was changed out after each filtration cycle (i.e., the listed prefilter area to viral filter area ratio is the tested ratio in each filtration cycle). In all runs, a diatomaceous earth-based depth filter (Viresolve® Prefilter (VPF), EMD Millipore) was used as a prefilter in combination with a flat sheet polyethersulfone (PES) membrane virus filter (Viresolve® Pro, EMD Millipore).

The mAb feed stream was conditioned prior to pre-filtration. Prior to load conditioning, mAb feed streams were characterized by low conductivity (<6 mS/cm), high concentration (>20 g/L), and high pH (7.5) and contained buffering species, including tris and acetate. In contrast, pre-conditioned streams were characterized by a lower pH (6.7), achieved via titration with acetate, and higher conductivity (>12 mS/cm), achieved via addition of sodium chloride.

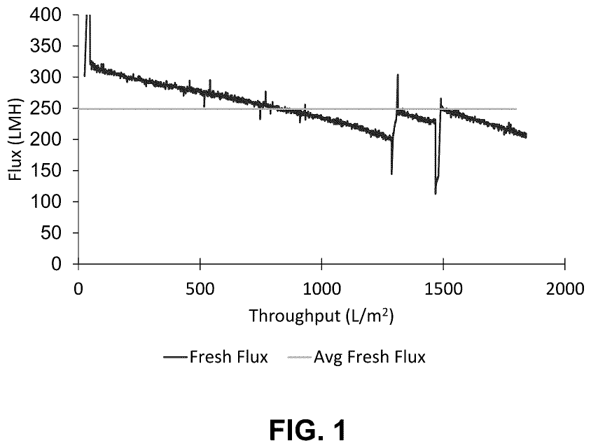

FIG. 1 shows virus filter flux versus loading from a bench-scale proof of concept run with non-virus spiked load. The bench-scale evaluation was conducted with pre-conditioned, non-frozen load material (i.e., “fresh” load, as denoted in the legend), a 2.9:1 prefilter to virus filter area ratio, and a constant differential pressure of 30 psid. In the evaluation, a volumetric throughput of greater than 1800 L/m² and an average flux of approximately 250 L/m²/hr were achieved, demonstrating the capability of the virus filtration scheme to enable cycling of the virus filter.

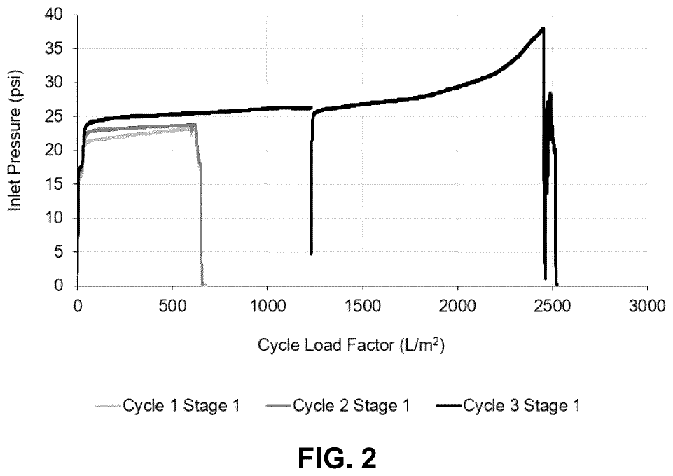

FIG. 2 shows bench-scale results for virus filter inlet pressure versus loading for “constant flux” runs using the same virus filter for three filtration cycles. This evaluation was conducted with fresh and pre-conditioned load material, a 2.9:1 prefilter to virus filter area ratio for each filtration cycle, and a constant flux of 250 L/m²/hr. High throughputs of approximately 500 L/m² were achieved for the first two virus filtration cycles. Loading of the third filtration cycle continued until the entirety of the material was loaded onto the filter, with an overall volumetric throughput of greater than 3400 L/m².

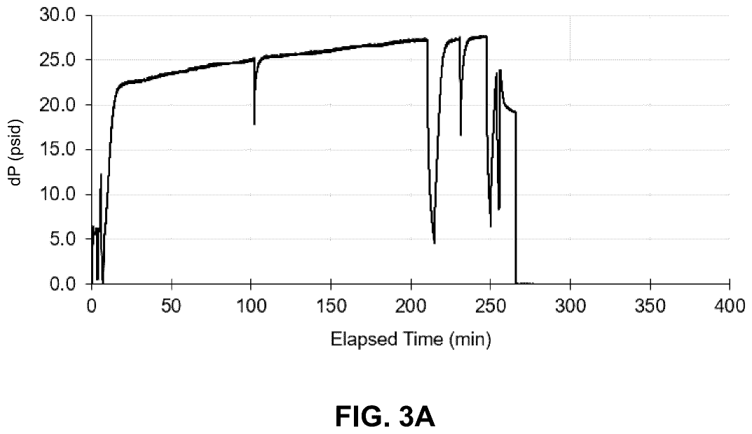

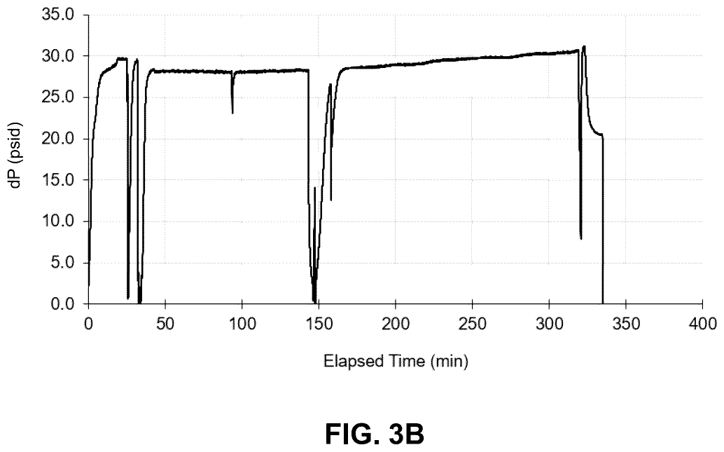

FIG. 3A, FIG. 3B, and Table 1 show viral clearance results obtained in bench-scale runs conducted with a 2.9:1 prefilter:virus filter area ratio for each of two filtration cycles, with fresh load material spiked with mouse minute virus (MMV), a model virus, at different volume percentage values summarized in Table 1. During the viral clearance studies, a loading of 1,000 L/m²/cycle was targeted. As shown in FIG. 3A and FIG. 3B, the inlet pressure was well-controlled for each of the two filtration cycles when run to a target loading of 1,000 L/m². The pressure trends for filtration cycles 1 and 2 show periods of low pressure due to filtration pauses. The virus filter net throughput of greater than 2,000 L/m² equated to more than 37,000 g/m2, a high throughput for a single virus filter. Additionally, over 4 log reduction values (LRV) of virus were obtained for each of the two filtration cycles with no observed virus breakthrough.

TABLE 1
Summary of Viral Clearance Results using an Oversized Prefilter.

| Filtration Cycle | Loading (L/m²) | MMV Spike % | LRV Achieved |
|---|---|---|---|
| 1 | 1,000 | 0.01 | Not measured |
| 2 | 1,300 | 0.01 | 4.04 ± 0.25 |

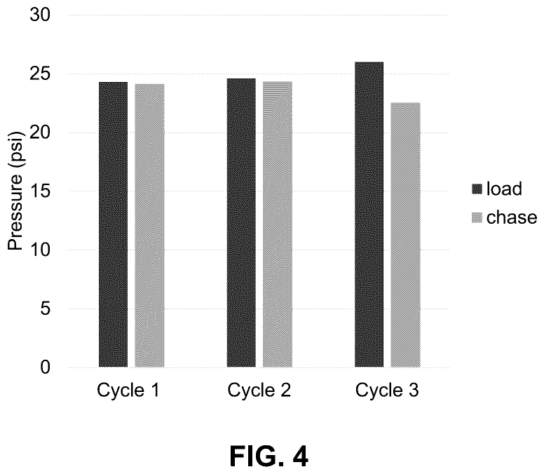

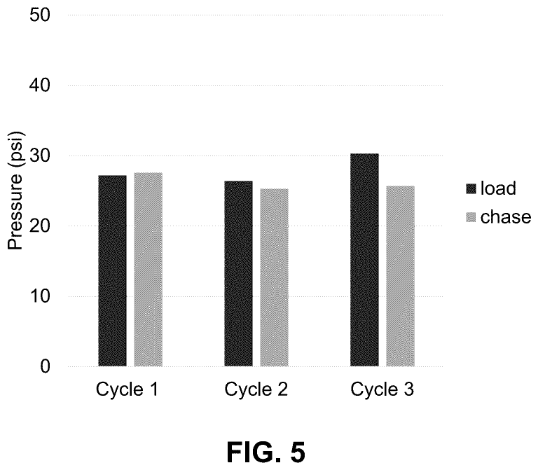

FIG. 4 and FIG. 5 show virus filter differential and inlet pressure measurements, respectively, in pilot-scale runs with three filtration cycles per virus filter, where a 2.6:1 prefilter:virus filter area ratio was employed in each filtration cycle. The target virus filter loading was 500 L/m²/cycle, and the pressures were well-controlled relative to the limits, similar to what was observed during the viral clearance studies. Differential and inlet pressures were measured at the end of each filtration cycle.

Table 2 shows the beta glucan levels in the final drug substance for three different pilot-scale runs (PSRs). The intent of this evaluation was to verify that the oversized prefilter did not lead to unacceptable leaching of beta glucans, a risk associated with some cellulose-based prefilters, which could impact safety of the final drug substance. The beta glucan levels were within historical ranges for mAb manufacture, demonstrating the feasibility of this filtration scheme in combination with a risk mitigation strategy of a sodium carbonate flush of each pre-filter prior to viral filtration.

TABLE 2
Beta Glucan Levels in Final mAb Drug
Substance for Pilot-Scale Runs

| Run | Beta Glucan Level in Drug Substance (μg/L) |
|---|---|
| Historical Ranges | 6.6-11.1 |
| PSR1 | 4.1 |
| PSR2 | 2.8 |
| PSR3 | 9.8 |

Based on the results of these evaluations, a filtration scheme employing an oversized prefilter enables virus filter loadings of greater than or equal to 1500 L/m² on a volumetric basis (greater than or equal to 30,000 g/m² on a product mass basis) over three filtration cycles, at a flux of 250 LMH (liters per meter squared per hour) and with a feed stream product concentration of greater than 18 g/L. Accordingly, use of an oversized prefilter may facilitate intensified virus filtration operations that accommodate: (1) high loadings to deliver high throughputs in a relatively small footprint; (2) high flux to enable connected processing, thereby leading to dematerialization (i.e., efficient use of raw materials to lower costs and reduce the manufacturing footprint) and decreased footprint versus discrete processing; (3) capability to cycle the viral filter, thereby leading to dematerialization; and (4) robust performance with high concentration (>15 g/L) feed streams, which helps ensure high throughput in a small footprint.

All documents, or portions of documents, cited in this application, including but not limited to patents, patent applications, articles, books, and treatises, are hereby expressly incorporated by reference. What is described in an embodiment of the disclosure can be combined with one or more other embodiments of the disclosure unless context clearly indicates otherwise.

The disclosed subject matter is not intended to be limited in scope by the specific embodiments described herein, which are instead intended as non-limiting illustrations of individual aspects of the disclosure. Functionally equivalent methods and components are within the scope of the disclosure. Indeed, various modifications of the disclosed subject matter, in addition to those shown and described herein, will be apparent to those skilled in the art from the foregoing description and accompanying drawing(s). Such modifications are intended to fall within the scope of the disclosed subject matter.

The descriptions of the various embodiments and/or examples of the disclosed subject matter have been presented for purposes of illustration, but are not intended to be exhaustive or limiting in any way. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, and/or to enable others of ordinary skill in the art to understand the disclosed subject matter.

What is claimed is:

1. A method of removing at least one viral contaminant from a composition, comprising filtering the composition through a virus prefilter and a virus filter, wherein:
the virus filter is loaded to at least about 1500 L/m² over one or more filtration cycles; and
a ratio of the virus prefilter area to the virus filter area in each filtration cycle is at least about 2:1.

2. The method of claim 1, comprising at least two filtration cycles, wherein the virus prefilter is replaced after one or more filtration cycles.

3. The method of claim 1, wherein:
the virus prefilter is a diatomaceous earth-based depth filter; and/or
the virus filter comprises polyethersulfone (PES).

4. The method of claim 1, wherein:
the virus prefilter is a diatomaceous earth-based depth filter;
the virus filter comprises polyethersulfone (PES);
the method further comprises flushing the diatomaceous earth-based depth filter with a carbonate-containing solution prior to filtering the composition; and
after filtering the composition, the composition has a β-glucan concentration of less than about 10 μg/L.

5. The method of claim 1, wherein a net ratio of the virus prefilter area to the virus filter area over the filtering is about 6:1 to about 9:1.

6. A method of removing at least one viral contaminant from a composition, comprising filtering the composition through a virus prefilter and a virus filter over at least two filtration cycles, wherein:
the virus prefilter is replaced after each filtration cycle;
the virus filter is loaded to at least about 1500 L/m² over the at least two filtration cycles; and
a ratio of the virus prefilter area to the virus filter area in each filtration cycle is at least about 2:1.

7. The method of claim 6, wherein:
the virus prefilter is a diatomaceous earth-based depth filter; and/or
the virus filter comprises polyethersulfone (PES).

8. The method of claim 6, wherein the ratio of the virus prefilter area to the virus filter area in each filtration cycle is about 2:1 to about 3:1.

9. The method of claim 6, further comprising:
adjusting the pH of the composition to less than about 7.2 prior to filtering; and/or
adjusting the conductivity of the composition to at least about 10 mS/cm prior to filtering.

10. The method of claim 6, further comprising:
adjusting the pH of the composition to less than about 7.2 prior to filtering; and
adjusting the conductivity of the composition to at least about 10 mS/cm prior to filtering.

11. The method of claim 6, wherein the composition is filtered through the virus filter at a flux of about 100 L/m²/hr to about 500 L/m²/hr.

12. The method of claim 6, wherein the composition is filtered through the virus filter at a pressure of about 10 psi to about 60 psi.

13. The method of claim 6, comprising three filtration cycles, wherein a net ratio of the virus prefilter area to the virus filter area over the three filtration cycles is at least about 6:1.

14. The method of claim 6, wherein a net ratio of the virus prefilter area to the virus filter area over the filtering is about 6:1 to about 9:1.

15. The method of claim 6, wherein:
the virus prefilter is a diatomaceous earth-based depth filter;
the virus filter comprises polyethersulfone (PES); and
the method further comprises flushing the diatomaceous earth-based depth filter with a carbonate-containing solution prior to filtering the composition.

16. The method of claim 6, wherein, after filtering the composition, the composition has a β-glucan concentration of less than about 15 μg/L.

17. The method of claim 6, wherein:
the virus prefilter is a diatomaceous earth-based depth filter;
the virus filter comprises polyethersulfone (PES);
the method further comprises flushing the diatomaceous earth-based depth filter with a carbonate-containing solution prior to filtering the composition; and
after filtering the composition, the composition has a β-glucan concentration of less than about 10 μg/L.

18. The method of claim 6, wherein the composition comprises at least about 10 g/L of a recombinant protein.

19. The method of claim 6, wherein the at least one viral contaminant is selected from parvoviruses, retroviruses, pseudorabies viruses, and reoviruses.

20. The method of claim 6, wherein the filtering results in a log reduction value (LRV) of the at least one viral contaminant of at least about 4 for each of one or more filtration cycles.
